(19) United States
(12) Patent Application Publication
(10) Pub. No.: US 2024/0389140 A1
(43) Pub. Date: Nov. 21, 2024

(54) MULTI-HOP CHANNEL SOUNDING FOR RELAY OPERATION

(71) Applicant: QUALCOMM Incorporated, San Diego, CA (US)

(72) Inventors: George Cherian, San Diego, CA (US); Sai Yiu Duncan Ho, San Diego, CA (US); Alfred Asterjadhi, San Diego, CA (US); Abhishek Pramod Patil, San Diego, CA (US); Abdel Karim Ajami, San Diego, CA (US); Gaurang Naik, San Diego, CA (US); Yanjun Sun, San Diego, CA (US)

(21) Appl. No.: 18/336,878

(22) Filed: Jun. 16, 2023

Related U.S. Application Data
(63) Continuation-in-part of application No. 18/319,299, filed on May 17, 2023.

(51) Int. Cl. H04W 74/08

(52) U.S. Cl. CPC H04W 74/0808; H04W 84/12

(57) ABSTRACT

This disclosure provides methods, components, devices and systems for signaling mechanisms for multi-hop channel sounding for relay operation. Some aspects more specifically relate to frame addressing and transmission opportunity (TXOP) or service period (SP) sharing to facilitate a multi-hop channel sounding within a single TXOP or SP. An originating device may transmit a first frame indicating identifying information corresponding to multiple other wireless communication devices to initiate a multi-hop channel sounding involving the multiple other wireless communication devices. For example, the originating device may include, in the first frame, identifying information corresponding to a satellite access point (AP) and identifying information corresponding to an end device with which the originating device may communicate via the satellite AP. In accordance with the multi-hop channel sounding, the originating device may receive, collectively via one or more frames, channel information associated with each hop between the originating device and the end device.

### CROSS REFERENCE

The present application for patent is a Continuation-In-Part of U.S. patent application Ser. No. 18/319,299 by CHERIAN et al., entitled “SIGNALING MECHANISMS FOR LOW LATENCY AND LOW COMPLEXITY RELAY DESIGNS,” filed May 17, 2023, assigned to the assignee hereof, and expressly incorporated by reference in its entirety herein.

### TECHNICAL FIELD

This disclosure relates to wireless communication and, more specifically, to multi-hop channel sounding for relay operation.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless communication device. The first wireless communication device may include one or more memories storing processor-executable code and one or more processors coupled with the one or more memories. The one or more processors may be individually or collectively configured to, when executing the code, cause the first wireless communication device to transmit contextual information of one or more wireless communication devices, the one or more wireless communication devices associated with a relay path to a root access point (AP) via at least the first wireless communication device, transmit, via the relay path, a set of protocol data units (PDUs) during a transmission opportunity (TXOP) of a second wireless communication device, receive, via the relay path, a first block acknowledgment (BA) associated with the set of PDUs during the TXOP, and transmit, via the relay path and in accordance with the first BA, a second BA associated with the set of PDUs during the TXOP.

Another innovative aspect of the subject matter described in this disclosure can be implemented in a method for wireless communication at a first wireless communication device. The method may include transmitting contextual information of one or more wireless communication devices, the one or more wireless communication devices associated with a relay path to a root AP via at least the first wireless communication device, transmitting, via the relay path, a set of PDUs during a TXOP of a second wireless communication device, receiving, via the relay path, a first BA associated with the set of PDUs during the TXOP, and transmitting, via the relay path and in accordance with the first BA, a second BA associated with the set of PDUs during the TXOP.

Another innovative aspect of the subject matter described in this disclosure can be implemented in a first wireless communication device. The first wireless communication device may include means for transmitting contextual information of one or more wireless communication devices, the one or more wireless communication devices associated with a relay path to a root AP via at least the first wireless communication device, means for transmitting, via the relay path, a set of PDUs during a TXOP of a second wireless communication device, means for receiving, via the relay path, a first BA associated with the set of PDUs during the TXOP, and means for transmitting, via the relay path and in accordance with the first BA, a second BA associated with the set of PDUs during the TXOP.

Another innovative aspect of the subject matter described in this disclosure can be implemented in a non-transitory computer-readable medium storing code for wireless communication at a first wireless communication device. The code may include instructions executable by one or more processors individually or collectively to transmit contextual information of one or more wireless communication devices, the one or more wireless communication devices associated with a relay path to a root AP via at least the first wireless communication device, transmit, via the relay path, a set of PDUs during a TXOP of a second wireless communication device, receive, via the relay path, a first BA associated with the set of PDUs during the TXOP, and transmit, via the relay path and in accordance with the first BA, a second BA associated with the set of PDUs during the TXOP.

Some implementations of the method, first wireless communication devices, and non-transitory computer-readable medium described herein may further include operations, features, means, or instructions for transmitting the second BA in accordance with an end-to-end encryption associated with the relay path.

Some implementations of the method, first wireless communication devices, and non-transitory computer-readable medium described herein may further include operations, features, means, or instructions for transmitting the set of PDUs without reordering the set of PDUs, where the set of PDUs may be a successfully received set of PDUs of a second set of PDUs.

Some implementations of the method, first wireless communication devices, and non-transitory computer-readable medium described herein may further include operations, features, means, or instructions for refraining from retransmitting any PDUs of the set of PDUs that may be unsuccessfully received.

Some implementations of the method, first wireless communication devices, and non-transitory computer-readable medium described herein may further include operations, features, means, or instructions for adjusting a set of physical layer parameters associated with a communication link in accordance with a comparison between a first set of sequence numbers associated with the set of PDUs and a second set of sequence numbers associated with successfully received PDUs of the set of PDUs, where the first BA includes information indicative of the second set of sequence numbers associated with the successfully received PDUs of the set of PDUs.

Some implementations of the method, first wireless communication devices, and non-transitory computer-readable medium described herein may further include operations, features, means, or instructions for receiving, via the first BA, information indicative of first successfully received PDUs of the set of PDUs, retransmitting, during the TXOP, one or more PDUs of the set of PDUs in accordance with the first BA, the one or more PDUs including first unsuccessfully received PDUs, and receiving, during the TXOP, a third BA associated with the one or more PDUs.

Some implementations of the method, first wireless communication devices, and non-transitory computer-readable medium described herein may further include operations, features, means, or instructions for receiving, via the third BA, information indicative of second successfully received PDUs associated with the one or more PDUs and transmitting, via the second BA, information indicative of both the first successfully received PDUs and the second successfully received PDUs.

Some implementations of the method, first wireless communication devices, and non-transitory computer-readable medium described herein may further include operations, features, means, or instructions for transmitting the second BA in accordance with a time duration until an expiration of the TXOP.

Another innovative aspect of the subject matter described in this disclosure can be implemented in a first wireless communication device. The first wireless communication device may include one or more memories storing processor-executable code and one or more processors coupled with the one or more memories. The one or more processors may be individually or collectively configured to, when executing the code, cause the first wireless communication device to receive contextual information of one or more wireless communication devices, the one or more wireless communication devices associated with a relay path to the first wireless communication device via at least a second wireless communication device, communicate, via a relay path, a set of PDUs during a TXOP of the first wireless communication device or a third wireless communication device, and communicate, via the relay path, a BA associate with the set of PDUs during the TXOP, where the BA is associated with the relay path between the first wireless communication device and the third wireless communication device via at least the second wireless communication device.

Another innovative aspect of the subject matter described in this disclosure can be implemented in a method for wireless communication at a first wireless communication device. The method may include receiving contextual information of one or more wireless communication devices, the one or more wireless communication devices associated with a relay path to the first wireless communication device via at least a second wireless communication device, communicating, via a relay path, a set of PDUs during a TXOP of the first wireless communication device or a third wireless communication device, and communicating, via the relay path, a BA associated with the set of PDUs during the TXOP, where the BA is associated with the relay path between the first wireless communication device and the third wireless communication device via at least the second wireless communication device.

Another innovative aspect of the subject matter described in this disclosure can be implemented in a first wireless communication device. The first wireless communication device may include means for receiving contextual information of one or more wireless communication devices, the one or more wireless communication devices associated with a relay path to the first wireless communication device via at least a second wireless communication device, means for communicating, via a relay path, a set of PDUs during a TXOP of the first wireless communication device or a third wireless communication device, and means for communicating, via the relay path, a BA associated with the set of PDUs during the TXOP, where the BA is associated with the relay path between the first wireless communication device and the third wireless communication device via at least the second wireless communication device.

Another innovative aspect of the subject matter described in this disclosure can be implemented in a non-transitory computer-readable medium storing code for wireless communication at a first wireless communication device. The code may include instructions executable by one or more processors individually or collectively to receive contextual information of one or more wireless communication devices, the one or more wireless communication devices associated with a relay path to the first wireless communication device via at least a second wireless communication device, communicate, via a relay path, a set of PDUs during a TXOP of the first wireless communication device or a third wireless communication device, and communicate, via the relay path, a BA associate with the set of PDUs during the TXOP, where the BA is associated with the relay path between the first wireless communication device and the third wireless communication device via at least the second wireless communication device.

Some implementations of the method, first wireless communication devices, and non-transitory computer-readable medium described herein may further include operations, features, means, or instructions for communicating the BA in accordance with an end-to-end encryption associated with the relay path.

In some implementations of the method, first wireless communication devices, and non-transitory computer-readable medium described herein, scheduling communication with each of the one or more wireless communication devices associated with the relay path in accordance with the contextual information and scheduling communication with each of one or more second wireless communication devices associated with a direct communication path to the first wireless communication in accordance with second contextual information of the one or more second wireless communication devices, where the first wireless communication device manages both the one or more wireless communication devices associated with the relay path and the one or more second wireless communication devices associated with the direct communication path.

Some implementations of the method, first wireless communication devices, and non-transitory computer-readable medium described herein may further include operations, features, means, or instructions for retransmitting, during the TXOP or a second TXOP, one or more PDUs of the set of PDUs in accordance with a comparison between a first set of sequence numbers associated with the set of PDUs and a second set of sequence numbers associated with successfully received PDUs of the set of PDUs, where the BA includes information indicative of the second set of sequence numbers associated with the successfully received PDUs of the set of PDUs.

In some implementations of the method, first wireless communication devices, and non-transitory computer-readable medium described herein, each PDU of the set of PDUs includes a first address field indicative of the first wireless communication device, a second address field indicative of the second wireless communication device, and a field indicative of an association identifier (AID) of the third wireless communication device.

In some implementations of the method, first wireless communication devices, and non-transitory computer-readable medium described herein, the BA includes a first address field indicative of the first wireless communication device, a second address field indicative of the second wireless communication device, and a field indicative of an AID of the third wireless communication device.

Some implementations of the method, first wireless communication devices, and non-transitory computer-readable medium described herein may further include operations, features, means, or instructions for receiving, in accordance with the relay path, a relayed version of a management frame, where the relayed version of the management frame includes a first address field indicative of the first wireless communication device, a second address field indicative of the second wireless communication device, and a field indicative of the third wireless communication device, where the field indicative of the third wireless communication device indicates that the management frame may be relayed from the third wireless communication device.

In some implementations of the method, first wireless communication devices, and non-transitory computer-readable medium described herein, the field indicative of the third wireless communication device may be within an information element associated with satellite AP relaying and includes a medium access control (MAC) address of the third wireless communication device.

Some implementations of the method, first wireless communication devices, and non-transitory computer-readable medium described herein may further include operations, features, means, or instructions for transmitting a management frame to the second wireless communication device, where the management frame includes a first address field indicative of the first wireless communication device, a second address field indicative of the second wireless communication device, and a field indicative of the third wireless communication device, and where the field indicative of the third wireless communication device indicates that the management frame may be to be relayed to the third wireless communication device.

In some implementations of the method, first wireless communication devices, and non-transitory computer-readable medium described herein, the field indicative of the third wireless communication device may be within an information element associated with satellite AP relaying and includes a MAC address of the third wireless communication device.

Another innovative aspect of the subject matter described in this disclosure can be implemented in a first wireless communication device. The first wireless communication device may include one or more memories storing processor-executable code and one or more processors coupled with the one or more memories. The one or more processors may be individually or collectively configured to, when executing the code, cause the first wireless communication device to receive, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device and transmit, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device.

Another innovative aspect of the subject matter described in this disclosure can be implemented in a method for wireless communication at a first wireless communication device. The method may include receiving, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device and transmitting, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device.

Another innovative aspect of the subject matter described in this disclosure can be implemented in a first wireless communication device. The first wireless communication device may include means for receiving, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device and means for transmitting, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device.

Another innovative aspect of the subject matter described in this disclosure can be implemented in a non-transitory computer-readable medium storing code for wireless communication at a first wireless communication device. The code may include instructions executable individually or collectively by one or more processors to receive, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device and transmit, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device.

Some implementations of the method, apparatuses, and non-transitory computer-readable medium described herein may further include operations, features, means, or instructions for receiving, from the second wireless communication device, a third frame associated with a sharing of a TXOP or a service period (SP) of the second wireless communication device with the first wireless communication device, where the multi-hop channel sounding may be performed within the TXOP or the SP in accordance with the sharing of the TXOP or the SP.

Some implementations of the method, apparatuses, and non-transitory computer-readable medium described herein may further include operations, features, means, or instructions for transmitting a third frame to obtain a TXOP or an SP of the second wireless communication device in accordance with the first frame including the first identifying information and the second identifying information, where the multi-hop channel sounding may be performed within the TXOP or the SP in accordance with obtainment of the TXOP or the SP.

Some implementations of the method, apparatuses, and non-transitory computer-readable medium described herein may further include operations, features, means, or instructions for receiving, in accordance with the multi-hop channel sounding, one or more sounding packets from the second wireless communication device, where the first channel information may be associated with the one or more sounding packets.

Some implementations of the method, apparatuses, and non-transitory computer-readable medium described herein may further include operations, features, means, or instructions for transmitting, in accordance with the first frame including the second identifying information corresponding to the third wireless communication device, a third frame associated with the multi-hop channel sounding, the third frame including the second identifying information corresponding to the third wireless communication device, transmitting, to the third wireless communication device, one or more sounding packets in accordance with the multi-hop channel sounding, and receiving, from the third wireless communication device, a fourth frame indicating the second channel information, where the second channel information may be associated with the one or more sounding packets.

In some implementations of the method, apparatuses, and non-transitory computer-readable medium described herein, transmitting at least the second frame indicating the first channel information and the second channel information may include operations, features, means, or instructions for transmitting the second frame indicating the first channel information and transmitting a third frame indicting the second channel information, where the third frame may be a relayed version of a frame received from the third wireless communication device.

In some implementations of the method, apparatuses, and non-transitory computer-readable medium described herein, transmitting at least the second frame indicating the first channel information and the second channel information may include operations, features, means, or instructions for transmitting the second frame indicating both the first channel information and the second channel information.

Another innovative aspect of the subject matter described in this disclosure can be implemented in a first wireless communication device. The first wireless communication device may include one or more memories storing processor-executable code and one or more processors coupled with the one or more memories. The one or more processors may be individually or collectively configured to, when executing the code, cause the first wireless communication device to transmit a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device and receive, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

Another innovative aspect of the subject matter described in this disclosure can be implemented in a method for wireless communication at a first wireless communication device. The method may include transmitting a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device and receiving, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

Another innovative aspect of the subject matter described in this disclosure can be implemented in a first wireless communication device. The first wireless communication device may include means for transmitting a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device and means for receiving, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

Another innovative aspect of the subject matter described in this disclosure can be implemented in a non-transitory computer-readable medium storing code for wireless communication at a first wireless communication device. The code may include instructions executable individually or collectively by one or more processors to transmit a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device and receive, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

Some implementations of the method, apparatuses, and non-transitory computer-readable medium described herein may further include operations, features, means, or instructions for transmitting, to the second wireless communication device, a third frame associated with a sharing of a TXOP or an SP of the first wireless communication device with the second wireless communication device, where the multi-hop channel sounding may be performed within the TXOP or the SP in accordance with the sharing of the TXOP or the SP.

Some implementations of the method, apparatuses, and non-transitory computer-readable medium described herein may further include operations, features, means, or instructions for receiving a third frame associated with an obtainment of a TXOP or the SP of the first wireless communication device by the second wireless communication device in accordance with the first frame including the first identifying information and the second identifying information, where the multi-hop channel sounding may be performed within the TXOP or the SP in accordance with the obtainment of the TXOP or the SP by the second wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports signaling mechanisms for low latency and low complexity relay designs.

FIG. 3 shows an example data plane architecture that supports signaling mechanisms for low latency and low complexity relay designs.

FIGS. 4-6 show example process flows that support signaling mechanisms for low latency and low complexity relay designs.

FIG. 7 shows an example medium access control (MAC) protocol data unit (MPDU) that supports signaling mechanisms for low latency and low complexity relay designs.

FIG. 8 shows an example process flow that supports signaling mechanisms for low latency and low complexity relay designs.

FIG. 9 shows an example beacon frame that supports signaling mechanisms for low latency and low complexity relay designs.

FIG. 10 shows an example encryption procedure that supports signaling mechanisms for low latency and low complexity relay designs.

FIGS. 11 and 12 show example downlink sounding sequences that support multi-hop channel sounding for relay operation.

FIGS. 13 and 14 show example uplink sounding sequences that support multi-hop channel sounding for relay operation.

FIG. 15 shows a block diagram of an example wireless communication device that supports signaling mechanisms for low latency and low complexity relay designs.

FIG. 16 shows a block diagram of an example wireless communication device that supports signaling mechanisms for low latency and low complexity relay designs.

FIGS. 17 and 18 show flowcharts illustrating example processes that support signaling mechanisms for low latency and low complexity relay designs.

FIG. 19 shows a block diagram of an example wireless communication device that supports multi-hop channel sounding for relay operation.

FIGS. 20 and 21 show flowcharts illustrating example processes that support multi-hop channel sounding for relay operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to signaling mechanisms associated with a multi-hop relay between a client device and a root access point (AP) via one or more other APs (sometimes referred to as satellite APs). Some aspects more specifically relate to signaling- and management-based mechanisms according to which a client device may associate with a root AP via a satellite AP as a pass through (as a relay or intermediate node). In accordance with an association between the client device and the root AP, the root AP may directly manage a context for the client device, which may include or be associated with a storage and management of authentication, association, block acknowledgment (BA), capability, and quality of service (QoS) information of the client device at the root AP. As part of an association between the client device and the root AP with a satellite AP acting as a relay between the client device and the root AP, the client device, the root AP, and the satellite AP may support an end-to-end (E2E) relay framework according to which the satellite AP may relay one or more protocol data units (PDUs) and a BA associated with the one or more PDUs between the client device and the root AP within a single transmission opportunity (TXOP). For example, a satellite AP may receive a set (such as one or more) of PDUs from a first wireless communication device (such as one of a client device or a root AP) and forward the set of PDUs to a second wireless communication device (such as the other of the client device or the root AP, or another device). The satellite AP may receive a BA from the second wireless communication device associated with the set of PDUs and may forward the BA to the first wireless communication device. In some aspects, the various wireless communication devices along a multi-hop relay path may support (such as communicate in accordance with) an end-to-end encryption of both the set of PDUs and the BA associated with the set of PDUs. For example, the PDUs and the associated BA may be encoded (and decoded) in accordance with an end-to-end security key, which may refer to any security key that is known by the various wireless communication devices along the multi-hop relay path. To facilitate communication along a multi-hop relay path within a single TXOP, a client device or the root AP (or any other downstream or upstream wireless communication device along the multi-hop relay path) may share a TXOP with the satellite AP to provide the satellite AP with channel access. In some aspects, such TXOP sharing may be associated with (such as in parallel, or otherwise be used in combination with) an end-to-end channel reservation scheme according to which the various wireless communication devices along the multi-hop relay path may protect end-to-end communication.

In some implementations, the satellite AP may refrain from reordering the set of PDUs received from the first wireless communication device (if, for example, the set of PDUs are a successfully received subset of a larger set of PDUs transmitted by the first wireless communication device) and may refrain from retransmitting any PDUs of the set of PDUs that the satellite AP fails to successfully deliver to the second wireless communication device within the TXOP. In such implementations, the satellite AP may transmit (such as forward or relay), to the first wireless communication device, the BA received from the second wireless communication to enable the first wireless communication device to select, identify, decide, or determine whether to retransmit any PDUs. In some other implementations, the satellite AP may support some amount of retransmission in accordance with a time remaining in the TXOP. For example, the satellite AP may attempt one or more retransmissions of PDUs to the second wireless communication device (in accordance with the BA(s) received from the second wireless communication device) until a remaining time duration of the TXOP is, for example, less than or equal to a threshold time duration, at which time the satellite AP may transmit a BA to the first wireless communication device. In such implementations, the BA that the satellite AP transmits to the first wireless communication device may indicate which PDUs the satellite AP was able to deliver within the TXOP (regardless of whether the PDUs were successfully delivered to the second wireless communication device via an initial transmission attempt or a retransmission attempt). In both implementations in which the satellite AP refrains from performing retransmissions and in which the satellite AP performs retransmissions, the satellite AP may flush out a data status for the client device at the end of the TXOP. In other words, the satellite AP may not keep any memory of the PDUs for the client device after the shared TXOP expires.

Additionally, or alternatively, a satellite AP and a root AP may support a frame addressing mechanism according to which the satellite AP and the root AP may provide information indicative of whether a frame is relayed from, or is to be relayed to, a specific client device. For example, the satellite AP and the root AP may include an association identifier (AID) value or a medium access control (MAC) address in a data frame, a BA frame, or a management frame to indicate that the frame is relayed from, or is to be relayed to, a client device corresponding to the AID value or MAC address. In some implementations, the satellite AP and the root AP may include an AID value in data and BA frames and include a MAC address in management frames and preserve a 3-address format in the data frames, BA frames, or management frame. In such implementations, the satellite AP may use an AID to derive (such as calculate, select, or map to) a receiver address (RA) for data or BA frame transmissions in the downlink direction and may use a transmitter address (TA) to derive (such as calculate, select, or map to) an AID for data or BA frame transmissions in the uplink direction. Further, the satellite AP may use a MAC address to derive an RA for management frame transmissions in the downlink direction and may use a TA to derive a MAC address for management frame transmissions in the uplink direction. Additionally, or alternatively, a satellite AP and a root AP may support one or more mechanisms associated with beacon creation and transmission in accordance with a relay path to a client device or one or more mechanisms associated with group addressed frame delivery in accordance with the relay path, or both.

Particular aspects of the subject matter described in this disclosure can be implemented to realize one or more of the following potential advantages. In some implementations, by supporting data and BA forwarding across at least two hops within a single TXOP without reordering or retransmissions by a satellite AP, the devices involved in the relay path may deliver data with lower latency or lower complexity, or both. Such lower latency and lower complexity may be associated with the satellite AP refraining from performing processing operations associated with retransmissions and refraining from storing information associated with relayed data in a buffer of the satellite AP (which, in addition to lowering latency and complexity, may further reduce power consumption and memory costs at the satellite AP). For example, processing operations associated with security, reorder, and retransmission may be performed end-to-end (such as performed at one or both of the client device and the root AP) and the satellite AP may operate in a ‘pass through’ mode (such as a mode according to which BA contexts are managed directly by the root AP) accordingly, which may provide a lower cost at the satellite AP. In some other implementations, by supporting some amount of retransmission in accordance with a remaining time duration of a shared TXOP, the satellite AP may support greater reliability and greater throughput while still balancing latency and complexity costs. For example, by limiting potential retransmissions in accordance with how much time is remaining in the shared TXOP, the satellite AP may still meet a latency target (by completing operations prior to an expiration of the shared TXOP) and may refrain from storing information associated with relayed data for longer than the shared TXOP (as a data source device may assume responsibility for any further retransmissions in accordance with the satellite AP providing the BA to the data source device). Further, lower latency may be achieved by the root AP directly managing a QoS for the client device and by the TXOP allocation for the client devices with the satellite AP as a pass through.

Moreover, by supporting a 3-address format for data frames, BA frames, and management frames, the satellite AP and a root AP may further lower latency and lower processing costs, as one or both devices may avoid translating a 3-address frame into a 4-address frame, or vice versa. By supporting mechanisms associated with beacon frame creation and transmission and group addressed frames, various devices along the relay path may maintain synchronization and operate in accordance with mutually understood expectations (including expectations related to beacon payload buffering or group addressed frame encryption), which may reduce communication failures that might otherwise result from a lack of synchronization or misaligned expectations. Further, in accordance with the root AP storing and managing association and security context of the client device, the client device may experience more seamless mobility as the client device may avoid re-associating if the client device transitions from communicating indirectly with the root AP via the satellite AP to communicating directly with the root AP, or vice versa. Additionally, in accordance with the relay framework, the example implementations described herein may increase coverage for client devices, which may reduce “dead spots” and support greater mobility. As such, the described techniques may be implemented to realize lower latency, lower complexity, more efficient and lower power consumption, higher data rates, greater spectral efficiency, and greater reliability, among other benefits.

Various aspects further relate generally to multi-hop channel sounding sequences between a root AP and a STA via at least one satellite AP. Some aspects more specifically relate to frame addressing and TXOP sharing (and protection) to facilitate a multi-hop channel sounding within a single TXOP or service period (SP) (which may contain one or more TXOPs). In some implementations, an originating device (which may, for example, be a root AP in a downlink sounding sequence or a STA in an uplink sounding sequence) may transmit a first frame indicating identifying information corresponding to multiple other wireless communication devices to initiate a multi-hop channel sounding involving the multiple other wireless communication devices. For example, the originating device may include, in the first frame, identifying information corresponding to a satellite AP and identifying information corresponding to an end device with which the originating device may communicate via the satellite AP. The satellite AP may receive the first frame and, in accordance with the first frame including the identifying information for the satellite AP and the end device, may participate in, perform, or otherwise assist with a multi-hop channel sounding operation. In accordance with the multi-hop channel sounding operation, the satellite AP may measure a first wireless communication link between the originating device and the satellite AP, sound a second wireless communication link between the satellite AP and the end device, and transmit at least a second frame to the originating device indicating first channel information associated with the first wireless communication link and second channel information associated with the second wireless communication link. As such, the originating device may obtain channel information associated with both the first wireless communication link and the second wireless communication link and, in some implementations, may use the channel information to select one or more transmission parameters for communication along a relay path between the originating device and the end device. The originating device and the satellite AP may further support one or more frame exchanges associated with TXOP sharing and protection and route selection, along with or separate from simultaneous sounding at both the satellite AP and the end device in accordance with a STA capability. For example, one or more of the originating device, the satellite AP, and the end device may protect the TXOP or the SP by transmitting one or more frames in association with transferring medium access (during a shared TXOP or SP) to a next hop device to reduce the likelihood that other devices interrupt or interfere with the multi-hop channel sounding operation. Such frames may include, for example, one or more request to send (RTS) frames (such as one or more multi-user (MU) RTS frames) or one or more clear to send (CTS) frames, or any combination thereof.

Particular aspects of the subject matter described in this disclosure can be implemented to realize one or more of the following potential advantages. In some implementations, by facilitating multi-hop channel sounding within a single TXOP or SP, one or more of the originating device, the satellite AP, and the end device (each of which may be understood as a wireless communication device) may experience greater reliability and fewer communication errors in accordance with enabling more dynamic and lower latency link adaptation across multiple links of a relay path. For example, because an originating device may obtain channel information associated with each of multiple links of a relay path within a single TXOP or SP in accordance with the multi-hop channel sounding described in this disclosure, the originating device may select more suitable communication parameters or may more efficiently allocate resources to each ‘hop’ of the relay path for subsequent data communication, or both. Further, one or more of the originating device, the satellite AP, and the end device may experience greater throughput in accordance with the selection of more suitable communication parameters or the more efficient resource allocation. Additionally, in some implementations, one or more of the originating device, the satellite AP, and the end device may use the results or outcome of the multi-hop channel sounding operation to dynamically select, identify, or otherwise determine more efficient routes for data traffic between the originating device and the end device. For example, using the results of the multi-hop channel sounding operation, an originating device may compare first channel metrics of a direct route between the originating device and the end device to second channel metrics of an indirect route via the satellite AP and may select one of the direct route or the indirect route for subsequent communication in accordance with which route offers higher quality channel metrics. In accordance with such greater reliability, more dynamic link adaptation, greater throughput, and more dynamic and efficient route selection, one or more of the originating device, the satellite AP, and the end device may further experience higher data rates, greater spectral efficiency, greater system capacity, and more efficient power consumption (at least by way of reducing a quantity of potential retransmissions and avoiding multiple, separate sounding operations for each hop of the relay path), among other benefits.

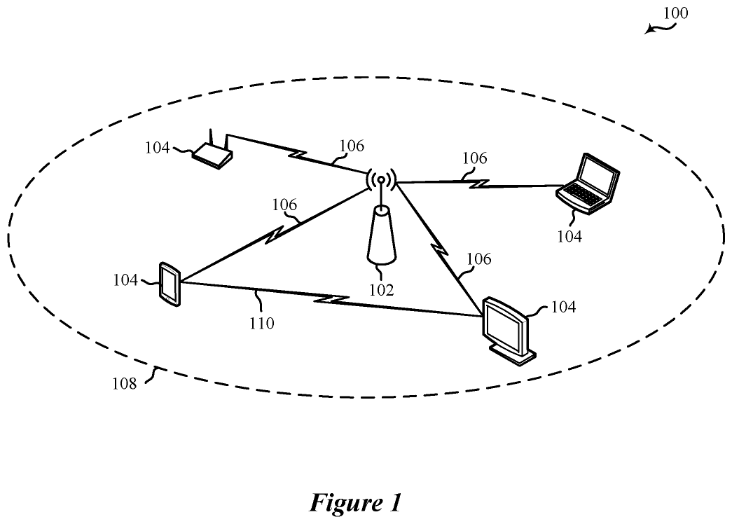

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and 802.11bn). The WLAN 100 may include numerous wireless communication devices such as a wireless AP 102 and multiple wireless STAs1. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE or 5G NR) can be further increased by a small cell which is supported by an AP 102 serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (such as TVs (including smart TVs), computer monitors, navigation systems, among others), music or other audio or stereo devices, remote control devices (“remotes”), printers, kitchen appliances (including smart refrigerators) or other household appliances, key fobs (such as for passive keyless entry and start (PKES) systems), Internet of Things (IoT) devices, smoke detectors, and vehicles, among other examples. The various STAs 104 in the network are able to communicate with one another via the AP 102.

A single AP 102 and an associated set of (such as one or more) STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which may be compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

Some APs 102 and STAs 104 may implement techniques for spatial reuse that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP. The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs 104.

In some examples of such TDMA techniques, each portion of a plurality of portions of the TXOP includes a set of (such as one or more) time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of (such as one or more) frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP 102. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs 102 may share at least a portion of a single TXOP obtained by any one of the participating APs 102, such techniques may increase throughput across the BSSs associated with the participating APs 102 and also may achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various implementations may achieve these and other advantages without requiring that the sharing AP 102 or the shared APs 102 be aware of the STAs 104 associated with other BSSs, without requiring a preassigned or dedicated master AP 102 or preassigned groups of APs 102, and without requiring backhaul coordination between the APs 102 participating in the TXOP.

In some examples in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs 104) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some implementations, the sharing AP 102 may perform polling of a set of (such as one or more) un-managed or non-co-managed APs 102 that support coordinated reuse to identify candidates for future spatial reuse opportunities. For example, the sharing AP 102 may transmit one or more spatial reuse poll frames as part of determining one or more spatial reuse criteria and selecting one or more other APs 102 to be shared APs 102. According to the polling, the sharing AP 102 may receive responses from one or more of the polled APs 102. In some specific examples, the sharing AP 102 may transmit a coordinated AP TXOP indication (CTI) frame to other APs 102 that indicates time and frequency of resources of the TXOP that can be shared. The sharing AP 102 may select one or more candidate APs 102 upon receiving a coordinated AP TXOP request (CTR) frame from a respective candidate AP 102 that indicates a desire by the respective AP 102 to participate in the TXOP. The poll responses or CTR frames may include a power indication, for example, an RX power or RSSI measured by the respective AP 102. In some other examples, the sharing AP 102 may directly measure potential interference of a service supported (such as UL transmission) at one or more APs 102, and select the shared APs 102 based on the measured potential interference. The sharing AP 102 generally selects the APs 102 to participate in coordinated spatial reuse such that it still protects its own transmissions (which may be referred to as primary transmissions) to and from the STAs 104 in its BSS. The selected APs 102 may be allocated resources during the TXOP as described above.

Some wireless communication devices (including both APs 102 and STAs 104) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102. Each communication link may support one or more sets of channels or logical entities. In some implementations, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs 102 each configured to communicate on a respective communication link with a respective one of multiple STAs 104 of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA 104 is simultaneously transmitted across multiple communication links in parallel to maximize the utilization of available resources to achieve higher throughput. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in various ways. In some implementations, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the example of a single BSS. For example, multi-link aggregation may increase the number of users per multiplexed transmission served by the multi-link AP MLD.

As described herein, a PDU can be configured as a PPDU. A PDU may include a PHY preamble and a PHY payload. The payload may be modulated according to a BPSK modulation scheme, a quadrature BPSK (Q-BPSK) modulation scheme, a quadrature amplitude modulation (QAM) modulation scheme, or another appropriate modulation scheme. The payload may include a PSDU including a data field that, in turn, may carry higher layer data, for example, in the form of MAC protocol data units (MPDUs) or an aggregated MPDU (A-MPDU).

In some implementations, various wireless communication devices of the WLAN 100 may support signaling mechanisms according to which the various wireless communication devices may relay PDUs and a BA associated with the relayed PDUs within a single TXOP. For example, an AP 102 (such as a root AP 102, which may be an example of an AP that is directly connected to the internet and manages communication across the WLAN 100) may communicate with a STA 104 (such as a client device) via one or more other wireless communication devices. Such one or more other wireless communication devices may be understood or referred to as one or more satellite APs 102, but may be examples of APs 102 or STAs 104. In some implementations, the AP 102 may communicate indirectly with the STA 104 in accordance with an end-to-end encryption associated with a relay path between the AP 102 and the STA 104.

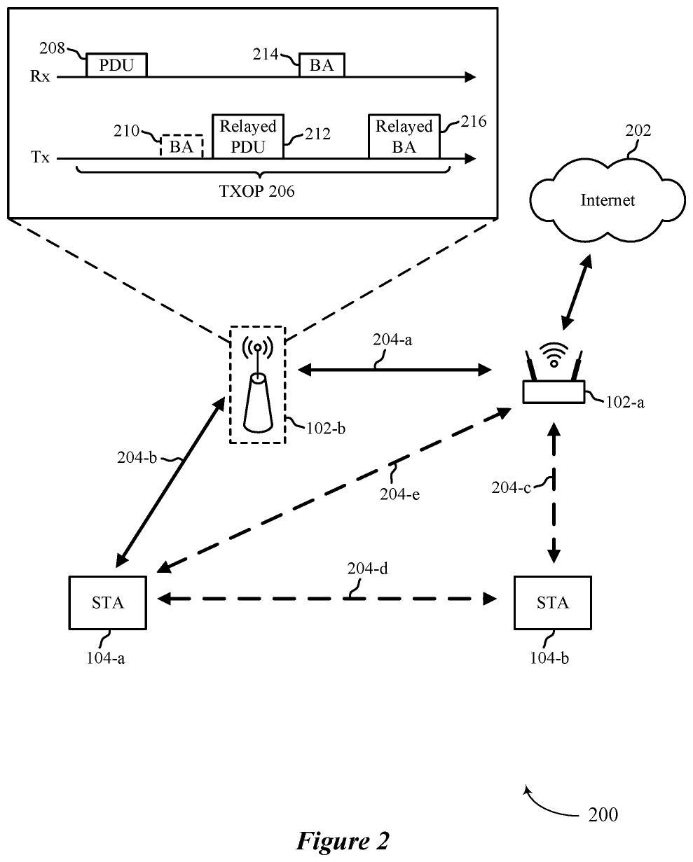

FIG. 2 shows an example signaling diagram 200 that supports signaling mechanisms for low latency and low complexity relay designs. The signaling diagram 200 may implement or be implemented to realize aspects of the WLAN 100. For example, the signaling diagram 200 illustrates communication between a root AP 102-a, a satellite AP 102-b, a STA 104-a, and a STA 104-b. The STA 104-a and the STA 104-b may be examples of STAs 104 (as illustrated by and described with reference to FIG. 1) and each may be an example of a client device, such as a smartphone, a laptop, a headset (such as an AR, VR or XR device), an Internet of Things (IoT) device, an automobile or automotive device, a wearable device, or any other wireless communication device that may be operated or otherwise used by an end user. The root AP 102-a may be an example of an AP 102 as illustrated by and described with reference to FIG. 1 and may be directly (or indirectly) connected to an internet 202. The satellite AP 102-b may be an example of an AP 102 or a STA 104 as illustrated by and described with reference to FIG. 1. For example, the satellite AP 102-b may be deployed as an AP 102 or may be a STA 104 that is capable of functioning as an AP 102 (such as a soft-AP). As described herein, each of the root AP 102-a, the satellite AP 102-b, the STA 104-a, and the STA 104-b may be an example of a wireless communication device.

A STA 104 (such as the STA 104-a or the STA 104-b) may communicate (such as transmit or receive, or both) with the root AP 102-a directly via a single communication link or indirectly via a relay path, and may switch between direct and indirect communication in accordance with a mobility of the STA 104. As illustrated in the example of the signaling diagram 200, the STA 104-a may communicate with the root AP 102-a indirectly via the satellite AP 102-b and the STA 104-b may communicate with the root AP 102-a directly. For example, the root AP 102-a may communicate with the satellite AP 102-b via a communication link 204-a and the satellite AP 102-b may communicate with the STA 104-a via a communication link 204-b. The root AP 102-a may communicate with the STA 104-b via a communication link 204-c. In some aspects, the STA 104-a and the STA 104-b may communicate via a communication link 204-d, which may be an example of a P2P link.

The wireless communication devices of the signaling diagram 200 may support a unified, versatile mesh framework that allows (such as enables or facilitates) flexibility to cater to different uses, deployment scenarios, or applications (such as to different market segments). In other words, the wireless communication devices of the signaling diagram 200 may support a unified design with different configurations and settings to differentiate (and adapt to) different uses. In accordance with such a mesh framework, the wireless communication devices of the signaling diagram 200 may support relay extensions (such as ultra-high reliability (UHR), also known as 802.11bn or Wi-Fi 8 relay extensions), which may provide lower latency and greater coverage. In some implementations, various wireless communication devices may achieve low latency support for some applications (such as XR-based applications) in accordance with a network-level reservation scheme across multiple hops in the mesh framework. In some aspects, the mesh framework may leverage a “phone as pseudo-mesh” scheme for XR or phone-compute applications.

Various wireless communication devices may achieve range extension using a relay path. For example, the root AP 102-a may serve a client that is multiple (such as two or more) hops away within a same TXOP (such as a single TXOP). In some aspects, the root AP 102-a may serve a client that is multiple hops away within a same TXOP for some application types, such as IoT applications associated with low latency and medium or low throughput. Relay paths may provide range extension in various deployment scenarios and for various uses, including to provide coverage to home network “dead spots” (such as a garage, an attic, a den, or a crawlspace, etc.), to various devices in a house (such as high definition (HD) cameras at a front or back door, or a drone), or to various automotive devices (such as to provide coverage between trailer rear or side cameras or sensors and a dashboard monitor). Some systems may deploy a low cost relay node to facilitate relay paths without adding too much computational or processing overhead (and corresponding power consumption) to the system. Such a low cost relay node may lack a complex scheduler for serving multiple clients and may avoid additional memory space for holding a buffer (such as a data buffer) or storing information for retransmissions.

In implementations in which the root AP 102-a communicates with the STA 104-a via the satellite AP 102-b, the relayed communication between the root AP 102-a and the STA 104-a may be associated with one or more latency, mobility, and simplicity targets. In terms of latency, for example, the relayed communication may be associated with a one-way end-to-end delay target. For some applications, such a one-way end-to-end delay target may be 5 milliseconds with a 100 megabits per second (Mbps) target for downlink communication. For some other applications (such as applications associated with predictive management (PdM)), such a one-way end-to-end delay target may be 2 milliseconds with a 200 Mbps target for downlink communication. To achieve such latency targets, various wireless communication devices of the signaling diagram 200 may employ signaling mechanisms associated with P2P TXOP sharing (TXS). For example, the root AP 102-a may manage a QoS and schedule clients (such as schedule all clients). In other words, the root AP 102-a may manage (such as schedule and coordinate with) wireless communication devices within a system regardless of whether the wireless communication devices are directly or indirectly connected to the root AP 102-a. In some aspects, the root AP 102-a may schedule clients associated with the satellite AP 102-b through P2P TXS, which may reduce processing complexity and increase simplicity at the satellite AP 102-b by enabling the satellite AP 102-b to avoid scheduling clients (and to avoid channel contention by the satellite AP 102-b).

In terms of mobility, the root AP 102-a, the satellite AP 102-b, and the STA 104-a may support signaling mechanisms to realize seamless mobility of the STA 104-a (which may be an example of XR glasses) between the satellite AP 102-b and the root AP 102-a. To achieve such mobility targets, various wireless communication devices of the signaling diagram 200 may employ a UHR mobility framework. For example, the root AP 102-a and the satellite AP 102-b may be part of a single MLD and UHR clients may avoid performing reassociation during mobility between the satellite AP 102-b and the root AP 102-a. As such, the STA 104-a may communicate with (such as transmit to or receive from) the root AP 102-a indirectly via the satellite AP 102-b during a first time period and may communicate with (such as transmit to or receive from) the root AP 102-a directly during a second time period, and the STA 104-a may refrain from performing a reassociation procedure when switching from indirect to direct communication.

In some aspects, the satellite AP 102-b may be a non-collocated affiliated AP of the root AP 102-a and the root AP 102-a may manage (such as control, for example via signaling) management or upper MAC functions for clients (such as all clients), regardless of whether such clients are associated with the root AP 102-a directly or through the satellite AP 102-b. In some implementations, the root AP 102-a may receive contextual information of a set of (such as one or more) wireless communication devices within a system and may use the contextual information to manage the set of wireless communication devices, regardless of whether the wireless communication devices are associated directly with the root AP 102-a or indirectly via a satellite AP (such as the satellite AP 102-b). For example, such management by the root AP 102-a may at least be associated with (such as include or involve) receiving and storing, at the root AP 102-a, association contexts, security contexts, or BA contexts, or any combination thereof, of the set of wireless communication devices. Accordingly, as used herein, contextual information may include information pertaining to an association context, a security context, or a BA context, or any combination thereof.

In terms of simplicity, the satellite AP 102-b may communicate in accordance with one or more decisions associated with end-to-end reordering, retransmissions, or encryption to reduce a processing complexity at the satellite AP 102-b. In some aspects, the satellite AP 102-b may support such one or more decisions to enable any wireless communication device (such as any AP 102, any STA 104, or any other client device) to be capable of operating as a satellite AP. For example, the satellite AP 102-b may support one or more design considerations to avoid complex scheduling and to avoid major additional buffers (such as buffers that the satellite AP 102-b would otherwise use for reordering, retransmitting, or the like for one or multiple clients), which may enable many different types of wireless communication devices to function as a satellite AP. Accordingly, in some implementations, the satellite AP 102-b may not be responsible for reordering received packets (in the event that the satellite AP 102-b fails to receive one or more packets) or retransmitting any missed packets (in the event that a destination device fails to receive one or more relayed packets). In other words, the satellite AP 102-b may forward the packets that the satellite AP 102-b successfully receives, regardless of whether there are missing packets (which may reduce latency along with reducing processing complexity), and the satellite AP 102-b may not retransmit any packets that the satellite AP 102-b fails to deliver. In some other implementations, the satellite AP 102-b may support or perform some amount of retransmissions within a TXOP 206, and an upper limit quantity of retransmissions that the satellite AP 102-b may perform within the TXOP 206 may be associated with a duration of the TXOP 206. Across any of such example implementations, the satellite AP 102-b may be able to decode and forward packets within a TXOP 206. As such, the satellite AP 102-b may forward the packets within a same TXOP 206 during which the satellite AP 102-b receives the packets.

In some aspects, such latency, mobility, and simplicity targets may limit which device types are able to associate with the root AP 102-a. For example, such a simplified relay node design may allow UHR clients (such as client devices operating in accordance with 802.11bn) to associate and may limit other device types from associating. Such a limitation on other device types from associating may include mechanisms that enable other device types to associate with restrictions, such as a restriction to operate with MU enhanced distributed channel access (EDCA). For example, the root AP 102-a may associate with a non-UHR client if the non-UHR client agrees to contend for channel access in accordance with an MU EDCA scheme.

In some implementations, the root AP 102-a, the satellite AP 102-b, and the STA 104-a may support one or more mechanisms associated with group addressed frame delivery via the relay path. In such implementations, the root AP 102-a may receive a group addressed frame from a distribution system (DS) and the root AP 102-a may assign a sequence number (SN) and duplicate the group addressed frame to a set of affiliated APs (such as one or more affiliated APs, or all affiliated APs). In accordance with some example implementations, the root AP 102-a may transmit (or otherwise provide) a group addressed frame (or information pertaining to a group addressed frame) to one or multiple satellite APs 102 including the satellite AP 102-b in one of multiple manners.

In some implementations, the root AP 102-a may form (such as construct or generate) a frame encrypted by a groupwise transient key (GTK) of an affiliated AP (such as the satellite AP 102-b) and may send the encrypted frame to the affiliated AP as an encrypted unicast frame. For example, because the root AP 102-a may manage affiliated APs, the root AP 102-a may store or otherwise have access to a GTK corresponding to each affiliated AP, where each respective affiliated AP may be associated with a respective GTK. In such examples, the satellite AP 102-b may unencrypt the frame and transmit the frame, as is (such as without changing or altering the frame), to the STA 104-a. In some other examples, the root AP 102-a may transmit an indication of an SN and a frame to the satellite AP 102-b as an encrypted unicast frame. In such examples, the satellite AP 102-b may decrypt the frame, encrypt the frame using a GTK of the satellite AP 102-b, and transmit the frame over-the-air to the STA 104-a.

In accordance with the example implementations described herein, the satellite AP 102-b may relay data packets and feedback information between the STA 104-a and the root AP 102-a within a single TXOP 206. For example, the satellite AP 102-b may receive a set of PDUs 208 (which may be equivalently referred to or understood as one or more data packets, PPDUs, MPDUs, or an A-MPDU) from a first wireless communication device and may transmit a set of relayed PDUs 212 to a second wireless communication device within the TXOP 206. Further, the satellite AP 102-b may receive a BA 214 (such as feedback information) associated with the set of relayed PDUs 212 from the second wireless communication device and may transmit a relayed BA 216 to the first wireless communication device within the TXOP 206. In some implementations, the satellite AP 102-b may relay the PDUs and the BA in accordance with an end-to-end encryption. In some implementations, the satellite AP 102-b may transmit a BA 210 associated with the set of PDUs 208 to the first wireless communication device. In such implementations, the first wireless communication device may use the BA 210 for rate adaptation and may refrain from using the BA 210 to empty a buffer at the first wireless communication device associated with the set of PDUs 208 (as the first wireless communication device is yet to receive feedback information associated with successful reception by the second wireless communication device to which the set of PDUs 208 are intended).

The first wireless communication device may be the root AP 102-a or the STA 104-a and the second wireless communication device may be the other of the root AP 102-a or the STA 104-a. In some implementations, the satellite AP 102-b and the root AP 102-a may include information indicative of the STA 104-a in the frames transmitted between each other, which may indicate that a frame is relayed from the STA 104-a (if the frame is transmitted from the satellite AP 102-b to the root AP 102-a) or that a frame is to be relayed to the STA 104-a (if the frame is transmitted from the root AP 102-a to the satellite AP 102-b). Further, the TXOP 206 may be obtained by any one of the root AP 102-a, the satellite AP 102-b, and the STA 104-a and shared (such as via a TXS frame) to others of the root AP 102-a, the satellite AP 102-b, and the STA 104-a to facilitate (such as to enable) the relaying of communications between the root AP 102-a and the STA 104-a. In some implementations, any one or more of the root AP 102-a, the satellite AP 102-b, and the STA 104-a may transmit or receive one or more frames associated with an end-to-end reservation of the relay path to protect communication across each hop of the relay path from transmissions by other wireless communication devices.

As such, the root AP 102-a, the satellite AP 102-b, and the STA 104-a may provide or otherwise support a relay framework having complementary design pillars, including seamless mobility, low latency and QoS handling, and simplicity (such as low processing complexity). For example, the example implementations described herein may support seamless mobility between a relay node (such as the satellite AP 102-b) and a root node (such as the root AP 102-a) in accordance with using a UHR single mobility domain MLD. Further, the example implementations described herein may support low latency and QoS handling in accordance with using TXOP sharing between the root AP 102-a and the satellite AP 102-b or between the satellite AP 102-b and the STA 104-a. Further, the example implementations described herein may support simplicity associated with less memory and an absence of a complex scheduler in accordance with using packet forwarding without reordering or retransmission at the satellite AP 102-b.

Accordingly, the described simplified relay mechanisms may provide a low cost solution (in terms of computational complexity, storage space, and power draw) for low latency, high mobility, and low-to-mid throughput traffic. In some implementations, the wireless communication devices of the signaling diagram 200 may employ the described simplified relay mechanisms in a mesh-type deployment, such as an easy-mesh deployment (which may be associated with backhaul efficiency and potential duplicate transmissions of packets in simplified relay, capacity-limited scenarios). Further, although described herein in the context of a two-hop relay between the STA 104-a and the root AP 102-a via the satellite AP 102-b, the described techniques may be applicable to any multi-hop relays. For example, the described techniques may be extendable and equally applicable to relays associated with three hops, four hops, and so on between a data source device and a data destination device.

In some implementations, the wireless communication devices of the signaling diagram 200 may support one or more mechanisms associated with channel sounding and link adaptation, including with TXOP sharing or protection for greater medium utilization and reduced latency. In some aspects, TXOP sharing or protection for channel sounding may support greater medium utilization and reduced latency as compared to other sounding techniques. For example, some systems may employ per link sounding (such as per link uplink sounding or per link downlink sounding, or both) according to which frames associated with a channel sounding for a given link are transmitted and received during independent TXOPs or independent service periods (SPs), use separate addressing (such as separate RA and TA addresses), and establish separate BA sessions and separate link activities in general (such as power save schedules, which may be maintained for each link independently, making it difficult to ensure or otherwise achieve the timely delivery of the traffic due to a potential unavailability of one or more hops at a given time).

In some deployments, one or both of the AP 102-a and the AP 102-b may function as mesh APs 102. In such deployments, which may be understood as mesh or mesh-like deployments, wireless communication devices of the signaling diagram 200 may communicate via (pre-) established links and may potentially communicate with other wireless communication devices that are multiple hops away (such that there may be multiple hops between two wireless communication devices communicating with each other). Mesh APs 102 may compute (such as select, identify, analyze, or otherwise determine) traffic routes (in a centralized or decentralized manner), which may result in changing links between wireless communication devices (as network conditions or device locations change over time). In some scenarios, a STA 104 (such as the STA 104-a or the STA 104-b) may associate with one (single) mesh AP 102, such that changing links may cause complexity at the STA 104. For example, if a link between a STA 104 and a mesh AP 102 changes, the STA 104 may be expected to perform a re-association procedure to switch to communicating with another mesh AP. In accordance with such a re-association at the STA 104, one or more mesh APs 102 may be expected to re-compute a traffic route to the STA 104 (as a previous traffic route may be obsolete because of the re-association at the STA 104, which gives the STA 104 a new entry point (a new serving AP 102) in the mesh system). On top of such complexity resulting from re-association procedures and route re-computations, use of independent TXOPs or SPs and separate BA sessions may further complicate and add latency to link maintenance.

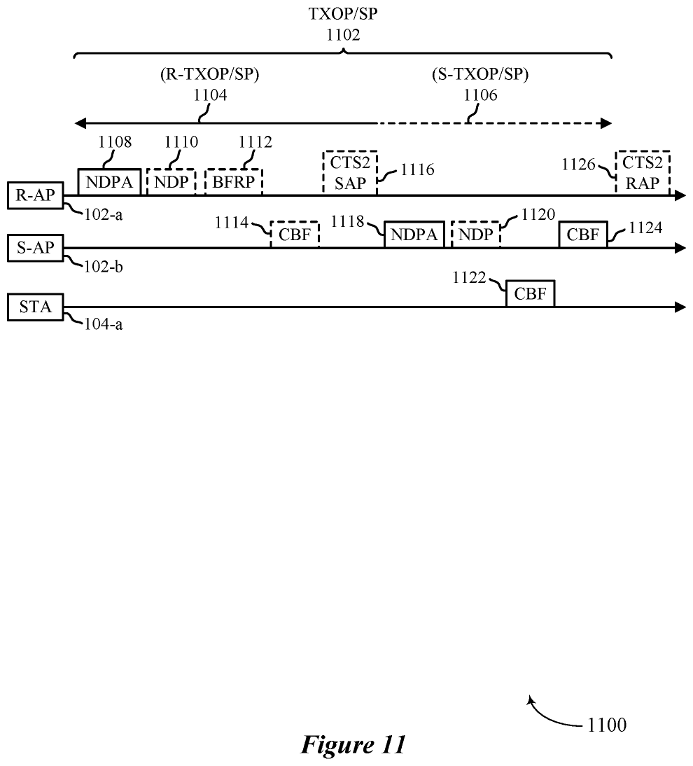

Accordingly, in some implementations, the wireless communication devices of the signaling diagram 200 may support an end-to-end (E2E) sounding protocol for one or both of relay selection and increasing throughput, as illustrated by and described in more detail with reference to FIGS. 11-14. In some examples, the STA 104-a may maintain or be capable of establishing a communication link 204-e (a direct communication link) with the root AP 102-a and may maintain or be capable of establishing a communication link with each of one or more satellite APs (such as one or both of the satellite AP 102-b and the STA 104-b, which may be examples of or otherwise function as satellite APs). The STA 104-a may maintain connectivity to the Internet 202 as long as at least one maintained wireless communication link remains strong (such as associated with a sufficiently high channel quality). As such, in examples in which the STA 104-a maintains at least two of the communication link 204-b, the communication link 204-d, and the communication link 204-e, the STA 104-a may maintain connectivity to the Internet 202 as long as at least one of such wireless communication links remains strong (such as associated with a sufficiently high channel quality), even if other wireless communication links become unavailable. In some aspects, the communication link 204-a, the communication link 204-b, the communication link 204-c, the communication link 204-d, and the communication link 204-e may be associated with a same channel (such as a same frequency channel). In some other aspects, one or more of the various communication links may be associated with different channels.

In the example of the signaling diagram 200, the root AP 102-a, the satellite AP 102-b, and the STA 104-b (which may be understood as another satellite AP) may establish and maintain relatively stable links with each other and, in some aspects, may be understood as being part of a same multi-link entity. Such a multi-link entity may be equivalently referred to or understood as a virtual or non-collocated MLD. In some aspects, the satellite AP 102-b (and satellite APs more generally) may expose a same address (such as a same MAC address) to the STA 104-a and the root AP 102-a. Further, the STA 104-a may be associated with (such as have or include) a capability associated with maintaining multiple links simultaneously. In some implementations, the STA 104-a may be associated with (such as have) a first capability according to which the STA 104-a may be connected with either the root AP 102-a or the satellite AP 102-b at any given time and may perform a re-association procedure to switch between the root AP 102-a and the satellite AP 102-b. In such implementations, the root AP 102-a and the satellite AP 102-b may coordinate to keep AIDs known and unchanged. A STA with such a first capability may be referred to as a basic STA, a legacy STA or an HE STA. In some other implementations, the STA 104-a may be associated with (such as have) a second capability according to which the STA 104-a may maintain connectivity with both the root AP 102-a and the satellite AP 102-b at any given time. In such implementations, the STA 104-a may perform or participate in a multi-link setup procedure with the root AP 102-a or the satellite AP 102-b and may have an AID assigned by the root AP 102-a and shared with the satellite AP 102-b. A STA with such a second capability may be referred to as an enhanced STA or a UHR STA.

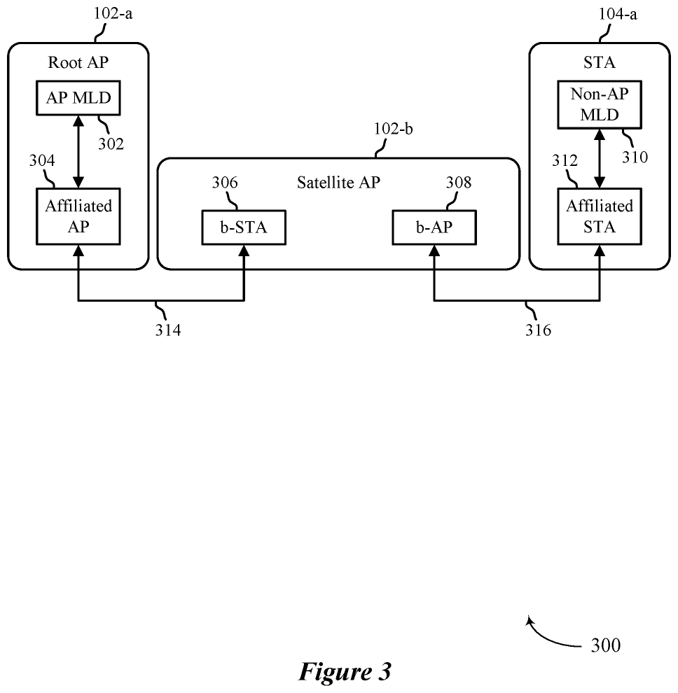

FIG. 3 shows an example data plane architecture 300 that supports signaling mechanisms for low latency and low complexity relay designs. The data plane architecture 300 may implement or be implemented to realize aspects of the WLAN 100 or the signaling diagram 200. For example, the data plane architecture 300 illustrates communication between a root AP 102-a and a STA 104-a via a satellite AP 102-b, and each of the root AP 102-a, the satellite AP 102-b, and the STA 104-a as illustrated by and described with reference to FIG. 3 may be examples of the root AP 102-a, the satellite AP 102-b, and the STA 104-a as illustrated by and described with reference to FIG. 2. In some implementations, the satellite AP 102-b may relay data frames and feedback information associated with the data frames between the root AP 102-a and the STA 104-a within a single TXOP.

As illustrated in the example of the data plane architecture 300, the root AP 102-a may include or be associated with an AP MLD 302 and may use an affiliated AP 304 to communicate with the satellite AP 102-b. For example, the satellite AP 102-b may include or be associated with a backhaul STA (b-STA) 306 and a backhaul AP (b-AP) 308 and the root AP 102-a may use the affiliated AP 304 to communicate with the b-STA 306 of the satellite AP 102-b via a communication link 314. The STA 104-a may include or be associated with a non-AP MLD 310 and may use an affiliated STA 312 to communicate with the satellite AP 102-b. For example, the STA 104-a may use the affiliated STA 312 to communicate with the b-AP 308 of the satellite AP 102-b via a communication link 316. The b-STA 306 and the b-AP 308 of the satellite AP 102-b may be different physical components or entities of the satellite AP 102-b, may be associated with different functionalities of the satellite AP 102-b, may be associated with different MAC addresses, or any combination thereof. Additionally, or alternatively, the b-STA 306 and the b-AP 308 of the satellite AP 102-b may share a same MAC address or time-share resources, or both. Similarly, the root AP 102-a may be an example of an AP MLD 302 and the affiliated AP 304 may be collocated or non-collocated with the AP MLD 302. Likewise, the STA 104-a may be an example of a non-AP MLD 310 and the affiliated STA 312 may be collocated or non-collocated with the non-AP MLD 310. In some aspects, the data plane architecture 300 may support or otherwise be in accordance with a separation between lower layer MAC and upper layer MAC functionalities.

In some aspects, the AP MLD 302 may perform operations associated with management signaling, security, buffer reordering, and retransmission and the affiliated AP 304 may perform operations associated with channel access, rate adaptation, and immediate or partial BA response. The b-STA 306 and the b-AP 308 may each perform operations associated with channel access, rate adaptation, and immediate or partial BA response. The non-AP MLD 310 may perform operations associated with management signaling, security, buffer reordering, and retransmission and the affiliated STA 312 may perform operations associated with channel access, rate adaptation, and immediate or partial BA response.

Accordingly, end-to-end operations at the root AP 102-a and the STA 104-a may include MLD management signaling operations, security operations, reorder buffer or retransmissions operations, and pass-through end-to-end BA operations. Through one or both of the b-STA 306 and the b-AP 308, the satellite AP 102-b may support per-link signaling, channel access (sometimes as scheduled by the root AP 102-a), and control level signaling between the root AP 102-a and the satellite AP 102-b and between the STA 104-a and the satellite AP 102-b. Additionally, or alternatively, the satellite AP 102-b may receive and store information associated with one or more security keys (such as end-to-end security keys) via which one or both of the root AP 102-a and the STA 104-a may use to protect over-the-air signaling. In some implementations, the satellite AP 102-b may lack a complex scheduler and may refrain from performing operations associated with reordering or retransmitting a buffer.

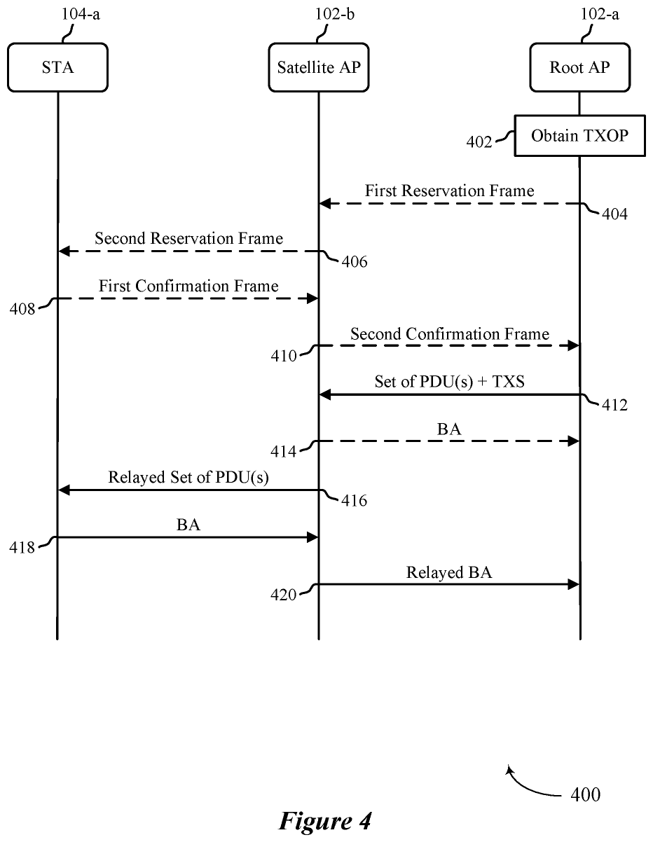

FIG. 4 shows an example process flow 400 that supports signaling mechanisms for low latency and low complexity relay designs. The process flow 400 may implement or be implemented to realize aspects of the WLAN 100, the signaling diagram 200, or the data plane architecture 300. For example, the process flow 400 illustrates communication between a root AP 102-a, a satellite AP 102-b, and a STA 104-a, and each of the root AP 102-a, the satellite AP 102-b, and the STA 104-a as illustrated by and described with reference to FIG. 4 may be examples of the root AP 102-a, the satellite AP 102-b, and the STA 104-a as illustrated by and described with reference to FIGS. 2 and 3. The root AP 102-a, the satellite AP 102-b, and the STA 104-a may communicate (such as transmit or receive) signaling in accordance with the process flow 400 in implementations in which the satellite AP 102-b relays downlink PPDUs from the root AP 102-a to the STA 104-a.

In the following description of the process flow 400, the operations may be performed (such as reported or provided) in a different order than the order shown, or the operations may be performed in different orders or at different times. For example, specific operations may be left out of the process flow 400, or other operations may be added to the process flow 400. Further, although some operations or signaling may be shown to occur at different times for explanatory purposes, these operations may actually occur at the same time.

At 402, the root AP 102-a may obtain a TXOP. The root AP 102-a may obtain the TXOP in one of various ways, including in accordance with an EDCA procedure, a differentiated channel access procedure according to which the root AP 102-a may have a higher priority or likelihood for obtaining channel access (relative to other devices in a system), or any other coordinated medium access scheme, such as during a coordinated restricted TWT (r-TWT) service period (SP).

At 404, the root AP 102-a may, in some implementations, transmit a first reservation frame to the satellite AP 102-b. In some aspects, the first reservation frame may be a first TXS reservation frame. At 406, the satellite AP 102-b may transmit a second reservation frame to the STA 104-a. In some aspects, the second reservation frame may be a second TXS reservation frame. At 408, the STA 104-a may transmit a first confirmation frame to the satellite AP 102-b. In some aspects, the first confirmation frame may be a first TXS confirmation frame. At 410, the satellite AP 102-b may transmit a second confirmation frame. In some aspects, the second confirmation frame may be a second TXS confirmation frame.

In some implementations, the first reservation frame, the second reservation frame, the first confirmation frame, and the second confirmation frame may be associated with an end-to-end reservation and may clear the relay path from an end-to-end perspective. For example, the signaling associated with the first reservation frame, the second reservation frame, the first confirmation frame, and the second confirmation frame may be a form of RTS/CTS signaling or MU RTS/CTS signaling. In such examples, the first reservation frame may be an (MU) RTS frame with an RA field indicative of the satellite AP 102-b, a TA field indicative of the root AP 102-a, and a duration field indicative of a whole network allocation vector (NAV) (such as an entire NAV) and the second reservation frame may be an (MU) RTS frame with an RA field indicative of the STA 104-a, a TA field indicative of the satellite AP 102-b, and a duration field indicative of the whole NAV. The first confirmation frame may be a CTS frame with an RA field indicative of the satellite AP 102-b and a duration field indicative of the whole NAV and the second confirmation frame may be a CTS-to-self frame with an RA field indicative of the satellite AP 102-b, a duration field indicative of the whole NAV, and a reasoning field indicative of an uplink triggered scenario.

As such, prior to transmitting data along the relay path, the root AP 102-a, the satellite AP 102-b, and the STA 104-a may exchange signaling to clear the relay path from interference from other wireless communication devices. In some aspects, the root AP 102-a, the satellite AP 102-b, and the STA 104-a may clear the relay path for a duration of the TXOP in accordance with the duration fields being indicative of the whole NAV. Additionally, or alternatively, one or more of the root AP 102-a, the satellite AP 102-b, and the STA 104-a may exchange channel quality information, such as via a channel quality indicator (CQI) via one or more of the first reservation frame, the second reservation frame, the first confirmation frame, and the second confirmation frame. In implementations in which CQI information is exchanged via one or more of the first reservation frame, the second reservation frame, the first confirmation frame, and the second confirmation frame, any one or more of the root AP 102-a, the satellite AP 102-b, and the STA 104-a may perform rate adaptation (for a corresponding link) in accordance with the CQI information.

At 412, the root AP 102-a may transmit, during the TXOP, a set of (such as one or more) PDUs to the satellite AP 102-b. In some aspects, the root AP 102-a may additionally transmit a TXS frame along with the set of PDUs, the TXS frame including information indicative of a sharing of the TXOP of the root AP 102-a with the satellite AP 102-b. For example, the root AP 102-a may transmit a downlink PPDU including an A-MPDU and a TXS frame. In some implementations, the root AP 102-a may encrypt the downlink PPDU using an end-to-end security key, such as an end-to-end pairwise transient key (PTK).

At 414, the satellite AP 102-b may, in some implementations, transmit a BA to the root AP 102-a associated with the set of PDUs. In such implementations, the BA may include information indicative of successfully received PDUs of the set of PDUs that the root AP 102-a transmitted to the satellite AP 102-b at 412. In some aspects, the root AP 102-a may use the BA received at 414 for rate adaptation and may refrain from emptying a buffer associated with the set of PDUs. In other words, the root AP 102-a may refrain from flushing buffers in accordance with receiving the BA at 414 from the satellite AP 102-b. In some implementations, the satellite AP 102-b may refrain from transmitting the BA at 414 if rate adaptation is performed via other ways (such as via CQI information provided in one or more of the first reservation frame, the second reservation frame, the first confirmation frame, and the second confirmation frame).

In some implementations, the root AP 102-a may refrain from performing any retransmissions of the set of PDUs prior to receiving feedback information from the STA 104-a. In some other implementations, the root AP 102-a and the satellite AP 102-b may perform one or more retransmissions prior to a relaying of data to the STA 104-a. In such implementations, the root AP 102-a may receive the BA at 414 and may retransmit one or more PDUs (or all of the initially transmitted PDUs) in accordance with the BA. For example, the root AP 102-a may compare the PDU(s) successfully received by the satellite AP 102-b (as indicated by the BA received at 414) with the set of PDUs that the root AP 102-a initially transmitted at 412 and may retransmit one or more PDUs that were unsuccessfully received by the satellite AP 102-b. In some aspects, the root AP 102-a and the satellite AP 102-b may support a single retransmission. In some other aspects, the root AP 102-a and the satellite AP 102-b may support potentially multiple retransmissions in accordance with a time duration of the TXOP (such as up to a quantity of retransmissions for which there is sufficient time to perform within the TXOP while still leaving time for the relay).

At 416, the satellite AP 102-b may transmit the set of PDUs to the STA 104-a. For example, the satellite AP 102-b may relay (such as forward) the set of PDUs received at 412 to the STA 104-a at 416. As such, the set of PDUs transmitted at 416 may be understood as a relayed set of PDUs or as relayed versions of the set of PDUs. In other words, the satellite AP 102-b may forward all successfully received MPDUs to the client. In some implementations, the satellite AP 102-b may locally select a modulation and coding scheme (MCS), a coding rate, or any other physical layer parameters to use for transmitting the set of PDUs to the STA 104-a. In some implementations, the satellite AP 102-b may refrain from reordering the successfully received PDUs.

At 418, the STA 104-a may transmit, to the satellite AP 102-b, a BA associated with the relayed set of PDUs. The BA may include information indicative of successfully received PDU(s) of the relayed set of PDUs. In some implementations, the satellite AP 102-b may record sequence numbers of PDUs sent to the STA 104-a at 416, compare the sequence numbers with the BA that the satellite AP 102-b receives at 418, and perform rate adaptation in accordance with the comparison. Further, although described in the example of the process flow 400 as being a BA, the STA 104-a may alternatively provide feedback information associated with the relayed set of PDUs via a multi-STA BA (M-BA). Accordingly, as described herein, a BA and an M-BA may be used interchangeably, and either may provide feedback information associated with a set of PDUs.

In some implementations, the satellite AP 102-b may relay (such as forward) the BA received at 418 to the root AP 102-a without performing any retransmissions of the relayed set of PDUs. In some other implementations, the satellite AP 102-b may perform one or more retransmissions to the STA 104-a in accordance with the BA received at 418. For example, the satellite AP 102-b may retransmit one or more PDUs that the STA 104-a failed to successfully receive (which the satellite AP 102-b may identify in accordance with receiving the BA at 418). In implementations in which the satellite AP 102-b performs one or more retransmissions to the STA 104-a, the satellite AP 102-b may perform up to a quantity of retransmissions in accordance with a time duration of the TXOP. For example, the satellite AP 102-b may continue to perform retransmissions (as applicable) to deliver any failed PDUs until there is less than or equal to a threshold time duration remaining in the TXOP. Such a threshold time duration may be associated with a time during which the satellite AP 102-b is expected to provide a BA to the root AP 102-a. In other words, the farther under the threshold time duration the satellite AP 102-b goes without transmitting a BA to the root AP 102-a, the more at risk the satellite AP 102-b may be of failing to deliver a BA to the root AP 102-a within the TXOP.

At 420, the satellite AP 102-b may transmit, to the root AP 102-a, a relayed BA associated with the relayed set of PDUs. In some implementations, the satellite AP 102-b may forward the BA received at 418 to the root AP 102-a at 420 in accordance with an end-to-end security. For example, the satellite AP 102-b may encrypt the relayed BA in accordance with (such as using) an end-to-end security key. The relayed BA that the satellite AP 102-b transmits to the root AP 102-a may be a forwarded version of the BA received from the STA 104-a at 418, or may be associated with an aggregation of BAs received from the STA 104-a (if the satellite AP 102-b performs one or more retransmissions to the STA 104-a, responsive to which the STA 104-a may provide one or more additional BAs). In some implementations, the relayed BA may be an M-BA. For example, the satellite AP 102-b (such as the b-STA 306 of the satellite AP 102-b) may use an M-BA for relaying the feedback information associated with the relayed set of PDUs.

In accordance with receiving the BA at 420, the root AP 102-a may retransmit one or more PDUs missing per the BA status obtained at 420. The root AP 102-a may perform such retransmissions during the TXOP shared for the relay (if there is sufficient time remaining in the current TXOP) or during a subsequent TXOP.

In some implementations, if the satellite AP 102-b provides the BA to the root AP 102-a with some amount of time remaining in the shared TXOP, the root AP 102-a may perform an early termination of the TXOP. In some implementations, the root AP 102-a may transmit a contention free end (CF-End) frame to the satellite AP 102-b (with an RA indicative of the satellite AP 102-b) to indicate an early termination of the TXOP. Additionally, or alternatively, the root AP 102-a may perform a channel access scheme to obtain control of the TXOP if, for example, the root AP 102-a aims to serve another wireless communication device (such as another satellite AP or another client device) during the TXOP. Such a channel access scheme may include point coordination function (PCF) interframe space (PIFS) access.

In some implementations, the root AP 102-a and the satellite AP 102-b may use a 4-address frame format for frames transmitted between the root AP 102-a and the satellite AP 102-b. In some other implementations, the root AP 102-a and the satellite AP 102-b may use a 3-address frame format for frames transmitted between the root AP 102-a and the satellite AP 102-b. In such implementations, the satellite AP 102-b may preserve a 3-address format for both hops (to keep an MPDU size unchanged) in accordance with an addressing translation by the satellite AP 102-b. The satellite AP 102-b may perform such addressing translation as part of relaying downlink PDUs or BAs, or both.

For example, as part of downlink PDU forwarding (such as downlink QoS data forwarding), the set of PDUs transmitted by the root AP 102-a at 412 may include a first address field (such as an RA field) indicative of the satellite AP 102-b, a second address field (such as a TA field) indicative of the root AP 102-a, and a field indicative of the STA 104-a. The field indicative of the STA 104-a may be an EHT-SIG field or a User field in which a STA ID is set equal an AID value of the STA 104-a, or may be an A-control field including an AID value of the STA 104-a. The satellite AP 102-b may identify, ascertain, or otherwise determine that the set of PDUs are to be relayed to the STA 104-a in accordance with the set of PDUs including the field indicative of the STA 104-a. In some implementations, the satellite AP 102-b (such as the b-AP 308 of the satellite AP 102-b) may use the AID value of the STA 104-a indicated by the set of PDUs received at 412 to derive an RA field value for the relayed set of PDUs transmitted at 416.

Further, as part of BA forwarding, the BA received by the satellite AP 102-b at 418 may include a first address field (such as an RA field) indicative of the satellite AP 102-b and a second address field (such as a TA field) indicative of the STA 104-a. In accordance with the relay path between the STA 104-a and the root AP 102-a, the satellite AP 102-b may generate the relayed BA such that the relayed BA includes a first address field (such as an RA field) indicative of the root AP 102-a, a second address field (such as a TA field) indicative of the satellite AP 102-b, and a field indicative of the STA 104-a. The field indicative of the STA 104-a may be a STA ID field of the relayed BA and may be indicative of the STA 104-a by way of indicating an AID value of the STA 104-a.

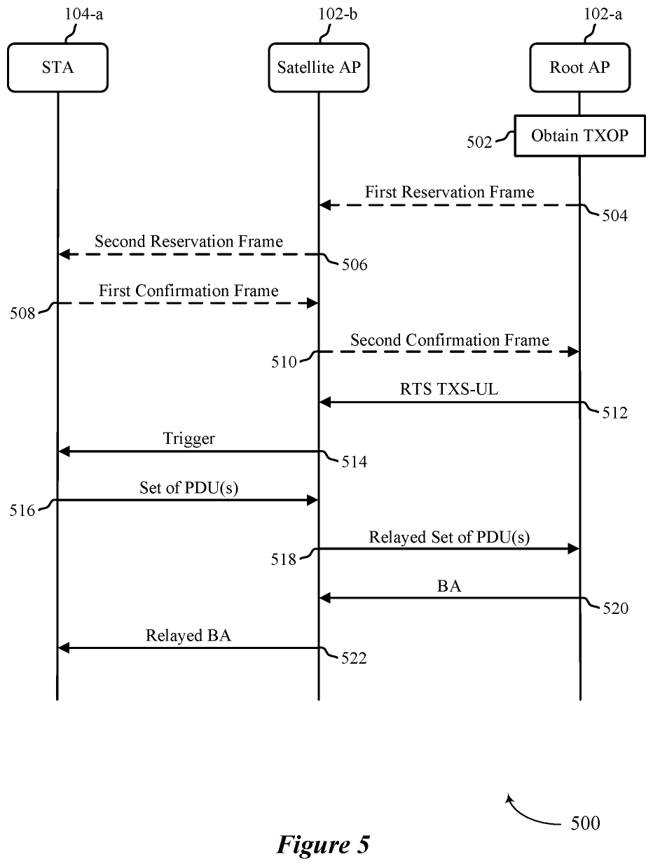

FIG. 5 shows an example process flow 500 that supports signaling mechanisms for low latency and low complexity relay designs. The process flow 500 may implement or be implemented to realize aspects of the WLAN 100, the signaling diagram 200, or the data plane architecture 300. For example, the process flow 500 illustrates communication between a root AP 102-a, a satellite AP 102-b, and a STA 104-a, and each of the root AP 102-a, the satellite AP 102-b, and the STA 104-a as illustrated by and described with reference to FIG. 5 may be examples of the root AP 102-a, the satellite AP 102-b, and the STA 104-a as illustrated by and described with reference to FIGS. 2-4. The root AP 102-a, the satellite AP 102-b, and the STA 104-a may communicate (such as transmit or receive) signaling in accordance with the process flow 500 in implementations in which the satellite AP 102-b relays trigger-based uplink PPDUs from the STA 104-a to the root AP 102-a.

In the following description of the process flow 500, the operations may be performed (such as reported or provided) in a different order than the order shown, or the operations may be performed in different orders or at different times. For example, specific operations may be left out of the process flow 500, or other operations may be added to the process flow 500. Further, although some operations or signaling may be shown to occur at different times for explanatory purposes, these operations may actually occur at the same time.

At 502, the root AP 102-a may obtain a TXOP. The root AP 102-a may obtain the TXOP in one of various ways, including in accordance with an EDCA procedure, a differentiated channel access procedure according to which the root AP 102-a may have a higher priority or likelihood for obtaining channel access (relative to other devices in a system), or any other coordinated medium access scheme, such as during a coordinated r-TWT SP.

At 504, the root AP 102-a may, in some implementations, transmit a first reservation frame to the satellite AP 102-b. In some aspects, the first reservation frame may be a first TXS reservation frame. At 506, the satellite AP 102-b may transmit a second reservation frame to the STA 104-a. In some aspects, the second reservation frame may be a second TXS reservation frame. At 508, the STA 104-a may transmit a first confirmation frame to the satellite AP 102-b. In some aspects, the first confirmation frame may be a first TXS confirmation frame. At 510, the satellite AP 102-b may transmit a second confirmation frame. In some aspects, the second confirmation frame may be a second TXS confirmation frame.

In some implementations, the first reservation frame, the second reservation frame, the first confirmation frame, and the second confirmation frame may be associated with an end-to-end reservation and may clear the relay path from an end-to-end perspective. For example, the signaling associated with the first reservation frame, the second reservation frame, the first confirmation frame, and the second confirmation frame may be a form of RTS/CTS signaling or MU RTS/CTS signaling, as described in more detail with reference to FIG. 4. In some implementations, if the root AP 102-a, the satellite AP 102-b, and the STA 104-a employ a coordinated r-TWT channel access scheme, the root AP 102-a, the satellite AP 102-b, and the STA 104-a may refrain from exchanging the signaling associated with the end-to-end reservation.

At 512, the root AP 102-a may transmit a frame associated with sharing the TXOP of the root AP 102-a with the satellite AP 102-b. For example, the root AP 102-a may transmit an RTS TXS-uplink (UL) frame to the satellite AP 102-b, which may share the TXOP of the root AP 102-a with the satellite AP 102-b (and may cause the satellite AP 102-b to transmit a Trigger frame to the STA 104-a). In some aspects, such an RTS TXS-UL frame may be a form of MU RTS TXS associated with satellite AP relaying to initiate (such as cause or trigger) an uplink trigger.

At 514, for example, the satellite AP 102-b may transmit a Trigger frame to the STA 104-a. The satellite AP 102-b may transmit the Trigger frame to the STA 104-a in accordance with receiving the frame associated with the sharing of the TXOP of the root AP 102-a at 512.

At 516, the STA 104-a may transmit a set of PDUs (such as a set of one or more uplink packets) to the satellite AP 102-b in accordance with receiving the Trigger frame from the satellite AP 102-b at 514. In some implementations, the STA 104-a may use a TB PPDU (such as a TB UL PPDU) to send the set of PDUs. In some implementations, the STA 104-a may encrypt the UL PPDU in accordance with an end-to-end security key, such as an end-to-end PTK. In some aspects, while a client device (such as the STA 104-a) may be constrained to transmit BA frames approximately immediately after receiving a data packet, an AP 102 may wait to respond (such as to provide a responsive BA) to a client. As such, in some implementations, the satellite AP 102-b may not transmit a BA to the STA 104-a associated with the set of PDUs transmitted at 516 within the shared TXOP.

At 518, the satellite AP 102-b may transmit the set of PDUs (received from the STA 104-a) to the root AP 102-a. In other words, the satellite AP 102-b may transmit a relayed set of PDUs to the root AP 102-a. For example, the satellite AP 102-b may relay (such as forward) successfully received PDUs of the set of PDUs from the STA 104-a to the root AP 102-a. In some implementations, the satellite AP 102-b may forward the successfully received PDUs of the set of PDUs to the root AP 102-a using an UL single user (SU) PPDU. In some implementations, the satellite AP 102-b may forward the successfully received PDUs of the set of PDUs without reordering or receiving any retransmissions from the STA 104-a. In some other implementations, the satellite AP 102-b may receive some retransmissions from the STA 104-a and may forward all of the PDUs that the satellite AP 102-b was able to successfully receive across an initial transmission attempt and one or more retransmission attempts.

At 520, the root AP 102-a may transmit a BA to the satellite AP 102-b associated with the relayed set of PDUs. The BA may include information indicative of successfully received PDU(s) of the relayed set of PDUs. In some implementations, the root AP 102-a may encrypt the BA using end-to-end security, such as an end-to-end security key. In some implementations, the satellite AP 102-b may refrain from performing any retransmissions associated with the relayed set of PDUs. In some other implementations, the satellite AP 102-b may perform one or more retransmissions of at least a subset of the relayed set of PDUs in accordance with the BA received from the root AP 102-a at 520. In such implementations, the satellite AP 102-b may perform one or more retransmissions in accordance with a time duration remaining in the TXOP. In some implementations, the BA may be an M-BA. For example, the root AP 102-a may use an M-BA for relaying the feedback information associated with the relayed set of PDUs.

In some implementations, the satellite AP 102-b may perform rate adaptation in accordance with the BA received at 520. For example, the satellite AP 102-b may note (such as record or otherwise keep track of) a set of sequence numbers of the relayed set of PDUs (which may be examples of MPDUs) sent to the root AP 102-a at 518, compare the set of sequence numbers with the BA received from the root AP 102-a at 520, and adjust a rate (such as a coding rate) or any other physical layer parameter of the communication link between the root AP 102-a and the satellite AP 102-b in accordance with the comparison.

At 522, the satellite AP 102-b may relay (such as forward), from the root AP 102-a to the STA 104-a, the BA associated with the relayed set of PDUs. In other words, the satellite AP 102-b may transmit a relayed BA to the STA 104-a, where the relayed BA is a relayed version of the BA received at 520. In some implementations, the satellite AP 102-b may transmit the relayed BA in accordance with the end-to-end security of the BA. In implementations in which the satellite AP 102-b refrains from performing retransmissions to the root AP 102-a, the BA received at 520 and the relayed BA transmitted at 522 may be the same (such as may include the same indication of successfully delivered PDUs). In implementations in which the satellite AP 102-b performs one or more retransmissions to the root AP 102-a, the relayed BA may be indicative of all PDUs that the satellite AP 102-b was able to successfully deliver across an initial transmission attempt and one or more retransmission attempts. Further, although described in the example of the process flow 500 as being a BA, the satellite AP 102-b may alternatively provide feedback information associated with the relayed set of PDUs via an M-BA. Accordingly, as described herein, a BA and an M-BA may be used interchangeably, and either may provide feedback information associated with a set of PDUs.

In accordance with receiving the relayed BA at 522, the STA 104-a may perform one or more retransmissions (during the TXOP or a subsequent TXOP). For example, the STA 104-a may retransmit a set of (such as all) PDUs (such as MPDUs) missing per the relayed BA received at 522.

In some implementations, if the satellite AP 102-b provides the BA to the STA 104-a with some amount of time remaining in the shared TXOP, the root AP 102-a may perform an early termination of the TXOP. In some implementations, the root AP 102-a may transmit a CF-End frame to the satellite AP 102-b (with an RA indicative of the satellite AP 102-b) to indicate an early termination of the TXOP. Additionally, or alternatively, the root AP 102-a may perform a channel access scheme to obtain control of the TXOP if, for example, the root AP 102-a aims to serve another wireless communication device (such as another satellite AP 102 or another STA 104) during the TXOP. Such a channel access scheme may include PIFS access.

In some implementations, the root AP 102-a and the satellite AP 102-b may use a 4-address frame format for frames transmitted between the root AP 102-a and the satellite AP 102-b. In some other implementations, the root AP 102-a and the satellite AP 102-b may use a 3-address frame format for frames transmitted between the root AP 102-a and the satellite AP 102-b. In such implementations, the satellite AP 102-b may preserve a 3-address format for both hops (to keep an MPDU size unchanged) in accordance with an addressing translation by the satellite AP 102-b. The satellite AP 102-b may perform such addressing translation as part of relaying uplink PDUs or responsive BAs, or both.

For example, as part of uplink PDU forwarding (such as uplink QoS data forwarding), the set of PDUs transmitted by the STA 104-a at 516 may include a first address field (such as an RA field) indicative of the satellite AP 102-b and a second address field (such as a TA field) indicative of the STA 104-a. In accordance with the relay path between the STA 104-a and the root AP 102-a, the satellite AP 102-b may construct the relayed set of PDUs such that the relayed set of PDUs include a first address field (such as an RA field) indicative of the root AP 102-a, a second address field (such as a TA field) indicative of the satellite AP 102-b, and a field indicative of the STA 104-a. The field indicative of the STA 104-a may be an EHT-SIG field or a User field in which a STA ID is set equal an AID value of the STA 104-a, or may be an A-control field including an AID value of the STA 104-a. The root AP 102-a may identify, ascertain, or otherwise determine that the set of PDUs are relayed from the STA 104-a in accordance with the set of PDUs including the field indicative of the STA 104-a.

Further, as part of BA forwarding, the BA received by the satellite AP 102-b at 520 may include a first address field (such as an RA field) indicative of the satellite AP 102-b, a second address field (such as a TA field) indicative of the root AP 102-a, and a field indicative of the STA 104-a. The field indicative of the STA 104-a may be a STA ID field of the BA and may be indicative of the STA 104-a by way of indicating an AID value of the STA 104-a. In accordance with the relay path between the STA 104-a and the root AP 102-a, the satellite AP 102-b may generate the relayed BA such that the relayed BA includes a first address field (such as an RA field) indicative of the STA 104-a and a second address field (such as a TA field) indicative of the STA 104-a. In some implementations, the satellite AP 102-b (such as the b-AP 308 of the satellite AP 102-b) may use the AID value of the STA 104-a indicated by the BA received at 520 to derive an RA field value for the relayed BA transmitted at 522.

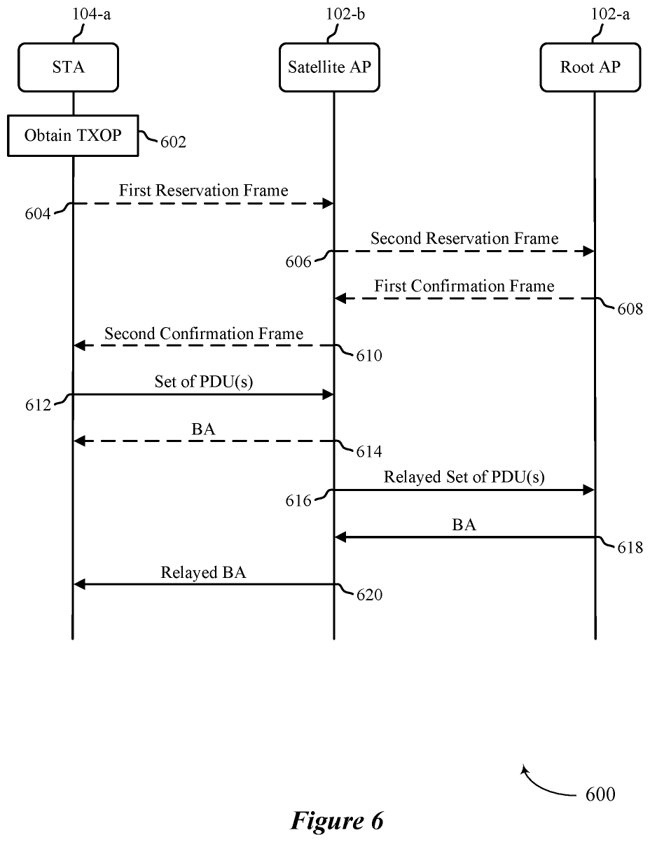

FIG. 6 shows an example process flow 600 that supports signaling mechanisms for low latency and low complexity relay designs. The process flow 600 may implement or be implemented to realize aspects of the WLAN 100, the signaling diagram 200, or the data plane architecture 300. For example, the process flow 600 illustrates communication between a root AP 102-a, a satellite AP 102-b, and a STA 104-a, and each of the root AP 102-a, the satellite AP 102-b, and the STA 104-a as illustrated by and described with reference to FIG. 6 may be examples of the root AP 102-a, the satellite AP 102-b, and the STA 104-a as illustrated by and described with reference to FIGS. 2-5. The root AP 102-a, the satellite AP 102-b, and the STA 104-a may communicate (such as transmit or receive) signaling in accordance with the process flow 600 in implementations in which the satellite AP 102-b relays EDCA-based uplink PPDUs from the STA 104-a to the root AP 102-a.

In the following description of the process flow 600, the operations may be performed (such as reported or provided) in a different order than the order shown, or the operations may be performed in different orders or at different times. For example, specific operations may be left out of the process flow 600, or other operations may be added to the process flow 600. Further, although some operations or signaling may be shown to occur at different times for explanatory purposes, these operations may actually occur at the same time.

At 602, the STA 104-a may obtain a TXOP. The STA 104-a may obtain the TXOP in one of various ways, including in accordance with an EDCA procedure, a differentiated channel access procedure according to which the STA 104-a may have a higher priority or likelihood for obtaining channel access (relative to other devices in a system), or any other coordinated medium access scheme, such as during a coordinated r-TWT SP.

At 604, the STA 104-a may, in some implementations, transmit a first reservation frame to the satellite AP 102-b. In some aspects, the first reservation frame may be a first TXS reservation frame. At 606, the satellite AP 102-b may transmit a second reservation frame to the root AP 102-a. In some aspects, the second reservation frame may be a second TXS reservation frame. At 608, the root AP 102-a may transmit a first confirmation frame to the satellite AP 102-b. In some aspects, the first confirmation frame may be a first TXS confirmation frame. At 610, the satellite AP 102-b may transmit a second confirmation frame. In some aspects, the second confirmation frame may be a second TXS confirmation frame.

In some implementations, the first reservation frame, the second reservation frame, the first confirmation frame, and the second confirmation frame may be associated with an end-to-end reservation and may clear the relay path from an end-to-end perspective. For example, the signaling associated with the first reservation frame, the second reservation frame, the first confirmation frame, and the second confirmation frame may be a form of RTS/CTS signaling or MU RTS/CTS signaling, as described in more detail with reference to FIGS. 4 and 5. In some implementations, if the root AP 102-a, the satellite AP 102-b, and the STA 104-a employ a coordinated r-TWT channel access scheme, the root AP 102-a, the satellite AP 102-b, and the STA 104-a may refrain from exchanging the signaling associated with the end-to-end reservation.

At 612, the STA 104-a may transmit, during the TXOP, a set of PDUs to the satellite AP 102-b. For example, the STA 104-a may transmit an UL PPDU (such as an A-MPDU) to the satellite AP 102-b. In some implementations, the STA 104-a may encrypt the UL PPDU using an end-to-end security key, such as an end-to-end PTK.

At 614, the satellite AP 102-b may, in some implementations, transmit a BA to the STA 104-a associated with the set of PDUs. In implementations in which the satellite AP 102-b transmits the BA associated with the set of PDUs to the STA 104-a, the STA 104-a may use the BA for rate adaptation purposes and may refrain from flushing out buffers associated with the set of PDUs (as the STA 104-a has yet to receive feedback information from the root AP 102-a, which is the intended receiver of the set of PDUs). The satellite AP 102-b may refrain from reordering any of the PDUs successfully received at 614. In some implementations, the STA 104-a may refrain from retransmitting any of the PDUs responsive to receiving the BA at 614. In some other implementations, the STA 104-a may perform one or more retransmissions responsive to receiving the BA at 614.

At 616, satellite AP 102-b may relay the set of PDUs to the root AP 102-a. In other words, the satellite AP 102-b may transmit a relayed set of PDUs to the root AP 102-a. The relayed set of PDUs may include PDUs of the set of PDUs that the satellite AP 102-b successfully received at 612.

At 618, the root AP 102-a may transmit a BA to the satellite AP 102-b associated with the relayed set of PDUs. The BA may include information indicative of PDUs of the relayed set of PDUs that the root AP 102-a successfully received at 616. In some implementations, the satellite AP 102-b may refrain from performing any retransmissions of unsuccessfully delivered PDUs of the relayed set of PDUs. In some other implementations, the satellite AP 102-b may perform one or more retransmissions of unsuccessfully delivered PDUs of the relayed set of PDUs. In such implementations, the satellite AP 102-b may perform retransmissions in accordance with a time duration remaining in the TXOP. For example, if the time duration remaining in the TXOP is less than or equal to a threshold, the satellite AP 102-b may refrain from performing any further retransmissions and may instead forward a BA to the STA 104-a.

At 620, the satellite AP 102-b may relay, from the root AP 102-a to the STA 104-a, the BA associated with the relayed set of PDUs. In other words, the satellite AP 102-b may transmit a relayed BA to the STA 104-a, the relayed BA including information indicative of which PDUs the satellite AP 102-b was able to successfully deliver to the root AP 102-a during the TXOP. In implementations in which the satellite AP 102-b refrains from performing retransmissions to the root AP 102-a, the BA received at 618 and the relayed BA transmitted at 620 may be the same (such as include the same indication of successfully delivered PDUs). In implementations in which the satellite AP 102-b performs one or more retransmissions to the root AP 102-a, the relayed BA may be indicative of all PDUs that the satellite AP 102-b was able to successfully deliver across an initial transmission attempt and one or more retransmission attempts.

In accordance with receiving the relayed BA at 620, the STA 104-a may perform one or more retransmissions (during the TXOP or a subsequent TXOP). For example, the STA 104-a may retransmit a set of (such as all) PDUs (such as MPDUs) missing per the relayed BA received at 620.

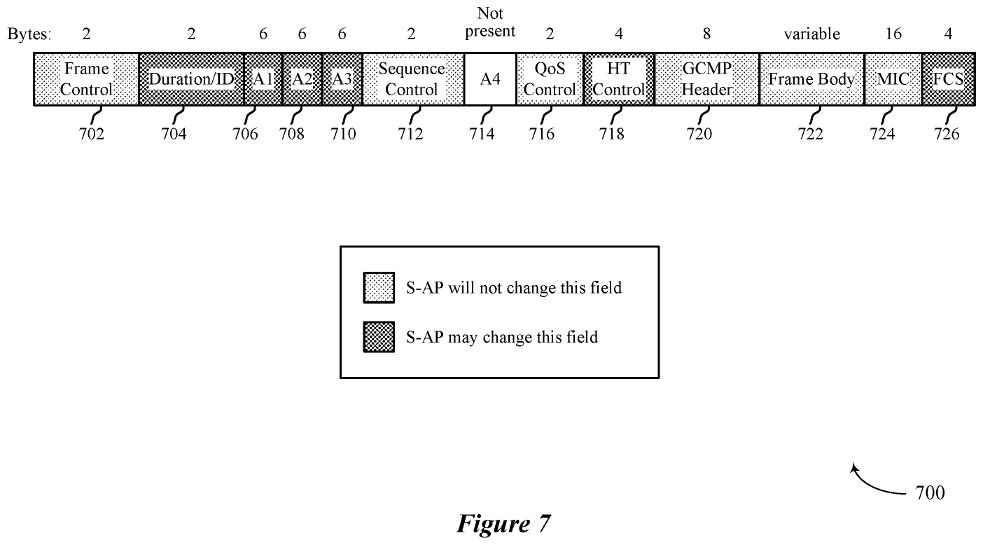

FIG. 7 shows an example MPDU 700 that supports signaling mechanisms for low latency and low complexity relay designs. In some implementations, the MPDU 700 may be relayed between a STA 104-a and a root AP 102-a via a satellite AP 102-b in accordance with a relay path between the STA 104-a and the root AP 102-a. The MPDU 700 may include a set of different fields and, to facilitate to relay between the STA 104-a and the root AP 102-a, the satellite AP 102-b may change, alter, or update one or more fields of the MPDU 700 as the satellite AP 102-b relays the MPDU. For example, the satellite AP 102-b may receive the MPDU 700 from one of the STA 104-a and the root AP 102-a, decode the MPDU 700, update one or more fields of the MPDU 700, and transmit the MPDU 700 (as updated) to the other of the STA 104-a and the root AP 102-a.

As illustrated in the example of the structure of the MPDU 700, the MPDU 700 may include a frame control field 702, a duration/ID field 704, an address 1 (A1) field 706 (which may be an example of an RA field), an address 2 (A2) field 708 (which may be an example of a TA field), an address 3 (A3) field 710, a sequence control field 712, an address 4 (A4) field 714 (which may not be present in some implementations), a QoS control field 716, an HT control field 718, a Galois/Counter Mode Protocol (GCMP) header 720, a frame body 722, a message integrity check (MIC) field 724, and a frame check sequence (FCS) field 726. Of the various fields carried by the MPDU 700, the satellite AP 102-b may change (such as update) the duration/ID field 704, the A1 field 706, the A2 field 708, the A3 field 710, the HT control field 718, and the FCS field 726. The satellite AP 102-b may leave a remainder of the fields unchanged.

In some implementations, the satellite AP 102-b may change the A1-A3 fields to indicate the local link addresses which are different between the root AP 102-a to the satellite AP 102-b and the satellite AP 102-b to the STA 104-a and may change the content of the FCS field 726 because some of the earlier fields in the MPDU 700 have changed. In accordance with the updates performed by the satellite AP 102-b, the satellite AP 102-b may refrain from performing re-encryption or re-calculation of a message integrity check (MIC) value and may refrain from changing a size of the MPDU 700.

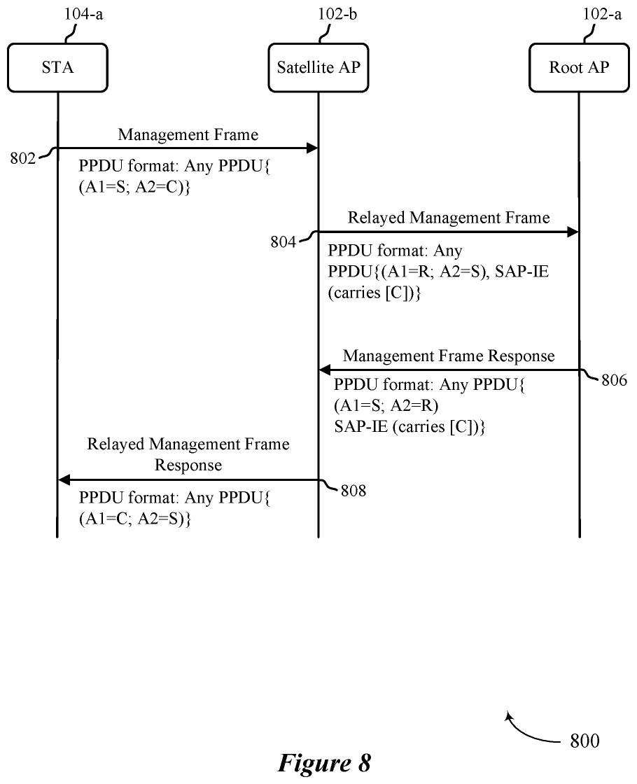

FIG. 8 shows an example process flow 800 that supports signaling mechanisms for low latency and low complexity relay designs. The process flow 800 may implement or be implemented to realize aspects of present disclosure. For example, the process flow 800 illustrates communication between a root AP 102-a, a satellite AP 102-b, and a STA 104-a, and each of the root AP 102-a, the satellite AP 102-b, and the STA 104-a as illustrated by and described with reference to FIG. 8 may be examples of the root AP 102-a, the satellite AP 102-b, and the STA 104-a as illustrated by and described with reference to FIGS. 2-6. The root AP 102-a, the satellite AP 102-b, and the STA 104-a may communicate (such as transmit or receive, or both) signaling in accordance with the process flow 800 in implementations in which the satellite AP 102-b relays management frames between the STA 104-a and the root AP 102-a. In accordance with the process flow 800, the satellite AP 102-b may perform addressing translation for management frames (which may be exchanged prior to association) relayed between the STA 104-a and the root AP 102-a and preserve a 3-address format for both hops (such as to keep the MPDU size unchanged).

In the following description of the process flow 800, the operations may be performed (such as reported or provided) in a different order than the order shown, or the operations may be performed in different orders or at different times. For example, specific operations may be left out of the process flow 800, or other operations may be added to the process flow 800. Further, although some operations or signaling may be shown to occur at different times for explanatory purposes, these operations may actually occur at the same time.

At 802, the STA 104-a may transmit a management frame to the satellite AP 102-b. The management frame may be associated with a PPDU format (such as any PPDU format) and may include an A1 field (such as an RA field) indicative of the satellite AP 102-b (which may be denoted as A1 being set to “S” for satellite) and may include an A2 field (such as a TA field) indicative of the STA 104-a (which may be denoted as A2 being set to “C” for client).

At 804, the satellite AP 102-b may transmit a relayed management frame to the root AP 102-a. For example, the satellite AP 102-b may relay (such as forward) the management frame received from the STA 104-a at 802 to the root AP 102-a at 804. The satellite AP 102-b may change (such as update or add) one or more fields or information elements (IEs) in the relayed management frame as compared to the management frame received at 802. For example, the satellite AP 102-b may add a MAC address of the STA 104-a in an IE associated with satellite AP relaying (which may be referred to as an SAP-IE). The relayed management frame may be associated with a PPDU format (such as any PPDU format) and may include an A1 field (such as an RA field) indicative of the root AP 102-a (which may be denoted as A1 being set to “R” for root), an A2 field (such as a TA field) indicative of the satellite AP 102-b (which may be denoted as A2 being set to “S” for satellite), and the SAP-IE indicative of the STA 104-a (such that the SAP-IE carries information indicative of “C”). The root AP 102-a may receive the relayed management frame and identify, ascertain, or otherwise determine that the relayed management frame is relayed from the STA 104-a in accordance with the relayed management frame including the SAP-IE indicative of the STA 104-a.

At 806, the root AP 102-a may transmit a management frame response to the satellite AP 102-b. In some aspects, the root AP 102-a may transmit the management frame response in accordance with (such as responsive to) receiving the relayed management frame at 804. The management frame response may be associated with a PPDU format (such as any PPDU format) and may include an A1 field (such as an RA field) indicative of the satellite AP 102-b, an A2 field (such as a TA field) indicative of the root AP 102-a, and a field or IE indicative of the STA 104-a. For example, the management frame response may include an IE, such as an SAP-IE or any other IE associated with satellite AP relaying, that carries information indicative of the STA 104-a. In other words, the root AP 102-a may include the SAP-IE, which may include or otherwise indicate the MAC address of the STA 104-a, in the management frame response. The satellite AP 102-b may receive the management frame response and identify, ascertain, or otherwise determine that the management frame response is to be relayed to the STA 104-a in accordance with the management frame response including the SAP-IE indicative of the STA 104-a.

Accordingly, at 808, the satellite AP 102-b may transmit a relayed management frame response to the STA 104-a. For example, the satellite AP 102-b may relay (such as forward) the management frame response received from the root AP 102-a at 806 to the STA 104-a at 808. The satellite AP 102-b may change (such as update or remove) one or more fields or IEs in the relayed management frame response as compared to the management frame response received at 806. The relayed management frame response may be associated with a PPDU format (such as any PPDU format) and may include an A1 field (such as an RA field) indicative of the STA 104-a and an A2 field (such as a TA field) indicative of the satellite AP 102-b. In some implementations, the satellite AP 102-b may use the MAC address of the STA 104-a indicated via the management frame response (such as via the SAP-IE in the management frame response) to derive a value for the A1 field in the relayed management frame response.

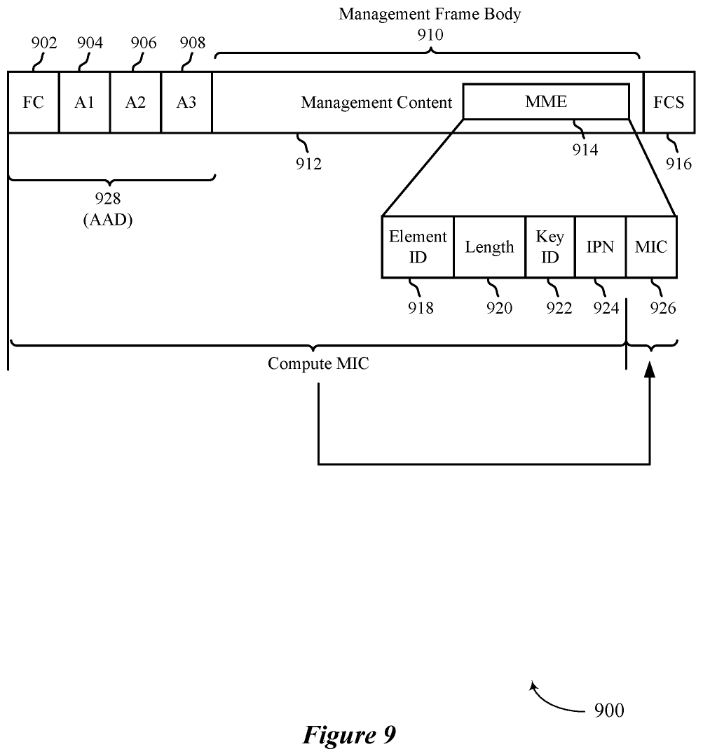

FIG. 9 shows an example beacon frame 900 that supports signaling mechanisms for low latency and low complexity relay designs. The beacon frame 900 may implement or be implemented to realize aspects of present disclosure. For example, one or more of a root AP 102-a, a satellite AP 102-b, and a STA 104-a may support a beacon integrity protection (BIP) scheme to enable or facilitate the creation and transmission of beacon frames 900 between the root AP 102-a and the STA 104-a via the satellite AP 102-b. Such a BIP scheme may be implemented, for example, during or as part of a relay discovery.

The beacon frame 900 may include a frame control (FC) field 902, an A1 field 904, an A2 field 906, an A3 field 908, a management frame body 910 including management content 912 and an management MIC element (MME) 914, and an FCS field 916. The MME 914 may include an element ID field 918, a length field 920, a key ID field 922, an integrity packet number (IPN) field 924, and a MIC field 926. Together, the FC field 902, the A1 field 904, the A2 field 906, and the A4 field 908 may be understood as additional authentication data (AAD) 928.

The FC field 902 may be associated with (such as include) one or more masked out bits, a retry bit, a power management (PM) bit, and a more data bit. The A1 field 904 may indicate or include a broadcast MAC address (in accordance with being included in the beacon frame 900) and the A2 field 906 and the A3 field 908 may (each or collectively) indicate or include a BSSID. The management content 912 may include an indication of a time synchronization function (TSF, within a timestamp field), which may be masked out in accordance with being included in the beacon frame 900.

In some aspects, a wireless communication device may compute, calculate, select, identify, or otherwise determine a MIC value in accordance with the AAD 928, the element ID field 918, the length field 920, the key ID field 922, and the IPN field 924 and may place the MIC value in the MIC field 926. In other words, the wireless communication device may compute, calculate, select, identify, or otherwise determine the MIC value using bits from the AAD 928, the element ID field 918, the length field 920, the key ID field 922, and the IPN field 924. For example, a wireless communication device may compute, calculate, select, identify, or otherwise determine an integrity value over the concatenation of the AAD 928 and the management frame body 910 including the MME 914, with the timestamp field masked out if the beacon frame 900 is a protected Beacon frame, and may insert the output (the integrity value) into the MIC field 926 in the MME 914. In some aspects, the wireless communication device may use a beacon integrity group temporal key (BIGTK) to encrypt or otherwise protect the beacon frame 900. In some aspects, the wireless communication may use a BIGTK on a link-by-link basis. In other words, the wireless communication device may use BIGTK per link.

In deployment scenarios in which the root AP 102-a communicates with the STA 104-a via the satellite AP 102-b, the satellite AP 102-b may transmit a beacon frame 900 to the STA 104-a to enable the STA 104-a to associate with the satellite AP 102-b (to achieve the targeted range extension). Prior to transmitting the beacon frame 900, the satellite AP 102-b may use a BSSID of the satellite AP 102-b (as A2 and A3) and a BIGTK or IPN for the beacon MIC computation. For example, the beacon MIC computation performed by the satellite AP 102-b may be associated with (such as involve) a usage of TA or RA and a security key, such as a BIGTK. The root AP 102-a may manage the BIGTK or IPN values for APs affiliated with the root AP 102-a (such as for all collocated and non-collocated affiliated APs). In some aspects, the root AP 102-a may manage the BIGTK or IPN values for the affiliated APs both for initial BIGTK installation on a client via a 4-way handshake and for later rekeying.

In some implementations, the STA 104-a (such as an end client) may opportunistically enter sleep or low power modes (such as a power save mode) to save power and may remain in such sleep or low power modes until the STA 104-a receives an indication to wake up (such as until a TIM bit is set to a 1 value). Such an indication to wake up (via TIM) may be different from TXOP access. In some aspects, the satellite AP 102-b may transmit a TIM bit via a TIM information element (which may be included in a beacon frame 900 or another management frame) to wake up the STA 104-a.

In implementations in which the STA 104-a opportunistically enters a sleep or low power mode, the root AP 102-a and the satellite AP 102-b may employ one or more mechanisms associated with beacon frame creation and transmission in accordance with whether downlink packet buffering is performed by the root AP 102-a or the satellite AP 102-b. In some implementations, the root AP 102-a may buffer downlink packets and the satellite AP 102-b may refrain from buffering downlink packets. In such implementations, to increase the likelihood that packets are successfully delivered to the STA 104-a, the root AP 102-a may provide a beacon payload to the satellite AP 102-b in accordance with (such as when) the STA 104-a is in an awake or active mode.

To enable the root AP 102-a to accurately identify, ascertain, or determine when the STA 104-a is in an awake or active mode, the STA 104-a may include an indication that the STA 104-a is in an awake or active mode in an uplink frame transmitted to the satellite AP 102-b and the satellite AP 102-b may transmit, via the relay path, the indication to the root AP 102-a. Such an indication may include a PM bit being set to a 1 value in an uplink frame. As such, the root AP 102-a may accurately identify, ascertain, or determine when the STA 104-a is in an awake or active mode and may transmit a beacon payload to the satellite AP 102-b (via encrypted unicast signaling and in a management container associated with satellite AP beacon frame relaying) when the STA 104-a is in an awake or active mode. The satellite AP 102-b may receive the beacon payload, create a MAC header, update a TSF value, compute a MIC value, and transmit a beacon frame 900 (including the beacon payload provided by the root AP 102-a) to the STA 104-a. The satellite AP 102-b may create and transmit the beacon frame 900 including the beacon payload without buffering the beacon payload. Accordingly, the satellite AP 102-b may create and transmit the beacon frame 900 approximately immediately (such as without additional delay outside of any processing delay) after receiving the beacon payload.

In some other implementations, the satellite AP 102-b may buffer downlink packets (in addition to the root AP 102-a buffering downlink packets), which may enable the root AP 102-a to refrain from keeping track of whether the STA 104-a is in an awake or active mode. In other words, in implementations in which the satellite AP 102-b buffers downlink packets, the root AP 102-a and the satellite AP 102-b may successfully deliver packets to the STA 104-a without the root AP 102-a knowing a power save status of the STA 104-a. In such implementations, the root AP 102-a may transmit a beacon payload to the satellite AP 102-b and the satellite AP 102-b may buffer (such as store in memory) the beacon payload until the satellite AP 102-b identifies, ascertains, or otherwise determines that the STA 104-a is in an awake or active mode (such as via a signaling indication, such as a PM bit set to 1), at which time the satellite AP 102-b may transmit a beacon frame 900 (including the beacon payload provided by the root AP 102-a) to the STA 104-a.

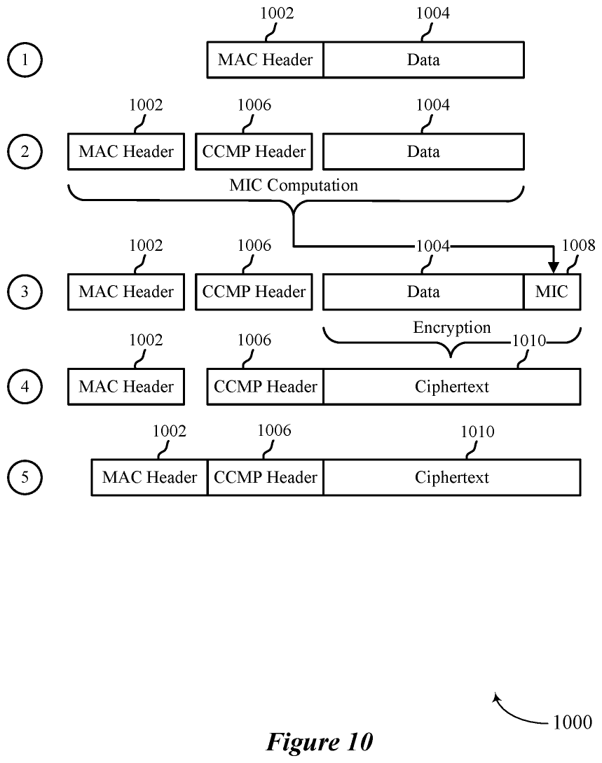

FIG. 10 shows an example encryption procedure 1000 that supports signaling mechanisms for low latency and low complexity relay designs. The encryption procedure 1000 may implement or be implemented to realize aspects of present disclosure. For example, a wireless communication device (such as a STA 104-a, a root AP 102-a, or a satellite AP 102-b) may perform the encryption procedure 1000 to calculate, compute, select, or otherwise determine a MIC value and to encrypt a frame to be transmitted over-the-air.

For example, as part of a first operation, the wireless communication device may obtain a frame associated with a MAC header 1002 and data 1004. As part of a second operation, the wireless communication device may add a counter mode with cipher block chaining message authentication code protocol (CCMP) header 1006 to the frame. As part of a third operation, the wireless communication device may perform a MIC computation in accordance with the MAC header 1002, the CCMP header 1006, and the data 1004 and may add a MIC value 1008 to the frame. As part of a fourth operation, the wireless communication device may encrypt the data 1004 and the MIC value 1008 to obtain ciphertext 1010. As part of a fifth operation, the wireless communication device may construct the frame in accordance with the MIC computation and the encryption such that the frame includes the MAC header 1002, the CCMP header 1006, and the ciphertext 1010.

FIG. 11 shows an example downlink sounding sequence 1100 that supports multi-hop channel sounding for relay operation. The downlink sounding sequence 1100 may be implemented to realize aspects of the present disclosure. For example, the root AP 102-a, the satellite AP 102-b, and the STA 104-a (each of which may be an example of a wireless communication device) may transmit and receiving signaling in accordance with the downlink sounding sequence 1100 as part of a downlink sounding sequence. In some aspects, the root AP 102-a, the satellite AP 102-b, and the STA 104-a may communicate in accordance with the downlink sounding sequence 1100 to obtain downlink channel information associated with multiple hops of a relay path between the root AP 102-a and the STA 104-a in examples in which the STA 104-a is associated with a first capability according to which the STA 104-a may be connected with either the root AP 102-a or the satellite AP 102-b at any given time. As illustrated in the example of the downlink sounding sequence 1100, the root AP 102-a may be referred to as an R-AP and the satellite AP 102-b may be referred to as an S-AP.

In some implementations, the root AP 102-a, the satellite AP 102-b, and the STA 104-a may exchange frames associated with the downlink sounding sequence within a single TXOP/SP 1102 (which may be understood as either a TXOP or an SP), which may be understood as having an R-TXOP/SP portion 1104 (such as a portion of the TXOP/SP 1102 controlled by the root AP 102-a) and an S-TXOP/SP portion 1106 (such as a portion of the TXOP/SP 1102 controlled by the satellite AP 102-b). As described herein, an SP may include one or multiple TXOPs, but may be another example (along with a TXOP) of a time duration during which one or more select devices may have prioritized or exclusive channel access rights. In accordance with the downlink sounding sequence, the root AP 102-a may transmit a sounding announcement (such as a Null Data Packet Announcement (NDPA) frame) frame 1108 associated with a multi-hop channel sounding involving the root AP 102-a, the satellite AP 102-b, and the STA 104-a. The sounding announcement frame 1108 may be associated with the multi-hop channel sounding by way of initiating or triggering the multi-hop channel sounding.

In some implementations, the sounding announcement frame 1108 may initiate or trigger the multi-hop channel sounding in accordance with including addresses corresponding to the satellite AP 102-b and the STA 104-a. For example, the sounding announcement frame 1108 may include a first ID (or any other first identifying information) corresponding to the satellite AP 102-b and a second ID (or any other second identifying information) corresponding to the STA 104-a. In some aspects, the root AP 102-a may transmit the sounding announcement frame 1108 addressed to the satellite AP 102-b (such that, for example, a MAC address of the satellite AP 102-b is included in an RA field of the sounding announcement frame 1108) and further including an AID of the STA 104-a. In such aspects, the first ID corresponding to the satellite AP 102-b may be a MAC address of the satellite AP 102-b and the second ID corresponding to the STA 104-a may be an AID of the STA 104-a. The sounding announcement frame 1108 may be an NDPA frame. Essentially, the sounding announcement frame 1108 may indicate, to the satellite AP 102-b, that this sequence is not only to be used to sound their respective channel (the channel between the root AP 102-a and the satellite AP 102-b) but also that the satellite AP 102-b is expected to also obtain (or have available) the link information for the channel between satellite AP 102-b and the STA 104-a.

The root AP 102-a may, in some implementations, follow the sounding announcement frame 1108 with one or more sounding packets 1110. Such one or more sounding packets 1110 may be one or more NDPs and the root AP 102-a may transmit the sounding packets 1110 to facilitate channel measurement at the satellite AP 102-b. In some other implementations, the root AP 102-a may refrain from transmitting the sounding packets 1110 and the satellite AP 102-b may instead measure a first wireless communication link (such as a first channel) between the root AP 102-a and the satellite AP 102-b using one or more other frames. In such implementations, the satellite AP 102-b may measure the first wireless communication link using the sounding announcement frame 1108 or one or more other frames transmitted by the root AP 102-a (such as beacon frames, association frames, probe response frames, or any other frames).

The root AP 102-a may employ trigger based (TB) sounding or non-TB sounding in the downlink sounding sequence in the example of the downlink sounding sequence 1100. In implementations in which the root AP 102-a employs TB sounding, the root AP 102-a may additionally sound multiple other wireless communication devices (such as one or more other STAs 104 or one or more other satellite APs 102, or any combination thereof). In such implementations, the root AP 102-a may transmit a trigger frame 1112, such as a Beamforming Report Poll (BFRP) trigger frame, addressed to the satellite AP 102-b. In some examples, the root AP 102-a may alternatively transmit a non-trigger variant of a BFRP frame addressed to the satellite AP 102-b. In implementations in which the root AP 102-a employs non-TB sounding, the RA field of the sounding announcement frame 1108 may be a MAC address of the satellite AP 102-b and the sounding announcement frame 1108 may include multiple (such as two) STA Info fields. Such multiple STA Info fields may include a first STA Info field including an AID of the satellite AP 102-b and a second STA Info field including an AID of the STA 104-a, where the inclusion of the AID of the STA 104-a in the NDPA may inform the satellite AP 102-b in advance that the sounding is for relaying between the root AP 102-a and the STA 104-a.

In accordance with one or more of the sounding announcement frame 1108, the sounding packets 1110, and the trigger frame 1112, the satellite AP 102-b may transmit a frame 1114 including first channel information associated with the first wireless communication link between the root AP 102-a and the satellite AP 102-b. The first channel information may indicate a first channel state, such as first compressed beamforming (CBF) and/or channel quality indicator (CQI) information, between the root AP 102-a and the satellite AP 102-b. In some implementations, the satellite AP 102-b may have previous (such as old) channel information associated with a second wireless communication link between the satellite AP 102-b and the STA 104-a (such as from past or previous channel sounding between the satellite AP 102-b and the STA 104-a). In such implementations, the satellite AP 102-b may include the previous channel information associated with the second wireless communication link in the frame 1114 (along with the first channel information associated with the first wireless communication link between the root AP 102-a and the satellite AP 102-b). The previous channel information may include a power management mode of the STA 104-a and a state of the STA 104-a (such as an awake state (and possibly for how long the STA 104-a is expected to remain in the awake state), a receive bandwidth or a number of spatial streams, among other communication parameters that are being used by the STA 104-a). A power management mode of the STA 104-a may include an active mode (according to which the STA 104-a is expected to remain in an awake state) and a power save (PS) mode (according to which the STA 104-a may be either in an awake state or a doze state). In some examples in which the STA 104-a is in a PS mode, the satellite AP 102-b may have information pertaining to how long the STA 104-a is expected to remain in an awake state in accordance with one or more PS schedules established between the satellite AP 102-b and the STA 104-a.

The root AP 102-a may receive the frame 1114 including the first channel information associated with the first wireless communication link and the previous associated with the second wireless communication link and, as such, may obtain information indicative of a channel state of the second wireless communication link and a status of the STA 104-a. The root AP 102-a may evaluate the multi-hop channel sounding in accordance with the first channel information and the previous channel information. For example, if the previous channel information passes one or more conditions (such as if the previous channel information indicates that a channel quality of the second wireless communication link satisfies a threshold quality, if the STA 104-a is available or otherwise in an awake state, or if the past channel sounding from which the previous channel information was obtained was performed within a threshold time duration), the root AP 102-a may end (such as terminate) the multi-hop channel sounding. The root AP 102-a may transmit a frame (to at least the satellite AP 102-b) to indicate a termination of the multi-hop channel sounding. Alternatively, if the previous channel information fails to pass one or more conditions, the root AP 102-a may let the multi-hop channel sounding continue. In some implementations, the root AP 102-a may transmit a frame including an indication of a continuation of the multi-hop channel sounding.

In examples in which the multi-hop channel sounding continues (such as if the frame 1114 did not include previous channel information associated with the second wireless communication link or if the previous channel information failed to pass one or more conditions), the root AP 102-a may, in some implementations, transmit a frame 1116 to transfer the TXOP/SP 1102 to the satellite AP 102-b. The frame 1116 may be a (clear to send to satellite AP) CTS2SAP frame, which is a clear to send (CTS) frame that contains the MAC address of the satellite AP 102-b in the RA field) and one or both of a duration field and an ID field of the frame 1116 may indicate an amount of the TXOP/SP 1102 transferred to the satellite AP 102-b for sounding the STA 104-a. In some aspects, the root AP 102-a may transmit the frame 1116 in accordance with knowing (such as identifying, ascertaining, or otherwise determining) that the STA 104-a is in an awake state. The frame 1116 may mark a transition point between the R-TXOP/SP portion 1104 and the S-TXOP/SP portion 1106.

The satellite AP 102-b may sound the STA 104-a to collect (updated or fresh) second channel information associated with the second wireless communication link between the satellite AP 102-b and the STA 104-a. In other words, the satellite AP 102-b may sound the STA 104-a to receive, collect, or otherwise obtain second CBF or CQI information from the STA 104-a. In some implementations, the satellite AP 102-b may transmit a sounding announcement frame 1118 (which may be an NDPA frame) and optionally one or more sounding packets 1120 (which may be one or more null data packets (NDPs)) to trigger and facilitate channel measurement at the STA 104-a. The sounding announcement frame 1118 may include an association identifier (AID) of the STA 104-a, a receiver address (RA) field of the sounding announcement frame 1118 may be set to a broadcast ID or a MAC address of the STA 104-a, and a TA field of the sounding announcement frame 1118 may be set to a MAC address of the satellite AP 102-b. If a MAC address of the STA 104-a is unavailable (such as not immediately available) at the satellite AP 102-b, the satellite AP 102-b may use TB sounding and set the RA field to a broadcast ID. In some implementations, one or both of the root AP 102-a and the satellite AP 102-b may participate in an (multi-user (MU)) request to send (RTS)/CTS frame exchange between the frame 1116 and the sounding announcement frame 1118, which may further protect the TXOP/SP 1102 for a duration of the multi-hop channel sounding.

The STA 104-a may measure a channel state (including, for example, CBF or CQI information) using one or both of the sounding announcement frame 1118 and the one or more sounding packets 1120 or any other frames transmitted by the satellite AP 102-b and may transmit a frame 1122 including the second channel information associated with the second wireless communication link. The frame 1122 may be a CBF frame. The satellite AP 102-b may forward the second channel information to the root AP 102-a via a frame 1124, which may be a forwarded (such as relayed) version of the frame 1122. In some aspects, the satellite AP 102-b may include, in the frame 1124, information associated with one or more expected transmission parameters for communication via the second wireless communication link between the satellite AP 102-b and the STA 104-a.

In some implementations, the satellite AP 102-b may separately provide the root AP 102-a with the first channel information via the frame 1114 and the second channel information via the frame 1124. In some other implementations, the satellite AP 102-b may provide the root AP 102-a with both the first channel information and the second channel information in a single frame, such as the frame 1124. Further, the satellite AP 102-b may transmit the frame 1124 with or without solicitation from the root AP 102-a. In examples in which the root AP 102-a solicits the frame 1124 from the satellite AP 102-b, the root AP 102-a may transmit a trigger frame (such as a BFRP trigger frame or, alternatively, a non-trigger variant BFRP frame) including an AID of the STA 104-a to poll the satellite AP 102-b for the second channel information of the STA 104-a.

The root AP 102-a may acknowledge reception of the frame 1124 (such as due to multiple exchanges involved in the sounding exchange illustrated by the downlink sounding sequence 1100). For example, the root AP 102-a may transmit a frame 1126 in accordance with receiving the frame 1124, the frame 1126 acknowledging successful reception of the frame 1124. In some aspects, the frame 1126 may be a CTS to root AP (CTS2RAP) frame, which may, in addition to acknowledging the frame 1124, take back the TXOP/SP 1102 from the satellite AP 102-b. In accordance with the frame 1126 being a CTS2RAP frame, the frame 1126 may include a MAC address of the root AP 102-a in an RA field.

At the conclusion of the relay sounding sequence illustrated by the example downlink sounding sequence 1100, the root AP 102-a and the satellite AP 102-b may use the obtained and relayed channel information for future scheduling or transmission decisions. For example, using at least some of the first channel information or the second channel information, the root AP 102-a may obtain information indicative of an availability and a channel state of both the first wireless communication link between the root AP 102-a and the satellite AP 102-b and the second wireless communication link between the satellite AP 102-b and the STA 104-a, which the root AP 102-a may use to select one or more transmission parameters for communication via the first wireless communication link and to obtain a state of the STA 104-a and a link quality of the second wireless communication link. The root AP 102-a may further use one or more expected transmission parameters indicated by the frame 1124, if provided, to estimate a duration for TXOP sharing or TXOP extension for data relaying (such as a data phase) between the root AP 102-a and the STA 104-a. The satellite AP 102-b may obtain information indicative of an availability of the STA 104-a and a channel state of the second wireless communication link via the second channel information, one or both of which the satellite AP 102-b may use to select one or more transmission parameters for communication via the second wireless communication link.

As such, the root AP 102-a and the STA 104-a may communicate with (such as transmit data frames to or receive data frames from, or both) each other via at least the satellite AP 102-b in accordance with transmission parameters that are associated with (results of findings of) the multi-hop channel sounding. In some aspects, one or more of the root AP 102-a, the satellite AP 102-b, and the STA 104-a may use the results or findings of the multi-hop channel sounding illustrated by the example of the downlink sounding sequence 1100 for selecting transmission parameters for downlink communication from the root AP 102-a to the STA 104-a.

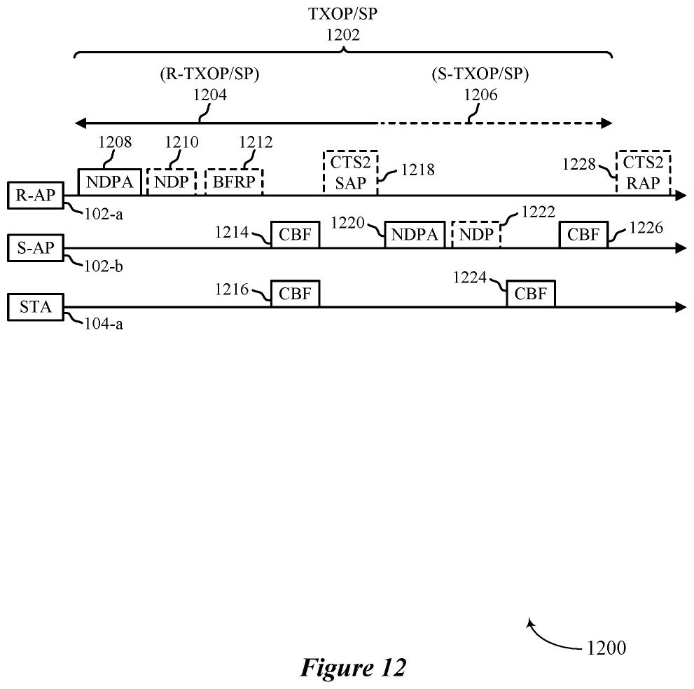

FIG. 12 shows an example downlink sounding sequence 1200 that supports multi-hop channel sounding for relay operation. The downlink sounding sequence 1200 may be implemented to realize aspects of the present disclosure. For example, the root AP 102-a, the satellite AP 102-b, and the STA 104-a (each of which may be an example of a wireless communication device) may transmit and receiving signaling in accordance with the downlink sounding sequence 1200 as part of a downlink sounding sequence. In some aspects, the root AP 102-a, the satellite AP 102-b, and the STA 104-a may communicate in accordance with the downlink sounding sequence 1200 to obtain downlink channel information associated with multiple hops of a relay path between the root AP 102-a and the STA 104-a in examples in which the STA 104-a is associated with a second capability according to which the STA 104-a may maintain connectivity with both the root AP 102-a and the satellite AP 102-b at any given time. As illustrated in the example of the downlink sounding sequence 1200, the root AP 102-a may be referred to as an R-AP and the satellite AP 102-b may be referred to as an S-AP.

In some implementations, the root AP 102-a, the satellite AP 102-b, and the STA 104-a may exchange frames associated with the downlink sounding sequence within a single TXOP/SP 1202, which may be understood as having an R-TXOP/SP portion 1204 (such as a portion of the TXOP/SP 1202 controlled by the root AP 102-a) and an S-TXOP/SP portion 1206 (such as a portion of the TXOP/SP 1202 controlled by the satellite AP 102-b). In accordance with the downlink sounding sequence, the root AP 102-a may transmit a sounding announcement frame 1208 associated with a multi-hop channel sounding involving the root AP 102-a, the satellite AP 102-b, and the STA 104-a. The sounding announcement frame 1208 may be associated with the multi-hop channel sounding by way of initiating or triggering the multi-hop channel sounding.

In some implementations, the sounding announcement frame 1208 may initiate or trigger the multi-hop channel sounding in accordance with including addresses corresponding to the satellite AP 102-b and the STA 104-a. For example, the sounding announcement frame 1208 may include a first ID (or any other first identifying information) corresponding to the satellite AP 102-b and a second ID (or any other second identifying information) corresponding to the STA 104-a. In some aspects, the first ID may be an AID of the satellite AP 102-b and the second ID may be an AID of the STA 104-a. The sounding announcement frame 1208 may be an NDPA frame. The sounding announcement frame 1208 may indicate, to the satellite AP 102-b, that this sequence is not only to be used to sound their respective channel (the channel between the root AP 102-a and the satellite AP 102-b) but also that the satellite AP 102-b is expected to also obtain (or have available) the link information for the channel between satellite AP 102-b and the STA 104-a.

The root AP 102-a may, in some implementations, follow the sounding announcement frame 1208 with one or more sounding packets 1210. Such one or more sounding packets 1210 may be one or more NDPs and the root AP 102-a may transmit the sounding packets 1210 to facilitate channel measurement at both the satellite AP 102-b and the STA 104-a (in accordance with the STA 104-a being capable of maintaining connections with both the root AP 102-a and the satellite AP 102-b). In some other implementations, the root AP 102-a may refrain from transmitting the sounding packets 1210. In such implementations, the satellite AP 102-b may instead measure a first wireless communication link (such as a first channel) between the root AP 102-a and the satellite AP 102-b using one or more other frames. Similarly, the STA 104-a may instead measure a third wireless communication link (such as a third channel) between the root AP 102-a and the STA 104-a using one or more other frames. In such implementations, the satellite AP 102-b and the STA 104-a may measure the first wireless communication link and the third wireless communication link, respectively, using the sounding announcement frame 1208 or one or more other frames transmitted by the root AP 102-a (such as beacon frames, association frames, probe response frames, or any other frames).

The root AP 102-a may, in some implementations, transmit a trigger frame 1212 (such as a BFRP trigger frame or, alternatively, a non-trigger variant BFRP frame) addressed to the satellite AP 102-b and the STA 104-a (along with potentially other additional devices) to solicit channel information from each of the satellite AP 102-b and the STA 104-a. In accordance with one or more of the sounding announcement frame 1208, the sounding packets 1210, and the trigger frame 1212, the satellite AP 102-b may transmit a frame 1214 including first channel information associated with the first wireless communication link between the root AP 102-a and the satellite AP 102-b and the STA 104-a may transmit a frame 1216 including third channel information associated with the third wireless communication link between the root AP 102-a and the STA 104-a. The first channel information may indicate a first channel state, such as first CBF or CQI information, between the root AP 102-a and the satellite AP 102-b and the third channel information may indicate a third channel state, such as third CBF or CQI information, between the root AP 102-a and the STA 104-a.

In some implementations, the satellite AP 102-b may have previous (such as old) channel information associated with a second wireless communication link between the satellite AP 102-b and the STA 104-a (such as from past or previous channel sounding between the satellite AP 102-b and the STA 104-a). In such implementations, the satellite AP 102-b may include the previous channel information associated with the second wireless communication link in the frame 1214 (along with the first channel information). The previous channel information may include a power management mode of the STA 104-a and a channel state of the STA 104-a (such as an awake state (and possibly for how long the STA 104-a is expected to remain in the awake state), a receive bandwidth or a number of spatial streams, among other communication parameters used by the STA 104-a).

The root AP 102-a may receive the frame 1214 including the first channel information associated with the first wireless communication link and the previous associated with the second wireless communication link and the frame 1216 including the third channel information associated with the third wireless communication link and, as such, may obtain information indicative of a channel state of the second wireless communication link and a status of the STA 104-a. The root AP 102-a may evaluate the multi-hop channel sounding in accordance with the first channel information, the previous channel information, and the third channel information. For example, if the previous channel information passes one or more conditions (such as if the previous channel information indicates that a channel quality of the second wireless communication link satisfies a threshold quality, if the STA 104-a is available or otherwise in an awake state, or if the past channel sounding from which the previous channel information was obtained was performed within a threshold time duration), the root AP 102-a may end (such as terminate) the multi-hop channel sounding. The root AP 102-a may transmit a frame (to at least the satellite AP 102-b) to indicate a termination of the multi-hop channel sounding. Alternatively, if the previous channel information fails to pass one or more conditions, the root AP 102-a may let the multi-hop channel sounding continue. In some implementations, the root AP 102-a may transmit a frame including an indication of a continuation of the multi-hop channel sounding.

In examples in which the multi-hop channel sounding continues (such as if the frame 1114 did not include previous channel information associated with the second wireless communication link or if the previous channel information failed to pass one or more conditions), the root AP 102-a may, in some implementations, transmit a frame 1218 to transfer the TXOP/SP 1202 to the satellite AP 102-b. The frame 1218 may be a CTS2SAP frame and one or both of a duration field and an ID field of the frame 1218 may indicate an amount of the TXOP/SP 1202 transferred to the satellite AP 102-b for sounding the STA 104-a.

The satellite AP 102-b may sound the STA 104-a to collect (updated or fresh) second channel information associated with the second wireless communication link between the satellite AP 102-b and the STA 104-a. In other words, the satellite AP 102-b may sound the STA 104-a to receive, collect, or otherwise obtain second CBF or CQI information from the STA 104-a. In some implementations, the satellite AP 102-b may transmit a sounding announcement frame 1220 (which may be an NDPA frame) and optionally one or more sounding packets 1222 (which may be one or more NDPs) to trigger and facilitate channel measurement at the STA 104-a. In some implementations, one or both of the root AP 102-a and the satellite AP 102-b may participate in an (MU) RTS/CTS frame exchange between the frame 1218 and the sounding announcement frame 1220, which may further protect the TXOP/SP 1202 for a duration of the multi-hop channel sounding.

The STA 104-a may measure a channel state (including, for example, CBF or CQI information) using one or both of the sounding announcement frame 1220 and the one or more sounding packets 1222 or any other frames transmitted by the satellite AP 102-b and may transmit a frame 1224 including the second channel information associated with the second wireless communication link. The frame 1224 may be a CBF frame. The satellite AP 102-b may forward the second channel information to the root AP 102-a via a frame 1226, which may be a forwarded (such as relayed) version of the frame 1224. In some implementations, the satellite AP 102-b may provide the root AP 102-a with both the first channel information and the second channel information via the frame 1226. In some other implementations, the satellite AP 102-b may include the second channel information in the frame 1226 and may exclude the first channel information from the frame 1226.

Further, the satellite AP 102-b may transmit the frame 1226 with or without solicitation from the root AP 102-a. In examples in which the root AP 102-a solicits the frame 1226 from the satellite AP 102-b, the root AP 102-a may transmit a trigger frame (such as a BFRP trigger frame or, alternatively, a non-trigger variant BFRP frame) including an AID of the STA 104-a to poll the satellite AP 102-b for the second channel information of the STA 104-a. In such examples, the root AP 102-a (via the trigger frame or another frame) also may poll the STA 104-a itself to check (such as identify, ascertain, or otherwise determine, such as in accordance with responsive signaling) if the downlink sounding sequence is successful in retrieving the second channel information from the STA 104-a.

The root AP 102-a may acknowledge reception of the frame 1226 (such as due to multiple exchanges involved in the sounding exchange illustrated by the downlink sounding sequence 1200). For example, the root AP 102-a may transmit a frame 1228 in accordance with receiving the frame 1226, the frame 1228 acknowledging successful reception of the frame 1226. In some aspects, the frame 1228 may be a CTS2RAP frame, which may, in addition to acknowledging the frame 1226, take back the TXOP/SP 1202 from the satellite AP 102-b.

At the conclusion of the relay sounding sequence illustrated by the downlink sounding sequence 1200, the root AP 102-a and the satellite AP 102-b may use the obtained and relayed channel information for future scheduling or transmission decisions. In some implementations, using the first channel information, the second channel information, and the third channel information, the root AP 102-a may select whether to communicate with the STA 104-a directly via the third wireless communication link or indirectly via a relay path associated with the first wireless communication link and the second wireless communication link. For example, if the third channel information indicates, relative to the first channel information and the second channel information, that the third wireless communication link is of higher quality than a combination of the first wireless communication link and the second wireless communication link, the root AP 102-a may select to communicate with the STA 104-a directly. Alternatively, if the combination of the first wireless communication link and the second wireless communication link is of higher quality than the third wireless communication link, the root AP 102-a may select to communicate with the STA 104-a indirectly via the relay path.

Further, using at least some of the first channel information, the second channel information, or the third channel information, the root AP 102-a may obtain information indicative of an availability and a channel state of the first wireless communication link, the second wireless communication link, and the third wireless communication link, which the root AP 102-a may use to select a traffic route, select one or more transmission parameters for communication via the first wireless communication link or the third wireless communication link, and obtain a state of the STA 104-a and a link quality of the second wireless communication link. The satellite AP 102-b may obtain information indicative of an availability of the STA 104-a and a channel state of the second wireless communication link via the second channel information, one or both of which the satellite AP 102-b may use to select one or more transmission parameters for communication via the second wireless communication link.

As such, the root AP 102-a and the STA 104-a may communicate with (such as transmit data frames to or receive data frames from, or both) each other directly or indirectly via at least the satellite AP 102-b in accordance with transmission parameters that are associated with (results of findings of) the multi-hop channel sounding. In some aspects, one or more of the root AP 102-a, the satellite AP 102-b, and the STA 104-a may use the results or findings of the multi-hop channel sounding illustrated by the example of the downlink sounding sequence 1200 for selecting transmission parameters for downlink communication from the root AP 102-a to the STA 104-a.

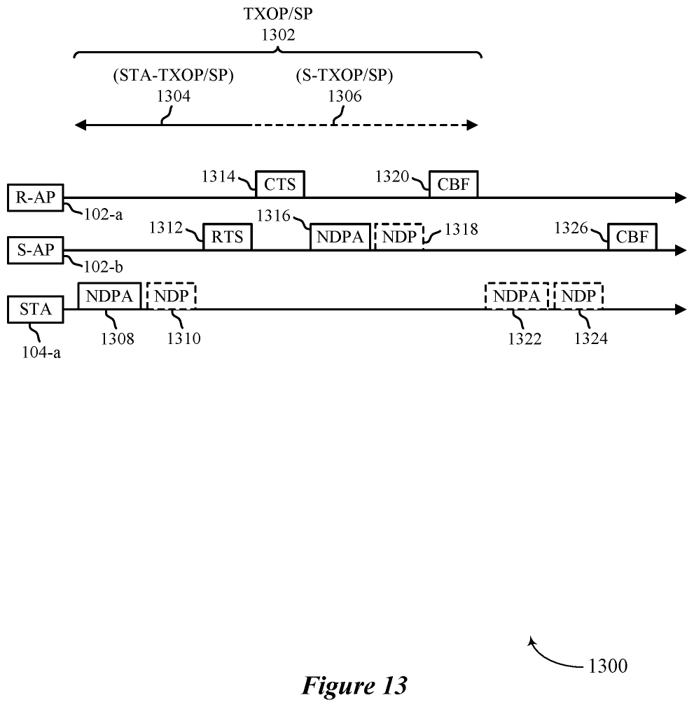

FIG. 13 shows an example uplink sounding sequence 1300 that supports multi-hop channel sounding for relay operation. The uplink sounding sequence 1300 may be implemented to realize aspects of the present disclosure. For example, the root AP 102-a, the satellite AP 102-b, and the STA 104-a (each of which may be an example of a wireless communication device) may transmit and receiving signaling in accordance with the uplink sounding sequence 1300 as part of an uplink sounding sequence. In some aspects, the root AP 102-a, the satellite AP 102-b, and the STA 104-a may communicate in accordance with the uplink sounding sequence 1300 to obtain uplink channel information associated with multiple hops of a relay path between the root AP 102-a and the STA 104-a in examples in which the STA 104-a is associated with a first capability according to which the STA 104-a may be connected with either the root AP 102-a or the satellite AP 102-b at any given time. As illustrated in the example of the uplink sounding sequence 1300, the root AP 102-a may be referred to as an R-AP and the satellite AP 102-b may be referred to as an S-AP.

In some implementations, the root AP 102-a, the satellite AP 102-b, and the STA 104-a may exchange frames associated with the uplink sounding sequence within a single TXOP/SP 1302, which may be understood as having a STA-TXOP/SP portion 1304 (such as a portion of the TXOP/SP 1302 controlled by the STA 104-a) and an S-TXOP/SP portion 1306 (such as a portion of the TXOP/SP 1302 controlled by the satellite AP 102-b). In accordance with the uplink sounding sequence, the root AP 102-a may transmit a sounding announcement frame 1308 associated with a multi-hop channel sounding involving the root AP 102-a, the satellite AP 102-b, and the STA 104-a. The sounding announcement frame 1308 may be associated with the multi-hop channel sounding by way of initiating or triggering the multi-hop channel sounding.

In some implementations, the sounding announcement frame 1308 may initiate or trigger the multi-hop channel sounding in accordance with including addresses corresponding to the root AP 102-a and the satellite AP 102-b. For example, the sounding announcement frame 1308 may include a first ID (or any other first identifying information) corresponding to the root AP 102-a and a second ID (or any other second identifying information) corresponding to the satellite AP 102-b. In some aspects, the STA 104-a may transmit the sounding announcement frame 1308 addressed to the satellite AP 102-b (such that, for example, a MAC address of the satellite AP 102-b is included in an RA field of the sounding announcement frame 1308) and further including an AID corresponding to the root AP 102-a. In such aspects, the first ID corresponding to the root AP 102-a may be an AID of the root AP 102-a (which may be understood as an AID of 0) and the second ID corresponding to the satellite AP 102-b may be a MAC address of the satellite AP 102-b. In some implementations, the sounding announcement frame 1308 may be an NDPA frame including one STA Info field (with the AID of 0). In some aspects, the sounding announcement frame 1308 may indicate, to the satellite AP 102-b, to prepare for assuming the TXOP/SP 1302 of the STA 104-a to sound the root AP 102-a. For example, the sounding announcement frame 1308 may indicate, to the satellite AP 102-b, that this sequence is not only to be used to sound their respective channel (the channel between the STA 104-a and the satellite AP 102-b) but also that the satellite AP 102-b is expected to also obtain (or have available) the link information for the channel between satellite AP 102-b and the root AP 102-a.

The STA 104-a may, in some implementations, follow the sounding announcement frame 1308 with one or more sounding packets 1310. Such one or more sounding packets 1310 may be one or more NDPs and the STA 104-a may transmit the sounding packets 1310 to facilitate channel measurement at the satellite AP 102-b. In some other implementations, the STA 104-a may refrain from transmitting the sounding packets 1310 and the satellite AP 102-b may instead measure a first wireless communication link (such as a first channel) between the satellite AP 102-b and the STA 104-a using one or more other frames (such as beacon frames, association frames, probe response or request frames, or any other frames). As such, the satellite AP 102-b may obtain first channel information associated with the first wireless communication link using the sounding packets 1310 or one or more other frames, or any combination thereof. The first channel information may include first CBF information, first CQI information, a power management mode of the satellite AP 102-b, or any combination thereof. For example, the satellite AP 102-b may support one or more power save protocols, and the satellite AP 102-b may provide information indicative of a power management mode of the satellite AP 102-b to the STA 104-a via the first channel information (to indicate, to the STA 104-a, when the satellite AP 102-b may be expected to be in an awake state or a doze state and, optionally, for how long).

In accordance with receiving the sounding announcement frame 1308, the satellite AP 102-b may transmit a frame 1312 to take over (such as to obtain) the TXOP/SP 1302 from the STA 104-a. In some implementations, the satellite AP 102-b may transmit the frame 1312, which may be an RTS frame, in a SIFS relative to the sounding announcement frame 1308 or a sounding packet 1310. In some aspects, one or both of a duration field or an ID field of the frame 1312 may indicate an amount of the TXOP/SP 1302 to be used by the satellite AP 102-b for sounding the root AP 102-a. The root AP 102-a may transmit a frame 1314 in response to the frame 1312. For example, the frame 1312 may be an RTS frame addressing the root AP 102-a and the root AP 102-a may transmit the frame 1314, which may be a CTS frame, accordingly.

The satellite AP 102-b may sound the root AP 102-a in accordance with obtaining the TXOP/SP 1302 via the frame 1312 and, in some implementations, may transmit a sounding announcement frame 1316 (which may be an NDPA frame) and optionally one or more sounding packets 1318 (which may be one or more NDPs) to trigger and facilitate channel measurement at the root AP 102-a. The root AP 102-a may use one or both of the sounding announcement frame 1316 and the one or more sounding packets 1318 to measure a second wireless communication link between the root AP 102-a and the satellite AP 102-b and obtain second channel information (such as second CBF information, second CQI information, a power management mode of the root AP 102-a, or any combination thereof) associated with the second wireless communication link. For example, the root AP 102-a may support one or more power save protocols, and the root AP 102-a may provide information indicative of a power management mode of the root AP 102-a to the satellite AP 102-b via the second channel information (to indicate, to the satellite AP 102-b, when the root AP 102-a may be expected to be in an awake state or a doze state and, optionally, for how long).

For example, the root AP 102-a may measure the second wireless communication link using any combination of the sounding announcement frame 1316, the one or more sounding packets 1318, or any other frames transmitted by the satellite AP 102-b and may transmit a frame 1320 including the second channel information associated with the second wireless communication link. The satellite AP 102-b may receive information indicative of a channel state of the second wireless communication link via the second channel information. The root AP 102-a may transmit the frame 1320 with or without solicitation by the satellite AP 102-b (such as with or without a trigger frame, such as a BFRP trigger frame or, alternatively, a non-trigger variant BFRP frame, from the satellite AP 102-b). Examples in which the satellite AP 102-b solicits the frame 1320 via a trigger frame may be understood as examples of TB sounding and examples in which the satellite AP 102-a transmits the frame 1320 without receiving a trigger frame may be understood as examples of non-TB sounding.

In some scenarios, the TXOP/SP 1302 may expire prior to transmission of the first channel information or the second channel information, or both, to the STA 104-a. In such scenarios, the STA 104-a may perform a channel access (such as an EDCA) recovery procedure in accordance with expiration of the TXOP/SP 1302 and may perform a retransmission of a sounding announcement frame 1322 (which may be an example of a retransmission of the sounding announcement frame 1308) and optionally one or more sounding packets 1324 (which may be one or more NDPs). For example, if the STA 104-a is associated with the first capability, the STA 104-a may expect or assume that sounding was unsuccessful because of the disruption of the TXOP/SP 1302 by the frame 1312 (the RTS frame) and may perform the channel access recovery procedure (and transmit the sounding announcement frame 1322) in accordance with expecting or assuming that the sounding was unsuccessful. In some implementations, to pre-empt the expectation or assumption that the sounding was unsuccessful, the satellite AP 102-b may assist the STA 104-a by transmitting a frame to return the TXOP/SP 1302 to the STA 104-a prior to the expiration of the TXOP/SP 1302. Such a frame to return the TXOP/SP 1302 to the STA 104-a may be a CTS2STA frame.

During the TXOP/SP 1302 or in accordance with receiving one or both of the sounding announcement frame 1322 and the one or more sounding packets 1324, the satellite AP 102-b may transmit a frame 1326 including the first channel information associated with the first wireless communication link between the satellite AP 102-b and the STA 104-a and the second channel information associated with the second wireless communication link between the root AP 102-a and the satellite AP 102-b. The frame 1326 may be a CBF frame.

At the conclusion of the relay sounding sequence illustrated by the example uplink sounding sequence 1300, the satellite AP 102-b and the STA 104-a may use the obtained and relayed channel information for future scheduling or transmission decisions. For example, using at least some of the first channel information or the second channel information, the STA 104-a may obtain information indicative of a channel state of the first wireless communication link and may select one or more transmission parameters for communication via the first wireless communication link. The satellite AP 102-b may use at least some of the first channel information or the second channel information to obtain information indicative of an availability and channel state of the second wireless communication link and to select one or more transmission parameters for communication via the second wireless communication link.

As such, the root AP 102-a and the STA 104-a may communicate with (such as transmit data frames to or receive data frames from, or both) each other via at least the satellite AP 102-b in accordance with transmission parameters that are associated with (results of findings of) the multi-hop channel sounding. In some aspects, one or more of the root AP 102-a, the satellite AP 102-b, and the STA 104-a may use the results or findings of the multi-hop channel sounding illustrated by the example of the uplink sounding sequence 1300 for selecting transmission parameters for uplink communication from the STA 104-a to the root AP 102-a.

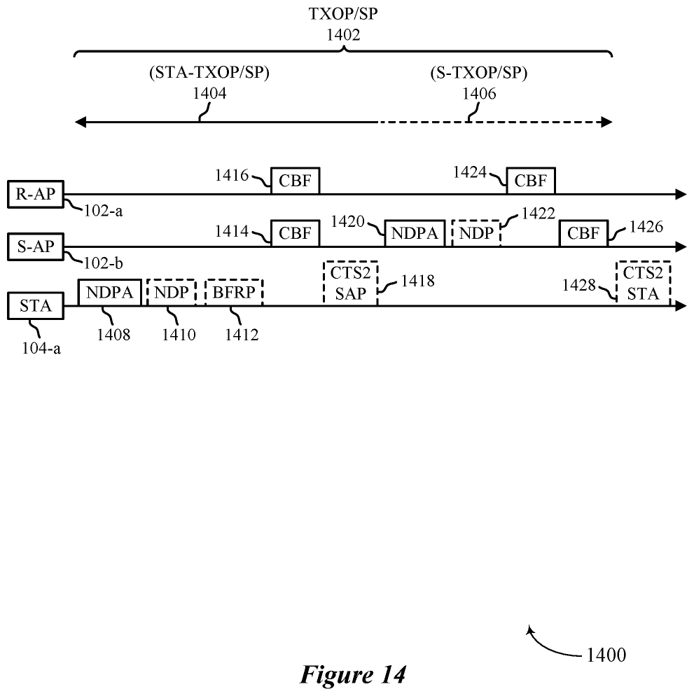

FIG. 14 shows an example uplink sounding sequence 1400 that supports multi-hop channel sounding for relay operation. The uplink sounding sequence 1400 may be implemented to realize aspects of the present disclosure. For example, the root AP 102-a, the satellite AP 102-b, and the STA 104-a (each of which may be an example of a wireless communication device) may transmit and receiving signaling in accordance with the uplink sounding sequence 1400 as part of an uplink sounding sequence. In some aspects, the root AP 102-a, the satellite AP 102-b, and the STA 104-a may communicate in accordance with the uplink sounding sequence 1400 to obtain uplink channel information associated with multiple hops of a relay path between the root AP 102-a and the STA 104-a in examples in which the STA 104-a is associated with a second capability according to which the STA 104-a may maintain connectivity with both the root AP 102-a and the satellite AP 102-b at any given time. As illustrated in the example of the uplink sounding sequence 1400, the root AP 102-a may be referred to as an R-AP and the satellite AP 102-b may be referred to as an S-AP.

In some implementations, the root AP 102-a, the satellite AP 102-b, and the STA 104-a may exchange frames associated with the uplink sounding sequence within a single TXOP/SP 1402, which may be understood as having a STA-TXOP/SP portion 1404 (such as a portion of the TXOP/SP 1402 controlled by the STA 104-a) and an S-TXOP/SP portion 1406 (such as a portion of the TXOP/SP 1402 controlled by the satellite AP 102-b). In accordance with the uplink sounding sequence, the root AP 102-a may transmit a sounding announcement frame 1408 associated with a multi-hop channel sounding involving the root AP 102-a, the satellite AP 102-b, and the STA 104-a. The sounding announcement frame 1308 may be associated with the multi-hop channel sounding by way of initiating or triggering the multi-hop channel sounding.

In some implementations, the sounding announcement frame 1408 may initiate or trigger the multi-hop channel sounding in accordance with including addresses corresponding to the root AP 102-a and the satellite AP 102-b. For example, the sounding announcement frame 1408 may include a first ID (or any other first identifying information) corresponding to the root AP 102-a and a second ID (or any other second identifying information) corresponding to the satellite AP 102-b. In some aspects, the sounding announcement frame 1408, which may be an NDPA frame, may include a first AID of the root AP 102-a and a second AID of the satellite AP 102-b (such that the first ID may be the first AID and the second ID may be the second AID). The sounding announcement frame 1408 may indicate, to the satellite AP 102-b, that this sequence is not only to be used to sound their respective channel (the channel between the STA 104-a and the satellite AP 102-b) but also that the satellite AP 102-b is expected to also obtain (or have available) the link information for the channel between satellite AP 102-b and the root AP 102-a.

The STA 104-a may, in some implementations, follow the sounding announcement frame 1408 with one or more sounding packets 1410. Such one or more sounding packets 1410 may be one or more NDPs and the STA 104-a may transmit the sounding packets 1410 to facilitate channel measurement at the root AP 102-a and at the satellite AP 102-b (in accordance with the STA 104-a being capable of maintaining connections with both the root AP 102-a and the satellite AP 102-b). In some other implementations, the STA 104-a may refrain from transmitting the sounding packets 1410. In such implementations, the root AP 102-a and the satellite AP 102-b may instead measure a respective wireless communication links and obtain respective channel information (such as respective CBF or CQI information) using one or more other frames transmitted by the STA 104-a (such as beacon frames, association frames, probe response or request frames, or any other frames).

In some implementations, the STA 104-a may transmit a trigger frame 1412 to solicit first channel information from the satellite AP 102-b associated with a first wireless communication link between the satellite AP 102-b and the STA 104-a and to solicit third channel information from the root AP 102-a associated with a third wireless communication link between the root AP 102-a and the STA 104-a. The trigger frame 1412 may be a BFRP trigger frame or, alternatively, a non-trigger variant BFRP frame and may be addressed to both the root AP 102-a and the satellite AP 102-b (and potentially one or more additional satellite APs). In accordance with one or more of the sounding announcement frame 1408, the sounding packets 1410, and the trigger frame 1412, the satellite AP 102-b may transmit a frame 1414 including the first channel information (such as first CBF information, first CQI information, a power management mode of the satellite AP 102-b, or any combination thereof) associated with the first wireless communication link and the root AP 102-a may transmit a frame 1416 including the third channel information (such as third CBF information, third CQI information, a power management mode of the root AP 102-a, or any combination thereof) associated with the third wireless communication link. Each of the frame 1414 and the frame 1416 may be a CBF frame. In some implementations, the frame 1414 may include the first channel information associated with the first wireless communication link along with previous channel information associated with a second wireless communication link between the root AP 102-a and the satellite AP 102-b (such as channel information associated with a past or previous channel sounding between the root AP 102-a and the satellite AP 102-b).

As such, STA 104-a may obtain, via the frame 1414, information indicative of a channel state of the first wireless communication link from the first channel information and may obtain information indicative of a previous channel state and an availability of the root AP 102-a from the previous channel information, if included. Similarly, the STA 104-a may obtain, via the frame 1416, information indicative of a channel state of the third wireless communication link from the third channel information.

In some implementations, the STA 104-a may evaluate the multi-hop channel sounding in accordance with the first channel information, the previous channel information, and the third channel information. For example, if the previous channel information passes one or more conditions (such as if the previous channel information indicates that a channel quality of the second wireless communication link satisfies a threshold quality, if the root AP 102-a is available or otherwise in an awake state, or if the past channel sounding from which the previous channel information was obtained was performed within a threshold time duration), the STA 104-a may end (such as terminate) the multi-hop channel sounding. The STA 104-a may transmit a frame (to at least the satellite AP 102-b) to indicate a termination of the multi-hop channel sounding. Alternatively, if the previous channel information fails to pass one or more conditions, the STA 104-a may let the multi-hop channel sounding continue. In some implementations, the STA 104-a may transmit a frame including an indication of a continuation of the multi-hop channel sounding.

In examples in which the multi-hop channel sounding continues (such as if the frame 1414 did not include previous channel information associated with the second wireless communication link or if the previous channel information failed to pass one or more conditions), the STA 104-a may, in some implementations, transmit a frame 1418 to transfer the TXOP/SP 1402 to the satellite AP 102-b. The frame 1418 may be a CTS2SAP frame and one or both of a duration field and an ID field of the frame 1418 may indicate an amount of the TXOP/SP 1402 transferred to the satellite AP 102-b for sounding the root AP 102-a.

The satellite AP 102-b may sound the root AP 102-a to collect (updated or fresh) second channel information associated with the second wireless communication link between the root AP 102-a and the satellite AP 102-b. In other words, the satellite AP 102-b may sound the root AP 102-a to receive, collect, or otherwise obtain second CBF or CQI information from the root AP 102-a. In some implementations, the satellite AP 102-b may transmit a sounding announcement frame 1420 (which may be an NDPA frame) and optionally one or more sounding packets 1422 (which may be one or more NDPs) to trigger and facilitate channel measurement at the root AP 102-a. In some implementations, one or more of the root AP 102-a, the satellite AP 102-b, and the STA 104-a may participate in an (MU) RTS/CTS frame exchange between the frame 1418 and the sounding announcement frame 1420, which may further protect the TXOP/SP 1402 for a duration of the multi-hop channel sounding.

The root AP 102-a may measure a channel state (including, for example, CBF or CQI information) using one or both of the sounding announcement frame 1420 and the one or more sounding packets 1422 or any other frames transmitted by the satellite AP 102-b and may transmit a frame 1424 including the second channel information (such as second CBF information, second CQI information, a power management mode of the root AP 102-a, or any combination thereof) associated with the second wireless communication link. The frame 1424 may be a CBF frame. The satellite AP 102-b may forward the second channel information to the STA 104-a via a frame 1426, which may be a forwarded (such as relayed) version of the frame 1424. In some implementations, the satellite AP 102-b may provide the STA 104-a with both the first channel information and the second channel information via the frame 1426. In some of such implementations, the satellite AP 102-b may refrain from transmitting the frame 1414 and instead provide both the first channel information and the second channel information via the frame 1426. In some other implementations, the satellite AP 102-b may include the second channel information in the frame 1426 and may exclude the first channel information from the frame 1426 (in accordance with providing the first channel information via the frame 1414).

Further, the satellite AP 102-b may transmit the frame 1426 with or without solicitation from the STA 104-a. In examples in which the STA 104-a solicits the frame 1426 from the satellite AP 102-b, the STA 104-a may transmit a trigger frame (such as a BFRP trigger frame or, alternatively, a non-trigger variant BFRP frame) including an AID of the root AP 102-a to poll the satellite AP 102-b for the second channel information of the root AP 102-a. In such examples, the STA 104-a (via the trigger frame or another frame) also may poll the root AP 102-a itself to check (such as identify, ascertain, or otherwise determine, such as in accordance with responsive signaling) if the uplink sounding sequence is successful in retrieving the second channel information from the root AP 102-a.

The STA 104-a may acknowledge reception of the frame 1426 (such as due to multiple exchanges involved in the sounding exchange illustrated by the uplink sounding sequence 1400). For example, the STA 104-a may transmit a frame 1428 in accordance with receiving the frame 1426, the frame 1428 acknowledging successful reception of the frame 1426. In some aspects, the frame 1428 may be a CTS2STA frame, which may, in addition to acknowledging the frame 1426, take back the TXOP/SP 1402 from the satellite AP 102-b.

At the conclusion of the relay sounding sequence illustrated by the uplink sounding sequence 1400, the satellite AP 102-b and the STA 104-a may use the obtained and relayed channel information for future scheduling or transmission decisions. In some implementations, using the first channel information, the second channel information, and the third channel information, the STA 104-a may select whether to communicate with the root AP 102-a directly via the third wireless communication link or indirectly via a relay path associated with the first wireless communication link and the second wireless communication link. For example, if the third channel information indicates, relative to the first channel information and the second channel information, that the third wireless communication link is of higher quality than a combination of the first wireless communication link and the second wireless communication link, the STA 104-a may select to communicate with the root AP 102-a directly. Alternatively, if the combination of the first wireless communication link and the second wireless communication link is of higher quality than the third wireless communication link, the STA 104-a may select to communicate with the root AP 102-a indirectly via the relay path.

Further, using at least some of the first channel information, the second channel information, or the third channel information, the STA 104-a may obtain information indicative of an availability and a channel state of the first wireless communication link, the second wireless communication link, and the third wireless communication link, which the STA 104-a may use to select a traffic route, select one or more transmission parameters for communication via the first wireless communication link or the third wireless communication link, and obtain a state of the root AP 102-a and a link quality of the second wireless communication link. The satellite AP 102-b may obtain information indicative of an availability of the root AP 102-a and a channel state of the second wireless communication link via the second channel information, one or both of which the satellite AP 102-b may use to select one or more transmission parameters for communication via the second wireless communication link.

As such, the root AP 102-a and the STA 104-a may communicate with (such as transmit data frames to or receive data frames from, or both) each other directly or indirectly via at least the satellite AP 102-b in accordance with transmission parameters that are associated with (results of findings of) the multi-hop channel sounding. In some aspects, one or more of the root AP 102-a, the satellite AP 102-b, and the STA 104-a may use the results or findings of the multi-hop channel sounding illustrated by the example of the uplink sounding sequence 1400 for selecting transmission parameters for uplink communication from the STA 104-a to the root AP 102-a.

Further, as described with reference to FIGS. 11-14, the first channel information (associated with an immediate hop) and the second channel information (associated with a next hop subsequent to the immediate hop) may be associated with different resolutions. In some implementations, for example, the first channel information may provide relatively higher resolution regarding one or more channel state matrixes that can assist an immediate transmitter in selecting one or more transmission parameters and the second channel information may provide relatively lower resolution regarding one or more channel state matrixes (as high resolution of a next hop link may be relatively less useful). For example, the first channel information may provide complete channel information and the second channel information may provide partial channel information, which may reduce signaling overhead. Such partial channel information may include information indicative of one or more of an expected TXOP duration, a bandwidth, a number of spatial streams, one or more modulation and coding schemes (MCSs), or other transmission parameters. Additionally, or alternatively, an originating device (such as the root AP 102-a for downlink and the STA 104-a for uplink) may indicate how much data is planned (such as scheduled) to be relayed during the TXOP. In such examples, the satellite AP 102-b may use the indication of how much data is planned to be relayed during the TXOP to provide a relatively more reliable estimate of the resources the satellite AP 102-b may use for the relay.

Further, although illustrated and described in the example of using NDPA frames to initiate and facilitate uplink and downlink sounding sequences, one or more of the root AP 102-a, the satellite AP 102-b, and the STA 104-a may estimate link qualities by measuring one or more other types of frames or packets. For example, the satellite AP 102-b may estimate a link quality of a wireless communication link between the root AP 102-a and the satellite AP 102-b in accordance with measuring frames (such as beacon frames) sent by the root AP 102-a. Similarly, the root AP 102-a may estimate a link quality of the wireless communication link between the root AP 102-a and the satellite AP 102-b in accordance with measuring frames (such as beacon frames) sent by the satellite AP 102-b. The STA 104-a may estimate a link quality of a wireless communication link between the satellite AP 102-b and the STA 104-a in accordance with measuring frames (such as beacon frames) sent by the satellite AP 102-b and may estimate a link quality of a wireless communication link between the root AP 102-a and the STA 104-a in accordance with measuring frames (such as beacon frames) sent by the root AP 102-a.

Instead of, or in addition to, explicit sounding sequences, the root AP 102-a and the satellite AP 102-b may exchange control frames (such as (MU) RTS/CTS frames) that include immediate link (adaptation) feedback, which may assist one or more wireless communication devices in measuring, estimating, or otherwise determining downlink or uplink link qualities for a backhaul link between the root AP 102-a and the satellite AP 102-b. Similarly, the satellite AP 102-b (and the root AP 102-a) and the STA 104-a may exchange control frames that include immediate link (adaptation) feedback. Such an immediate link may be understood as a link via which a given device is able to transmit or receive signaling, and may be differentiated from a next hop link via which a given device may access via a relay path and another device. In the examples of the sounding sequences described with reference to FIGS. 11-14, with respect to an originating device, a first wireless communication link may be understood as being an immediate link and a second wireless communication link may be understood as being a next hop link. A third wireless communication link may be understood as being a direct communication link between an originating device and an end device (such as the STA 104-a for downlink and the root AP 102-a for uplink).

Further, such control frame exchanges may be performed at a beginning of a TXOP that is intended to be used for downlink or uplink data relaying. As such, the multi-hop channel sounding illustrated by and described with reference to FIGS. 11-14 may occur at or near a beginning of a TXOP, such that a later portion of the TXOP may be used for data relaying between the root AP 102-a and the STA 104-a. In implementations in which control frame exchanges are used at or near a beginning of a TXOP, link adaptation feedback may be delivered in a similar manner as is illustrated by and described with reference to the sounding sequences of FIGS. 11-14, with the frames of a control frame exchange potentially including less information (such as several bytes of information). As such, using control frame exchanges may be associated with a tradeoff between granularity of information and signaling overhead as compared to an explicit sounding sequence and, in some implementations, an originating device may select between a control frame exchange and an explicit sounding sequence in accordance with the tradeoff and a deployment scenario of the originating device.

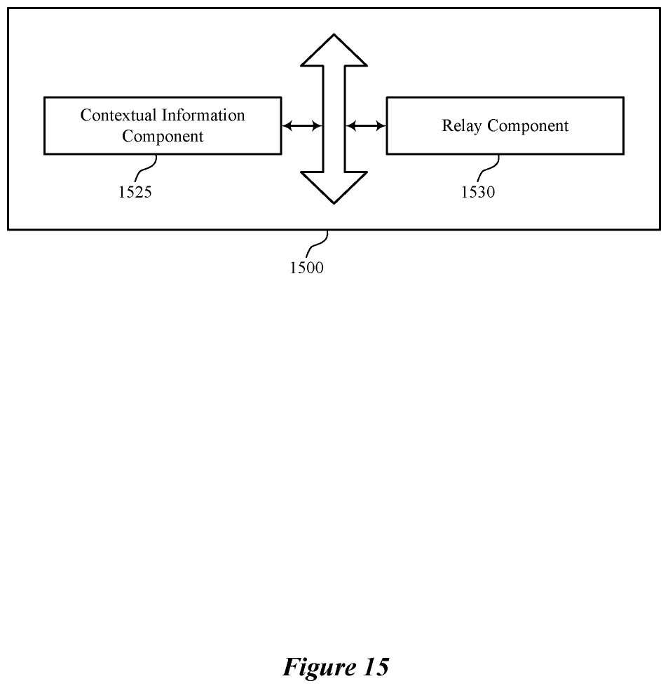

FIG. 15 shows a block diagram of an example wireless communication device 1500 that supports signaling mechanisms for low latency and low complexity relay designs. In various examples, the wireless communication device 1500 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “the radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 1500 can be a device for use in a STA or an AP, such as STA 104 or an AP 102 described with reference to FIG. 1 or a satellite AP 102-b as described with reference to FIGS. 2-10. In some other examples, the wireless communication device 1500 can be a STA or an AP that includes such a chip, SoC, chipset, package or device as well as multiple antennas. The wireless communication device 1500 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 1500 also includes or can be coupled with at least one application processor which may be further coupled with at least one memory. In some implementations, the wireless communication device 1500 further includes a user interface (UI) (such as a touchscreen or keypad) and a display, which may be integrated with the UI to form a touchscreen display. In some implementations, the wireless communication device 1500 may further include one or more sensors such as, for example, one or more inertial sensors, accelerometers, temperature sensors, pressure sensors, or altitude sensors.

The wireless communication device 1500 includes a contextual information component 1525 and a relay component 1530. Portions of the one or more of the contextual information component 1525 and the relay component 1530 may be implemented at least in part in the hardware or firmware. For example, one or more of the contextual information component 1525 and the relay component 1530 may be implemented at least in part by a modem. In some implementations, at least some of the contextual information component 1525 and the relay component 1530 are implemented at least in part by at least one processor and as software stored in memory. For example, portions of one or more of the contextual information component 1525 and the relay component 1530 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the device 1500). For example, a processing system of the device 1500 may refer to a system including the various other components or subcomponents of the device 1500, such as the at least one processor, or a transceiver, or a communications manager, or other components or combinations of components of the device 1500. The processing system of the device 1500 may interface with other components of the device 1500, and may process information received from other components (such as inputs or signals) or output information to other components. For example, a chip or modem of the device 1500 may include a processing system, a first interface to output information and a second interface to obtain information. In some implementations, the first interface may refer to an interface between the processing system of the chip or modem and a transmitter, such that the device 1500 may transmit information output from the chip or modem. In some implementations, the second interface may refer to an interface between the processing system of the chip or modem and a receiver, such that the device 1500 may obtain information or signal inputs, and the information may be passed to the processing system. A person having ordinary skill in the art will readily recognize that the first interface also may obtain information or signal inputs, and the second interface also may output information or signal outputs.

The device 1500 may support wireless communication at a first wireless communication device in accordance with examples as disclosed herein. The contextual information component 1525 is capable of, configured to, or operable to support a means for transmitting contextual information of one or more wireless communication devices, the one or more wireless communication devices associated with a relay path to a root AP via at least the first wireless communication device. The relay component 1530 is capable of, configured to, or operable to support a means for transmitting, via the relay path, a set of PDUs during a TXOP of a second wireless communication device. In some implementations, the relay component 1530 is capable of, configured to, or operable to support a means for receiving, via the relay path, a first BA associated with the set of PDUs during the TXOP. In some implementations, the relay component 1530 is capable of, configured to, or operable to support a means for transmitting, via the relay path and in accordance with the first BA, a second BA associated with the set of PDUs during the TXOP.

In some implementations, the relay component 1530 is capable of, configured to, or operable to support a means for transmitting the second BA in accordance with an end-to-end encryption associated with the relay path.

In some implementations, the relay component 1530 is capable of, configured to, or operable to support a means for transmitting the set of PDUs without reordering the set of PDUs, where the set of PDUs are a successfully received set of PDUs of a second set of PDUs.

In some implementations, the relay component 1530 is capable of, configured to, or operable to support a means for refraining from retransmitting any PDUs of the set of PDUs that are unsuccessfully received.

In some implementations, the relay component 1530 is capable of, configured to, or operable to support a means for adjusting a set of physical layer parameters associated with a communication link in accordance with a comparison between a first set of sequence numbers associated with the set of PDUs and a second set of sequence numbers associated with successfully received PDUs of the set of PDUs, where the first BA includes information indicative of the second set of sequence numbers associated with the successfully received PDUs of the set of PDUs.

In some implementations, the relay component 1530 is capable of, configured to, or operable to support a means for receiving, via the first BA, information indicative of first successfully received PDUs of the set of PDUs. In some implementations, the relay component 1530 is capable of, configured to, or operable to support a means for retransmitting, during the TXOP, one or more PDUs of the set of PDUs in accordance with the first BA, the one or more PDUs including first unsuccessfully received PDUs. In some implementations, the relay component 1530 is capable of, configured to, or operable to support a means for receiving, during the TXOP, a third BA associated with the one or more PDUs.

In some implementations, the relay component 1530 is capable of, configured to, or operable to support a means for receiving, via the third BA, information indicative of second successfully received PDUs associated with the one or more PDUs. In some implementations, the relay component 1530 is capable of, configured to, or operable to support a means for transmitting, via the second BA, information indicative of both the first successfully received PDUs and the second successfully received PDUs.

In some implementations, the relay component 1530 is capable of, configured to, or operable to support a means for transmitting the second BA in accordance with a time duration until an expiration of the TXOP.

In some implementations, the first wireless communication device transmits the second BA in accordance with the time duration until the expiration of the TXOP being less than or equal to a threshold time duration.

In some implementations, the relay component 1530 is capable of, configured to, or operable to support a means for receiving information indicative of a termination of the TXOP. In some implementations, the relay component 1530 is capable of, configured to, or operable to support a means for discarding the set of PDUs in accordance with the termination of the TXOP.

In some implementations, the relay component 1530 is capable of, configured to, or operable to support a means for receiving the information indicative of the termination of the TXOP via a contention free end (CF-End) frame, where an address field of the CF-End frame is indicative of the first wireless communication device.

In some implementations, the relay component 1530 is capable of, configured to, or operable to support a means for receiving a frame associated with an end-to-end reservation of the TXOP, where the end-to-end reservation of the TXOP is associated with end-to-end communication between a client device and the root AP via the relay path within the TXOP.

In some implementations, the relay component 1530 is capable of, configured to, or operable to support a means for receiving, via the relay path, the set of PDUs during the TXOP, where the set of PDUs transmitted by the first wireless communication device via the relay path includes relayed versions of the set of PDUs received via the relay path.

In some implementations, the relay component 1530 is capable of, configured to, or operable to support a means for receiving a first frame associated with a sharing of the TXOP for uplink data. In some implementations, the relay component 1530 is capable of, configured to, or operable to support a means for transmitting a second frame that triggers the uplink data, where receiving the set of PDUs is in accordance with transmitting the second frame that triggers the uplink data.

In some implementations, the relay component 1530 is capable of, configured to, or operable to support a means for transmitting, in accordance with successfully receiving the set of PDUs, a third BA including information indicative of the set of PDUs.

In some implementations, the relay component 1530 is capable of, configured to, or operable to support a means for transmitting, in accordance with successfully receiving a first subset of the set of PDUs as part of a first transmission attempt, a third BA including information indicative the first subset of the set of PDUs. In some implementations, the relay component 1530 is capable of, configured to, or operable to support a means for receiving, as part of a second transmission attempt, a second subset of the set of PDUs in accordance with the third BA, where receiving the set of PDUs is associated with receiving the first subset as part of the first transmission attempt and receiving the second subset as part of the second transmission attempt. In some implementations, the relay component 1530 is capable of, configured to, or operable to support a means for transmitting, in accordance with successfully receiving the second subset of the set of PDUs, a fourth BA including information indicative the second subset of the set of PDUs.

In some implementations, the relay component 1530 is capable of, configured to, or operable to support a means for receiving, from the second wireless communication device, a first reservation frame associated with the TXOP. In some implementations, the relay component 1530 is capable of, configured to, or operable to support a means for transmitting, to a third wireless communication device and in accordance with receiving the first reservation frame, a second reservation frame associated with the TXOP. In some implementations, the relay component 1530 is capable of, configured to, or operable to support a means for receiving, from the third wireless communication device and in accordance with transmitting the second reservation frame, a first confirmation frame associated with the TXOP. In some implementations, the relay component 1530 is capable of, configured to, or operable to support a means for transmitting, in accordance with receiving the first confirmation frame, a second confirmation frame associated with the TXOP.

In some implementations, the first reservation frame is a first RTS frame, the second reservation frame is a second RTS frame, the first confirmation frame is a CTS frame, and the second confirmation frame is a CTS-to-self frame.

In some implementations, each of the first reservation frame, the second reservation frame, the first confirmation frame, and the second confirmation frame indicate an entire duration of the TXOP.

In some implementations, any one or more of the first reservation frame, the second reservation frame, the first confirmation frame, and the second confirmation frame indicate channel quality information. In some implementations, a rate adaptation at the first wireless communication device is associated with the channel quality information.

In some implementations, the relay component 1530 is capable of, configured to, or operable to support a means for receiving, via the relay path, the set of PDUs from an upstream AP, where each PDU of the set of PDUs includes a first address field indicative of the first wireless communication device, a second address field indicative of the upstream AP, and a field indicative of an association identifier (AID) of a client device, where the set of PDUs transmitted by the first wireless communication device via the relay path includes relayed versions of the set of PDUs received via the relay path and are transmitted to the client device, and where each PDU of the relayed versions of the set of PDUs includes a first address field indicative of the client device and a second address field indicative of the first wireless communication device.

In some implementations, the relay component 1530 is capable of, configured to, or operable to support a means for deriving a medium access control (MAC) address of the client device in accordance with the AID of the client device, where the first address field indicates the MAC address of the client device.

In some implementations, the relay component 1530 is capable of, configured to, or operable to support a means for receiving the first BA from the client device, where the first BA includes a first address field indicative of the first wireless communication device and a second address field indicative of the client device. In some implementations, the relay component 1530 is capable of, configured to, or operable to support a means for transmitting, via the relay path, the second BA to the upstream AP, where the second BA includes a first address field indicative of the upstream AP, a second address field indicative of the first wireless communication device, and a field indicative of the AID of the client device.

In some implementations, the relay component 1530 is capable of, configured to, or operable to support a means for receiving, via the relay path, the set of PDUs from a client device, where each PDU of the set of PDUs includes a first address field indicative of the first wireless communication device and a second address field indicative of the client device, where the set of PDUs transmitted by the first wireless communication device via the relay path includes relayed versions of the set of PDUs received via the relay path and are transmitted to an upstream AP, and where each PDU of the relayed versions of the set of PDUs includes a first address field indicative of the upstream AP, a second address field indicative of the first wireless communication device, and a field indicative of an association identifier (AID) of the client device.

In some implementations, the relay component 1530 is capable of, configured to, or operable to support a means for receiving the first BA from the upstream AP, where the first BA includes a first address field indicative of the first wireless communication device, a second address field indicative of the upstream AP, and a field indicative of the AID of the client device. In some implementations, the relay component 1530 is capable of, configured to, or operable to support a means for transmitting, in accordance with the AID of the client device, the second BA to the client device, where the second BA includes a first address field indicative of the client device and a second address field indicative of the first wireless communication device.

In some implementations, the relay component 1530 is capable of, configured to, or operable to support a means for receiving a management frame from a client device, where the management frame includes a first address field indicative of the first wireless communication device and a second address field indicative of the client device. In some implementations, the relay component 1530 is capable of, configured to, or operable to support a means for transmitting, in accordance with the relay path, a relayed version of the management frame to an upstream AP, where the relayed version of the management frame includes a first address field indicative of the upstream AP, a second address field indicative of the first wireless communication device, and a field indicative of the client device.

In some implementations, the field indicative of the client device is within an information element associated with satellite AP relaying and includes a medium access control (MAC) address of the client device.

In some implementations, the relay component 1530 is capable of, configured to, or operable to support a means for receiving a management frame from an upstream AP, where the management frame includes a first address field indicative of the first wireless communication device, a second address field indicative of the upstream AP, and a field indicative of a client device. In some implementations, the relay component 1530 is capable of, configured to, or operable to support a means for transmitting, in accordance with the field indicative of the client device, a relayed version of the management frame to the client device, where the relayed version of the management frame includes a first address field indicative of the client device and a second address field indicative of the first wireless communication device.

In some implementations, the field indicative of the client device is within an information element associated with satellite AP relaying and includes a medium access control (MAC) address of the client device.

In some implementations, the relay component 1530 is capable of, configured to, or operable to support a means for transmitting, to the root AP via the relay path, a frame including information indicative of a power management state of a client device. In some implementations, the relay component 1530 is capable of, configured to, or operable to support a means for receiving, from the root AP, a beacon payload associated with the client device in accordance with the power management state of the client device. In some implementations, the relay component 1530 is capable of, configured to, or operable to support a means for transmitting, to the client device, a beacon frame in accordance with receiving the beacon payload, where the beacon frame includes the beacon payload.

In some implementations, the relay component 1530 is capable of, configured to, or operable to support a means for receiving, from the root AP via the relay path, a beacon payload associated with a client device. In some implementations, the relay component 1530 is capable of, configured to, or operable to support a means for storing the beacon payload in a buffer of the first wireless communication device in accordance with a power management state of the client device being associated with a power save mode. In some implementations, the relay component 1530 is capable of, configured to, or operable to support a means for transmitting, to the client device, a beacon frame in accordance with the power management state of the client device switching to an active mode, where the beacon frame includes the beacon payload.

In some implementations, the relay component 1530 is capable of, configured to, or operable to support a means for receiving an encrypted unicast frame from the root AP via the relay path, where an encryption of the encrypted unicast frame is associated with a sequence number and a group temporary key (GTK), the GTK being specific to the first wireless communication device. In some implementations, the relay component 1530 is capable of, configured to, or operable to support a means for unencrypting the encrypted unicast frame to obtain an unencrypted group addressed frame. In some implementations, the relay component 1530 is capable of, configured to, or operable to support a means for transmitting the unencrypted group addressed frame via the relay path, where the set of PDUs includes the unencrypted group addressed frame.

In some implementations, the relay component 1530 is capable of, configured to, or operable to support a means for receiving an encrypted unicast frame and an indication of a sequence number from the root AP via the relay path. In some implementations, the relay component 1530 is capable of, configured to, or operable to support a means for unencrypting the encrypted unicast frame to obtain an unencrypted group addressed frame. In some implementations, the relay component 1530 is capable of, configured to, or operable to support a means for encrypting the unencrypted group addressed frame to obtain an encrypted group addressed frame, where an encryption of the encrypted group addressed frame is associated with the sequence number and a group temporary key (GTK), the GTK being specific to the first wireless communication device. In some implementations, the relay component 1530 is capable of, configured to, or operable to support a means for transmitting the encrypted group addressed frame via the relay path, where the set of PDUs includes the encrypted group addressed frame.

In some implementations, the first wireless communication device is a satellite AP and the second wireless communication device is the root AP or a client device.

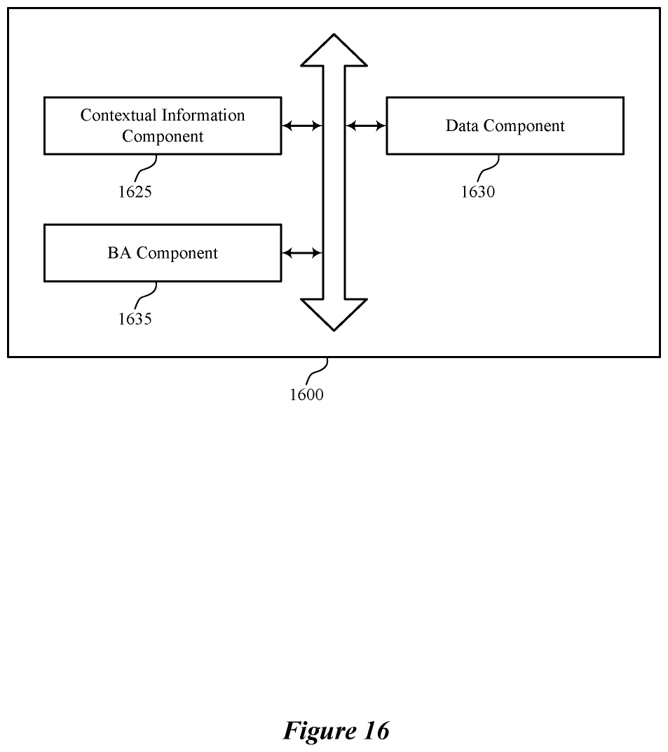

FIG. 16 shows a block diagram of an example wireless communication device 1600 that supports signaling mechanisms for low latency and low complexity relay designs. In various examples, the wireless communication device 1600 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “the radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 1600 can be a device for use in an AP, such as AP 102 described with reference to FIG. 1 or a root AP 102-a as described with reference to FIGS. 2-10. In some other examples, the wireless communication device 1600 can be an AP that includes such a chip, SoC, chipset, package or device as well as multiple antennas. The wireless communication device 1600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 1600 also includes or can be coupled with at least one application processor which may be further coupled with at least one memory. In some implementations, the wireless communication device 1600 further includes at least one external network interface that enables communication with a core network or backhaul network to gain access to external networks including the Internet.

The wireless communication device 1600 includes a contextual information component 1625, a data component 1630, and a BA component 1635. Portions of the one or more of the contextual information component 1625, the data component 1630, and the BA component 1635 may be implemented at least in part in the hardware or firmware. For example, one or more of the contextual information component 1625, the data component 1630, and the BA component 1635 may be implemented at least in part by a modem. In some implementations, at least some of the contextual information component 1625, the data component 1630, and the BA component 1635 are implemented at least in part by at least one processor and as software stored in at least one memory. For example, portions of one or more of the contextual information component 1625, the data component 1630, and the BA component 1635 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the device 1600). For example, a processing system of the device 1600 may refer to a system including the various other components or subcomponents of the device 1600, such as the at least one processor, or a transceiver, or a communications manager, or other components or combinations of components of the device 1600. The processing system of the device 1600 may interface with other components of the device 1600, and may process information received from other components (such as inputs or signals) or output information to other components. For example, a chip or modem of the device 1600 may include a processing system, a first interface to output information and a second interface to obtain information. In some implementations, the first interface may refer to an interface between the processing system of the chip or modem and a transmitter, such that the device 1600 may transmit information output from the chip or modem. In some implementations, the second interface may refer to an interface between the processing system of the chip or modem and a receiver, such that the device 1600 may obtain information or signal inputs, and the information may be passed to the processing system. A person having ordinary skill in the art will readily recognize that the first interface also may obtain information or signal inputs, and the second interface also may output information or signal outputs.

The device 1600 may support wireless communication at a first wireless communication device in accordance with examples as disclosed herein. The contextual information component 1625 is capable of, configured to, or operable to support a means for receiving contextual information of one or more wireless communication devices, the one or more wireless communication devices associated with a relay path to the first wireless communication device via at least a second wireless communication device. The data component 1630 is capable of, configured to, or operable to support a means for communicating, via a relay path, a set of PDUs during a TXOP of the first wireless communication device or a third wireless communication device. The BA component 1635 is capable of, configured to, or operable to support a means for communicating, via the relay path, a BA associated with the set of PDUs during the TXOP, where the BA is associated with the relay path between the first wireless communication device and the third wireless communication device via at least the second wireless communication device.

In some implementations, the BA component 1635 is capable of, configured to, or operable to support a means for communicating the BA in accordance with an end-to-end encryption associated with the relay path.

In some implementations, the contextual information component 1625 is capable of, configured to, or operable to support a means for scheduling communication with each of the one or more wireless communication devices associated with the relay path in accordance with the contextual information. In some implementations, the contextual information component 1625 is capable of, configured to, or operable to support a means for scheduling communication with each of one or more second wireless communication devices associated with a direct communication path to the first wireless communication in accordance with second contextual information of the one or more second wireless communication devices, where the first wireless communication device manages both the one or more wireless communication devices associated with the relay path and the one or more second wireless communication devices associated with the direct communication path.

In some implementations, the data component 1630 is capable of, configured to, or operable to support a means for retransmitting, during the TXOP or a second TXOP, one or more PDUs of the set of PDUs in accordance with a comparison between a first set of sequence numbers associated with the set of PDUs and a second set of sequence numbers associated with successfully received PDUs of the set of PDUs, where the BA includes information indicative of the second set of sequence numbers associated with the successfully received PDUs of the set of PDUs.

In some implementations, each PDU of the set of PDUs includes a first address field indicative of the first wireless communication device, a second address field indicative of the second wireless communication device, and a field indicative of an association identifier (AID) of the third wireless communication device.

In some implementations, to support communicating the set of PDUs, the data component 1630 is capable of, configured to, or operable to support a means for transmitting the set of PDUs to the second wireless communication device, where the field indicative of the AID of the third wireless communication device indicates that the set of PDUs is to be relayed to the third wireless communication device.

In some implementations, the BA component 1635 is capable of, configured to, or operable to support a means for receiving, from the second wireless communication device, a second BA including information indicative of the set of PDUs. In some implementations, the data component 1630 is capable of, configured to, or operable to support a means for maintaining a storage of information pertaining to the set of PDUs in accordance with the relay path and receiving the second BA from the second wireless communication device.

In some implementations, the BA component 1635 is capable of, configured to, or operable to support a means for receiving, from the second wireless communication device, a second BA including information indicative of successfully received PDUs of the set of PDUs. In some implementations, the data component 1630 is capable of, configured to, or operable to support a means for retransmitting, during the TXOP, one or more PDUs of the set of PDUs in accordance with the second BA, the one or more PDUs including first unsuccessfully received PDUs. In some implementations, the BA component 1635 is capable of, configured to, or operable to support a means for receiving, during the TXOP, a third BA associated with the one or more PDUs.

In some implementations, to support communicating the set of PDUs, the data component 1630 is capable of, configured to, or operable to support a means for receiving the set of PDUs from the second wireless communication device, where the field indicative of the AID of the third wireless communication device indicates that the set of PDUs is relayed from the third wireless communication device.

In some implementations, the data component 1630 is capable of, configured to, or operable to support a means for obtaining the TXOP at the first wireless communication device. In some implementations, the data component 1630 is capable of, configured to, or operable to support a means for transmitting, to the second wireless communication device, a first frame associated with a sharing of the TXOP for uplink data from the third wireless communication device, where the frame initiates a transmission, by the second wireless communication device, of a second frame that triggers the uplink data from the third wireless communication device, and where receiving the set of PDUs is in accordance with transmitting the first frame associated with the sharing of the TXOP for the uplink data.

In some implementations, the BA component 1635 is capable of, configured to, or operable to support a means for transmitting, to the second wireless communication device, a second BA including information indicative of the set of PDUs.

In some implementations, the BA component 1635 is capable of, configured to, or operable to support a means for transmitting, in accordance with successfully receiving a first subset of the set of PDUs as part of a first transmission attempt, a second BA including information indicative the first subset of the set of PDUs. In some implementations, the data component 1630 is capable of, configured to, or operable to support a means for receiving, as part of a second transmission attempt, a second subset of the set of PDUs in accordance with the second BA, where receiving the set of PDUs is associated with receiving the first subset as part of the first transmission attempt and receiving the second subset as part of the second transmission attempt. In some implementations, the BA component 1635 is capable of, configured to, or operable to support a means for transmitting, in accordance with successfully receiving the second subset of the set of PDUs, a third BA including information indicative the second subset of the set of PDUs.

In some implementations, the BA includes a first address field indicative of the first wireless communication device, a second address field indicative of the second wireless communication device, and a field indicative of an association identifier (AID) of the third wireless communication device.

In some implementations, to support communicating the BA, the BA component 1635 is capable of, configured to, or operable to support a means for receiving the BA from the second wireless communication device, where the field indicative of the AID of the third wireless communication device indicates that the BA is relayed from the third wireless communication device.

In some implementations, the BA component 1635 is capable of, configured to, or operable to support a means for receiving the BA in accordance with a time duration until an expiration of the TXOP, where the first wireless communication device expects to receive the BA in accordance with the time duration until the expiration of the TXOP being less than or equal to a threshold time duration.

In some implementations, to support communicating the BA, the BA component 1635 is capable of, configured to, or operable to support a means for transmitting the BA to the second wireless communication device, where the field indicative of the AID of the third wireless communication device indicates that the BA is to be relayed to the third wireless communication device.

In some implementations, the data component 1630 is capable of, configured to, or operable to support a means for transmitting information indicative of a termination of the TXOP, where transmission of the information indicative of the termination of the TXOP triggers a discarding of the set of PDUs at the second wireless communication device.

In some implementations, the data component 1630 is capable of, configured to, or operable to support a means for transmitting the information indicative of the termination of the TXOP via a contention free end (CF-End) frame, where an address field of the CF-End frame is indicative of the second wireless communication device.

In some implementations, the BA component 1635 is capable of, configured to, or operable to support a means for performing a channel access scheme in accordance with communicating the BA with the second wireless communication device. In some implementations, the data component 1630 is capable of, configured to, or operable to support a means for communicating a second set of PDUs with a fourth wireless communication during the TXOP in accordance with performing the channel access scheme.

In some implementations, the data component 1630 is capable of, configured to, or operable to support a means for communicating, with the second wireless communication device, a reservation frame associated with the TXOP, where the reservation frame is associated with a protection of the TXOP at the second wireless communication device. In some implementations, the data component 1630 is capable of, configured to, or operable to support a means for communicating, with the second wireless communication device, a confirmation frame, where the confirmation frame is further associated with the protection of the TXOP at the second wireless communication device.

In some implementations, the reservation frame is an RTS frame and the confirmation frame is a CTS frame.

In some implementations, each of the reservation frame and the confirmation frame indicate an entire duration of the TXOP.

In some implementations, any one or more of the reservation frame and the confirmation frame indicate channel quality information. In some implementations, a rate adaptation at the first wireless communication device, the second wireless communication device, or the third wireless communication device is associated with the channel quality information.

In some implementations, the data component 1630 is capable of, configured to, or operable to support a means for receiving, in accordance with the relay path, a relayed version of a management frame, where the relayed version of the management frame includes a first address field indicative of the first wireless communication device, a second address field indicative of the second wireless communication device, and a field indicative of the third wireless communication device, where the field indicative of the third wireless communication device indicates that the management frame is relayed from the third wireless communication device.

In some implementations, the field indicative of the third wireless communication device is within an information element associated with satellite AP relaying and includes a medium access control (MAC) address of the third wireless communication device.

In some implementations, the data component 1630 is capable of, configured to, or operable to support a means for transmitting a management frame to the second wireless communication device, where the management frame includes a first address field indicative of the first wireless communication device, a second address field indicative of the second wireless communication device, and a field indicative of the third wireless communication device, and where the field indicative of the third wireless communication device indicates that the management frame is to be relayed to the third wireless communication device.

In some implementations, the field indicative of the third wireless communication device is within an information element associated with satellite AP relaying and includes a medium access control (MAC) address of the third wireless communication device.

In some implementations, the data component 1630 is capable of, configured to, or operable to support a means for receiving a frame including information indicative of a power management state of the third wireless communication device. In some implementations, the data component 1630 is capable of, configured to, or operable to support a means for transmitting, to the second wireless communication device, a beacon payload associated with the third wireless communication device in accordance with the power management state of the third wireless communication device, where transmission of the beacon payload triggers a transmission, by the second wireless communication device, of a beacon frame including the beacon payload.

In some implementations, the data component 1630 is capable of, configured to, or operable to support a means for transmitting an encrypted unicast frame to the second wireless communication device, where an encryption of the encrypted unicast frame is associated with a sequence number and a group temporary key (GTK), the GTK being specific to the second wireless communication device, and where the encrypted unicast frame is associated with a group addressed frame, and where the set of PDUs includes the group addressed frame.

In some implementations, the data component 1630 is capable of, configured to, or operable to support a means for transmitting an encrypted unicast frame and an indication of a sequence number to the second wireless communication device, where the encrypted unicast frame is associated with a group addressed frame, and where the set of PDUs includes the group addressed frame.

In some implementations, the first wireless communication device is a root AP, the second wireless communication device is a satellite AP, and the third wireless communication device is a client device.

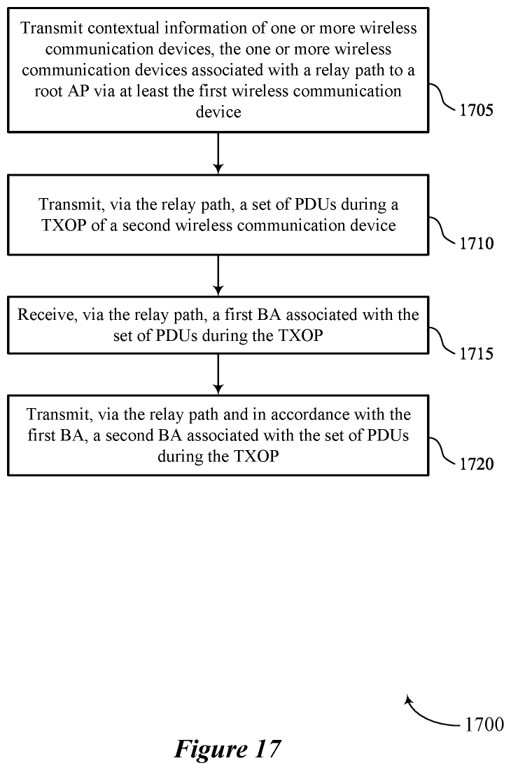

FIG. 17 shows a flowchart illustrating an example process 1700 performable at a wireless STA that supports signaling mechanisms for low latency and low complexity relay designs. The operations of the process 1700 may be an example of a method implemented by a wireless STA or its components as described herein. For example, the process 1700 may be performed by a wireless communication device, such as the wireless communication device 1500 described with reference to FIG. 15, operating as or within a wireless STA. In some implementations, the process 1700 may be performed by a wireless STA, such as one of the STAs 104 described with reference to FIG. 1.

In some implementations, in block 1705, the wireless STA may transmit contextual information of one or more wireless communication devices, the one or more wireless communication devices associated with a relay path to a root AP via at least the first wireless communication device. The operations of block 1705 may be performed in accordance with examples as disclosed herein. In some implementations, aspects of the operations of block 1705 may be performed by a contextual information component 1525 as described with reference to FIG. 15.

In some implementations, in block 1710, the wireless STA may transmit, via the relay path, a set of PDUs during a TXOP of a second wireless communication device. The operations of block 1710 may be performed in accordance with examples as disclosed herein. In some implementations, aspects of the operations of block 1710 may be performed by a relay component 1530 as described with reference to FIG. 15.

In some implementations, in block 1715, the wireless STA may receive, via the relay path, a first BA associated with the set of PDUs during the TXOP. The operations of block 1715 may be performed in accordance with examples as disclosed herein. In some implementations, aspects of the operations of block 1715 may be performed by a relay component 1530 as described with reference to FIG. 15.

In some implementations, in block 1720, the wireless STA may transmit, via the relay path and in accordance with the first BA, a second BA associated with the set of PDUs during the TXOP. The operations of block 1720 may be performed in accordance with examples as disclosed herein. In some implementations, aspects of the operations of block 1720 may be performed by a relay component 1530 as described with reference to FIG. 15.

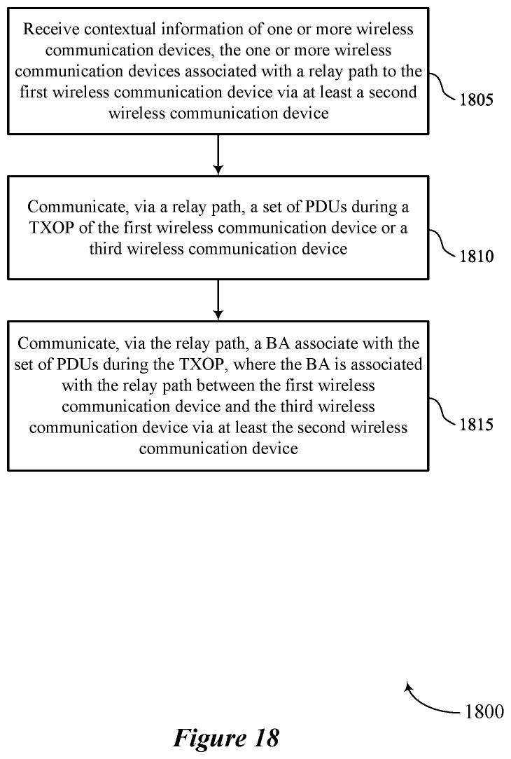

FIG. 18 shows a flowchart illustrating an example process 1800 performable at a wireless AP that supports signaling mechanisms for low latency and low complexity relay designs. The operations of the process 1800 may be an example of a method implemented by a wireless AP or its components as described herein. For example, the process 1800 may be performed by a wireless communication device, such as the wireless communication device 1600 described with reference to FIG. 16, operating as or within a wireless AP. In some implementations, the process 1800 may be performed by a wireless AP, such as one of the APs 102 described with reference to FIG. 1.

In some implementations, in block 1805, the wireless AP may receive contextual information of one or more wireless communication devices, the one or more wireless communication devices associated with a relay path to the first wireless communication device via at least a second wireless communication device. The operations of block 1805 may be performed in accordance with examples as disclosed herein. In some implementations, aspects of the operations of block 1805 may be performed by a contextual information component 1625 as described with reference to FIG. 16.

In some implementations, in block 1810, the wireless AP may communicate, via a relay path, a set of PDUs during a TXOP of the first wireless communication device or a third wireless communication device. The operations of block 1810 may be performed in accordance with examples as disclosed herein. In some implementations, aspects of the operations of block 1810 may be performed by a data component 1630 as described with reference to FIG. 16.

In some implementations, in block 1815, the wireless AP may communicate, via the relay path, a BA associate with the set of PDUs during the TXOP, where the BA is associated with the relay path between the first wireless communication device and the third wireless communication device via at least the second wireless communication device. The operations of block 1815 may be performed in accordance with examples as disclosed herein. In some implementations, aspects of the operations of block 1815 may be performed by a BA component 1635 as described with reference to FIG. 16.

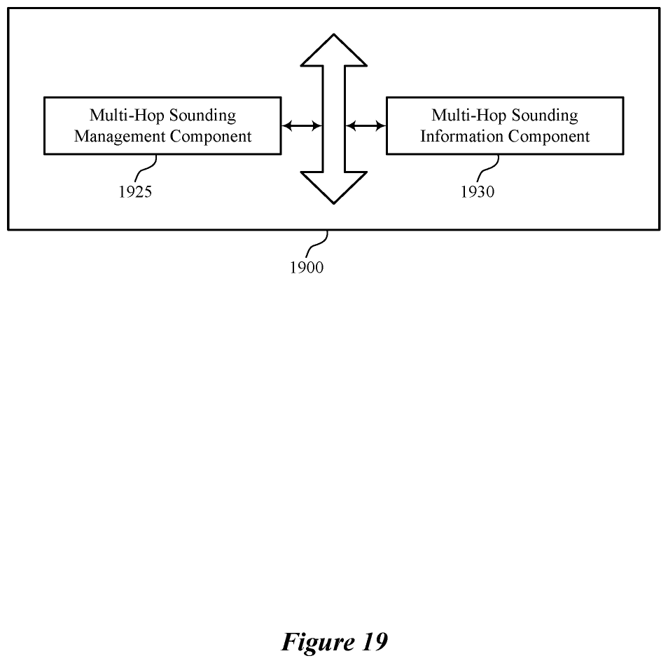

FIG. 19 shows a block diagram of an example wireless communication device 1900 that supports multi-hop channel sounding for relay operation. In various examples, the wireless communication device 1900 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 1900 can be a device for use in an AP or STA, such as an AP 102 or a STA 104 described with reference to FIG. 1. In some other examples, the wireless communication device 1900 can be an AP or STA that includes such a chip, SoC, chipset, package or device as well as multiple antennas. The wireless communication device 1900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 1900 also includes or can be coupled with at least one application processor which may be further coupled with at least one memory. In some implementations, the wireless communication device 1900 further includes at least one external network interface that enables communication with a core network or backhaul network to gain access to external networks including the Internet.

The wireless communication device 1900 includes a multi-hop sounding management component 1925 and a multi-hop sounding information component 1930. Portions of one or more of the multi-hop sounding management component 1925 and the multi-hop sounding information component 1930 may be implemented at least in part in hardware or firmware. For example, one or more of the multi-hop sounding management component 1925 and the multi-hop sounding information component 1930 may be implemented at least in part by at least one modem. In some implementations, at least some of the multi-hop sounding management component 1925 and the multi-hop sounding information component 1930 are implemented at least in part by at least one processor and as software stored in at least one memory. For example, portions of one or more of the multi-hop sounding management component 1925 and the multi-hop sounding information component 1930 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the device 1900). For example, a processing system of the device 1900 may refer to a system including the various other components or subcomponents of the device 1900, such as the at least one processor, or at least one transceiver, or at least one communications manager, or other components or combinations of components of the device 1900. The processing system of the device 1900 may interface with other components of the device 1900, and may process information received from other components (such as inputs or signals) or output information to other components. For example, a chip or modem of the device 1900 may include a processing system, a first interface to output information and a second interface to obtain information. In some implementations, the first interface may refer to an interface between the processing system of the chip or modem and a transmitter, such that the device 1900 may transmit information output from the chip or modem. In some implementations, the second interface may refer to an interface between the processing system of the chip or modem and a receiver, such that the device 1900 may obtain information or signal inputs, and the information may be passed to the processing system. A person having ordinary skill in the art will readily recognize that the first interface also may obtain information or signal inputs, and the second interface also may output information or signal outputs.

The device 1900 may support wireless communication at a first wireless communication device in accordance with examples as disclosed herein. The multi-hop sounding management component 1925 is capable of, configured to, or operable to support a means for receiving, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device. The multi-hop sounding information component 1930 is capable of, configured to, or operable to support a means for transmitting, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device.

In some implementations, the multi-hop sounding management component 1925 is capable of, configured to, or operable to support a means for receiving, from the second wireless communication device, a third frame associated with a sharing of a TXOP or an SP of the second wireless communication device with the first wireless communication device, where the multi-hop channel sounding is performed within the TXOP or the SP in accordance with the sharing of the TXOP or the SP.

In some implementations, the multi-hop sounding management component 1925 is capable of, configured to, or operable to support a means for transmitting a third frame to obtain a TXOP or an SP of the second wireless communication device in accordance with the first frame including the first identifying information and the second identifying information, where the multi-hop channel sounding is performed within the TXOP or the SP in accordance with obtainment of the TXOP or the SP.

In some implementations, the multi-hop sounding management component 1925 is capable of, configured to, or operable to support a means for receiving a second instance of the first frame in accordance with transmitting the third frame, where at least the second frame is transmitted in accordance with receiving the second instance of the first frame.

In some implementations, the multi-hop sounding information component 1930 is capable of, configured to, or operable to support a means for receiving, in accordance with the multi-hop channel sounding, one or more sounding packets from the second wireless communication device, where the first channel information is associated with the one or more sounding packets.

In some implementations, the multi-hop sounding information component 1930 is capable of, configured to, or operable to support a means for measuring the first frame in accordance with the multi-hop channel sounding, where the first channel information is associated with the first frame.

In some implementations, the multi-hop sounding management component 1925 is capable of, configured to, or operable to support a means for transmitting, in accordance with the first frame including the second identifying information corresponding to the third wireless communication device, a third frame associated with the multi-hop channel sounding, the third frame including the second identifying information corresponding to the third wireless communication device. In some implementations, the multi-hop sounding management component 1925 is capable of, configured to, or operable to support a means for transmitting, to the third wireless communication device, one or more sounding packets in accordance with the multi-hop channel sounding. In some implementations, the multi-hop sounding information component 1930 is capable of, configured to, or operable to support a means for receiving, from the third wireless communication device, a fourth frame indicating the second channel information, where the second channel information is associated with the one or more sounding packets.

In some implementations, to support transmitting at least the second frame indicating the first channel information and the second channel information, the multi-hop sounding information component 1930 is capable of, configured to, or operable to support a means for transmitting the second frame indicating the first channel information. In some implementations, to support transmitting at least the second frame indicating the first channel information and the second channel information, the multi-hop sounding information component 1930 is capable of, configured to, or operable to support a means for transmitting a third frame indicting the second channel information, where the third frame is a relayed version of a frame received from the third wireless communication device.

In some implementations, to support transmitting at least the second frame indicating the first channel information and the second channel information, the multi-hop sounding information component 1930 is capable of, configured to, or operable to support a means for transmitting the second frame indicating both the first channel information and the second channel information.

In some implementations, the second channel information is associated with a previous channel sounding between the first wireless communication device and the third wireless communication device, and the multi-hop sounding management component 1925 is capable of, configured to, or operable to support a means for receiving, from the second wireless communication device, a third frame indicating whether the multi-hop channel sounding is terminated in accordance with the second channel information.

In some implementations, to support receiving the third frame, the multi-hop sounding management component 1925 is capable of, configured to, or operable to support a means for receiving, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

In some implementations, to support receiving the third frame, the multi-hop sounding management component 1925 is capable of, configured to, or operable to support a means for receiving, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

In some implementations, the multi-hop sounding management component 1925 is capable of, configured to, or operable to support a means for transmitting, to the third wireless communication device, a sounding announcement frame and one or more sounding packets in accordance with the continuation of the multi-hop channel sounding. In some implementations, the multi-hop sounding information component 1930 is capable of, configured to, or operable to support a means for receiving, from the third wireless communication device, a fourth frame indicating third channel information associated with the second wireless communication link between the first wireless communication device and the third wireless communication device, where the third channel information is associated with one or more of the sounding announcement frame or the one or more sounding packets. In some implementations, the multi-hop sounding information component 1930 is capable of, configured to, or operable to support a means for transmitting, to the second wireless communication device, a fifth frame indicating the third channel information, where the fifth frame is a relayed version of the fourth frame.

In some implementations, the multi-hop sounding information component 1930 is capable of, configured to, or operable to support a means for receiving one or more beacon frames transmitted by the second wireless communication device, where the first channel information is associated with the one or more beacon frames.

In some implementations, the multi-hop sounding management component 1925 is capable of, configured to, or operable to support a means for receiving, from the second wireless communication device, a third frame in accordance with transmitting at least the second frame indicating the first channel information and the second channel information. In some implementations, the multi-hop sounding management component 1925 is capable of, configured to, or operable to support a means for returning a TXOP or an SP of the second wireless communication device in accordance with receiving the third frame.

In some implementations, the multi-hop sounding management component 1925 is capable of, configured to, or operable to support a means for receiving, from the second wireless communication device, information indicative of an amount of data to be relayed, during a TXOP or an SP, between the second wireless communication device and the third wireless communication device via at least the first wireless communication device. In some implementations, the multi-hop sounding information component 1930 is capable of, configured to, or operable to support a means for transmitting, to the second wireless communication device, an indication of an estimated amount of resources, where the estimated amount of resources is associated with the amount of data and at least one of the first channel information and the second channel information.

In some implementations, the multi-hop sounding management component 1925 is capable of, configured to, or operable to support a means for receiving, from the second wireless communication device, a trigger frame associated with the multi-hop channel sounding, where transmitting at least the second frame indicating the first channel information is in accordance with the trigger frame.

In some implementations, the trigger frame includes the first identifying information associated with the first wireless communication device and the second identifying information associated with the third wireless communication device.

In some implementations, the first channel information is associated with a first channel state resolution and the second channel information is associated with a second channel state resolution lower than the first channel state resolution.

In some implementations, the multi-hop sounding information component 1930 is capable of, configured to, or operable to support a means for transmitting, via a relay path between the second wireless communication device and the third wireless communication device, one or more data frames in accordance with the multi-hop channel sounding.

In some implementations, the multi-hop sounding information component 1930 is capable of, configured to, or operable to support a means for transmitting the one or more data frames via the relay path during a TXOP or an SP within which the multi-hop channel sounding is performed.

In some implementations, the first wireless communication device receives the first frame and transmits at least the second frame during a same TXOP or a same SP.

In some implementations, inclusion of the second identifying information corresponding to the third wireless communication device indicates, to the first wireless communication device, that the first frame is associated with an initiation of the multi-hop channel sounding.

In some implementations, the first frame is a sounding announcement frame or a request-to-send (RTS) frame, and the second frame is a compressed beamforming (CBF) frame or a clear-to-send (CTS) frame.

Additionally, or alternatively, the device 1900 may support wireless communication at a first wireless communication device in accordance with examples as disclosed herein. In some implementations, the multi-hop sounding management component 1925 is capable of, configured to, or operable to support a means for transmitting a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device. In some implementations, the multi-hop sounding information component 1930 is capable of, configured to, or operable to support a means for receiving, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

In some implementations, the multi-hop sounding management component 1925 is capable of, configured to, or operable to support a means for transmitting, to the second wireless communication device, a third frame associated with a sharing of a TXOP or an SP of the first wireless communication device with the second wireless communication device, where the multi-hop channel sounding is performed within the TXOP or the SP in accordance with the sharing of the TXOP or the SP.

In some implementations, the multi-hop sounding management component 1925 is capable of, configured to, or operable to support a means for receiving a third frame associated with an obtainment of a TXOP or an SP of the first wireless communication device by the second wireless communication device in accordance with the first frame including the first identifying information and the second identifying information, where the multi-hop channel sounding is performed within the TXOP or the SP in accordance with the obtainment of the TXOP or the SP by the second wireless communication device.

In some implementations, the multi-hop sounding management component 1925 is capable of, configured to, or operable to support a means for transmitting a second instance of the first frame in accordance with receiving the third frame, where at least the second frame is received in accordance with transmitting the second instance of the first frame.

In some implementations, the multi-hop sounding management component 1925 is capable of, configured to, or operable to support a means for transmitting, in accordance with the multi-hop channel sounding, one or more sounding packets, where at least the first channel information is associated with the one or more sounding packets.

In some implementations, to support receiving at least the second frame indicating the first channel information and the second channel information, the multi-hop sounding information component 1930 is capable of, configured to, or operable to support a means for receiving, from the second wireless communication device, the second frame indicating the first channel information. In some implementations, to support receiving at least the second frame indicating the first channel information and the second channel information, the multi-hop sounding information component 1930 is capable of, configured to, or operable to support a means for receiving, from the second wireless communication device, a third frame indicating the second channel information.

In some implementations, to support receiving at least the second frame indicating the first channel information and the second channel information, the multi-hop sounding information component 1930 is capable of, configured to, or operable to support a means for receiving, from the second wireless communication device, the second frame indicating both the first channel information and the second channel information.

In some implementations, the second channel information is associated with a previous channel sounding between the second wireless communication device and the third wireless communication device, and the multi-hop sounding management component 1925 is capable of, configured to, or operable to support a means for transmitting, to the second wireless communication device, a third frame indicating whether the multi-hop channel sounding is terminated in accordance with the second channel information.

In some implementations, to support transmitting the third frame, the multi-hop sounding management component 1925 is capable of, configured to, or operable to support a means for transmitting, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

In some implementations, to support transmitting the third frame, the multi-hop sounding management component 1925 is capable of, configured to, or operable to support a means for transmitting, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

In some implementations, the multi-hop sounding information component 1930 is capable of, configured to, or operable to support a means for receiving, from the second wireless communication device, a fourth frame indicating third channel information associated with the second wireless communication link between the second wireless communication device and the third wireless communication device.

In some implementations, the multi-hop sounding information component 1930 is capable of, configured to, or operable to support a means for receiving, from the third wireless communication device, a third frame indicating third channel information associated with a third wireless communication link between the first wireless communication device and the third wireless communication device.

In some implementations, the multi-hop sounding management component 1925 is capable of, configured to, or operable to support a means for transmitting, to the second wireless communication device, a fourth frame associated with a sharing of a TXOP or an SP of the first wireless communication device with the second wireless communication device in accordance with the third channel information, where receiving the second channel information is in association with transmitting the fourth frame.

In some implementations, the multi-hop sounding information component 1930 is capable of, configured to, or operable to support a means for establishing a data path between the first wireless communication device and the third wireless communication device in accordance with the first channel information, the second channel information, and the third channel information, where establishing the data path is in association with selecting a multi-hop relay data path associated with the first wireless communication link and the second wireless communication link or a direct data path associated with the third wireless communication link.

In some implementations, the multi-hop sounding management component 1925 is capable of, configured to, or operable to support a means for transmitting a third frame in accordance with receiving at least the second frame indicating the first channel information and the second channel information, where the third frame is transmitted to re-obtain a TXOP or an SP of the first wireless communication device.

In some implementations, the multi-hop sounding information component 1930 is capable of, configured to, or operable to support a means for transmitting, to the second wireless communication device, information indicative of an amount of data to be relayed, during a TXOP or an SP, between the first wireless communication device and the third wireless communication device via at least the second wireless communication device. In some implementations, the multi-hop sounding information component 1930 is capable of, configured to, or operable to support a means for receiving, from the second wireless communication device, an indication of an estimated amount of resources, where the estimated amount of resources is associated with the amount of data and at least one of the first channel information and the second channel information.

In some implementations, the multi-hop sounding management component 1925 is capable of, configured to, or operable to support a means for transmitting, to the second wireless communication device, a trigger frame associated with the multi-hop channel sounding, where receiving at least the second frame indicating the first channel information is in accordance with the trigger frame.

In some implementations, the trigger frame includes the first identifying information associated with the first wireless communication device and the second identifying information associated with the third wireless communication device.

In some implementations, the first channel information is associated with a first channel state resolution and the second channel information is associated with a second channel state resolution lower than the first channel state resolution.

In some implementations, the first wireless communication device transmits the first frame and receives at least the second frame during a same TXOP or a same SP.

In some implementations, inclusion of the second identifying information corresponding to the third wireless communication device indicates, to the second wireless communication device, that the first frame is associated with an initiation of the multi-hop channel sounding.

In some implementations, the first frame is a sounding announcement frame or a request-to-send (RTS) frame, and the second frame is a compressed beamforming (CBF) frame or a clear-to-send (CTS) frame.

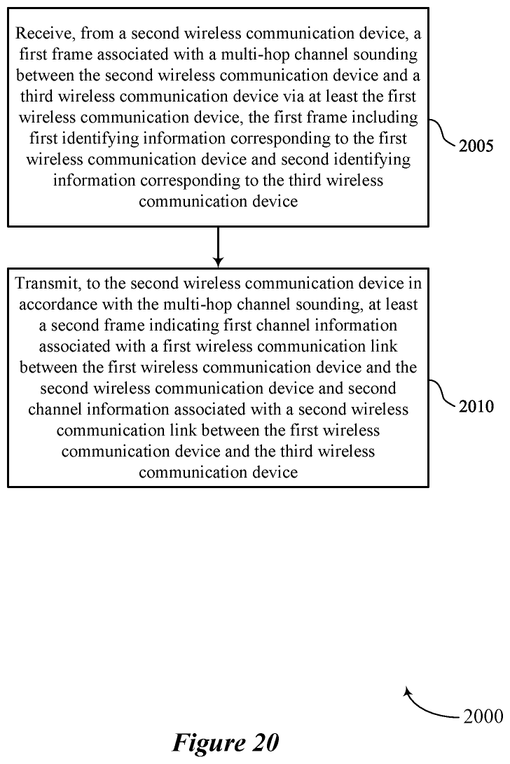

FIG. 20 shows a flowchart illustrating an example process 2000 that supports multi-hop channel sounding for relay operation in accordance with one or more aspects of the present disclosure. The operations of the process 2000 may be implemented by a wireless communication device, such as an AP or a STA or its components as described herein. For example, the operations of the process 2000 may be performed by any wireless communication device as described with reference to FIGS. 1-19. In some implementations, a first wireless communication device may execute a set of instructions to control the functional elements of the first wireless communication device to perform the described functions. Additionally, or alternatively, the first wireless communication device may perform aspects of the described functions using special-purpose hardware.

In some implementations, in block 2005, the first wireless communication device may receive, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device. The operations of block 2005 may be performed in accordance with examples as disclosed herein. In some implementations, aspects of the operations of block 2005 may be performed by a multi-hop sounding management component 1925 as described with reference to FIG. 19.

In some implementations, in block 2010, the first wireless communication device may transmit, to the second wireless communication device in accordance with the multi-hop channel sounding, at least a second frame indicating first channel information associated with a first wireless communication link between the first wireless communication device and the second wireless communication device and second channel information associated with a second wireless communication link between the first wireless communication device and the third wireless communication device. The operations of block 2010 may be performed in accordance with examples as disclosed herein. In some implementations, aspects of the operations of block 2010 may be performed by a multi-hop sounding information component 1930 as described with reference to FIG. 19.

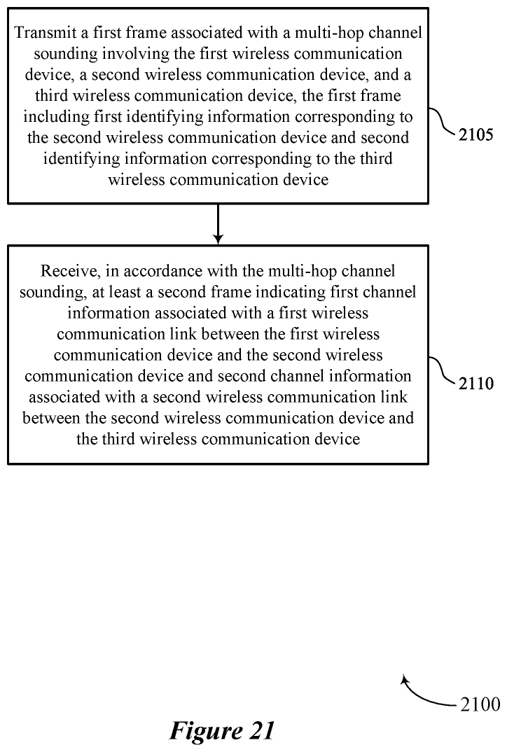

FIG. 21 shows a flowchart illustrating an example process 2100 that supports multi-hop channel sounding for relay operation in accordance with one or more aspects of the present disclosure. The operations of the process 2100 may be implemented by a wireless communication device, such as an AP or a STA or its components as described herein. For example, the operations of the process 2100 may be performed by any wireless communication device as described with reference to FIGS. 1-19. In some implementations, a first wireless communication device may execute a set of instructions to control the functional elements of the first wireless communication device to perform the described functions. Additionally, or alternatively, the first wireless communication device may perform aspects of the described functions using special-purpose hardware.

In some implementations, in block 2105, the first wireless communication device may transmit a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device. The operations of block 2105 may be performed in accordance with examples as disclosed herein. In some implementations, aspects of the operations of block 2105 may be performed by a multi-hop sounding management component 1925 as described with reference to FIG. 19.

In some implementations, in block 2110, the first wireless communication device may receive, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device. The operations of block 2110 may be performed in accordance with examples as disclosed herein. In some implementations, aspects of the operations of block 2110 may be performed by a multi-hop sounding information component 1930 as described with reference to FIG. 19.

Implementation examples are described in the following numbered clauses:

Clause 1: A first wireless communication device, including: one or more memories storing processor-executable code; and one or more processors coupled with the one or more memories and individually or collectively configured to, when executing the code, cause the first wireless communication device to: transmit contextual information of one or more wireless communication devices, the one or more wireless communication devices associated with a relay path to a root AP via at least the first wireless communication device; transmit, via the relay path, a set of PDUs during a TXOP of a second wireless communication device; receive, via the relay path, a first BA associated with the set of PDUs during the TXOP; and transmit, via the relay path and in accordance with the first BA, a second BA associated with the set of PDUs during the TXOP.

Clause 2: The first wireless communication device of clause 1, where the one or more processors are individually or collectively further configured to, when executing the code, cause the first wireless communication device to: transmit the second BA in accordance with an end-to-end encryption associated with the relay path.

Clause 3: The first wireless communication device of any of clauses 1-2, where the one or more processors are individually or collectively further configured to, when executing the code, cause the first wireless communication device to: transmit the set of PDUs without reordering the set of PDUs, where the set of PDUs are a successfully received set of PDUs of a second set of PDUs.

Clause 4: The first wireless communication device of any of clauses 1-3, where the one or more processors are individually or collectively further configured to, when executing the code, cause the first wireless communication device to: refrain from retransmitting any PDUs of the set of PDUs that are unsuccessfully received.

Clause 5: The first wireless communication device of any of clauses 1-4, where the one or more processors are individually or collectively further configured to, when executing the code, cause the first wireless communication device to: adjust a set of physical layer parameters associated with a communication link in accordance with a comparison between a first set of sequence numbers associated with the set of PDUs and a second set of sequence numbers associated with successfully received PDUs of the set of PDUs, where the first BA includes information indicative of the second set of sequence numbers associated with the successfully received PDUs of the set of PDUs.

Clause 6: The first wireless communication device of any of clauses 1-5, where the one or more processors are individually or collectively further configured to, when executing the code, cause the first wireless communication device to: receive, via the first BA, information indicative of first successfully received PDUs of the set of PDUs; retransmit, during the TXOP, one or more PDUs of the set of PDUs in accordance with the first BA, the one or more PDUs including first unsuccessfully received PDUs; and receive, during the TXOP, a third BA associated with the one or more PDUs.

Clause 7: The first wireless communication device of clause 6, where the one or more processors are individually or collectively further configured to, when executing the code, cause the first wireless communication device to: receive, via the third BA, information indicative of second successfully received PDUs associated with the one or more PDUs; and transmit, via the second BA, information indicative of both the first successfully received PDUs and the second successfully received PDUs.

Clause 8: The first wireless communication device of any of clauses 1-7, where the one or more processors are individually or collectively further configured to, when executing the code, cause the first wireless communication device to: transmit the second BA in accordance with a time duration until an expiration of the TXOP.

Clause 9: The first wireless communication device of clause 8, where the first wireless communication device transmits the second BA in accordance with the time duration until the expiration of the TXOP being less than or equal to a threshold time duration.

Clause 10: The first wireless communication device of any of clauses 1-9, where the one or more processors are individually or collectively further configured to, when executing the code, cause the first wireless communication device to: receive information indicative of a termination of the TXOP; and discard the set of PDUs in accordance with the termination of the TXOP.

Clause 11: The first wireless communication device of clause 10, where the one or more processors are individually or collectively further configured to, when executing the code, cause the first wireless communication device to: receive the information indicative of the termination of the TXOP via a CF-End frame, where an address field of the CF-End frame is indicative of the first wireless communication device.

Clause 12: The first wireless communication device of any of clauses 1-11, where the one or more processors are individually or collectively further configured to, when executing the code, cause the first wireless communication device to: receive a frame associated with an end-to-end reservation of the TXOP, where the end-to-end reservation of the TXOP is associated with end-to-end communication between a client device and the root AP via the relay path within the TXOP.

Clause 13: The first wireless communication device of any of clauses 1-12, where the one or more processors are individually or collectively further configured to, when executing the code, cause the first wireless communication device to: receive, via the relay path, the set of PDUs during the TXOP, where the set of PDUs transmitted by the first wireless communication device via the relay path includes relayed versions of the set of PDUs received via the relay path.

Clause 14: The first wireless communication device of clause 13, where the one or more processors are individually or collectively further configured to, when executing the code, cause the first wireless communication device to: receive a first frame associated with a sharing of the TXOP for uplink data; and transmit a second frame that triggers the uplink data, where receiving the set of PDUs is in accordance with transmitting the second frame that triggers the uplink data.

Clause 15: The first wireless communication device of any of clauses 13-14, where the one or more processors are individually or collectively further configured to, when executing the code, cause the first wireless communication device to: transmit, in accordance with successfully receiving the set of PDUs, a third BA including information indicative of the set of PDUs.

Clause 16: The first wireless communication device of any of clauses 13-15, where the one or more processors are individually or collectively further configured to, when executing the code, cause the first wireless communication device to: transmit, in accordance with successfully receiving a first subset of the set of PDUs as part of a first transmission attempt, a third BA including information indicative the first subset of the set of PDUs; receive, as part of a second transmission attempt, a second subset of the set of PDUs in accordance with the third BA, where receiving the set of PDUs is associated with receiving the first subset as part of the first transmission attempt and receiving the second subset as part of the second transmission attempt; and transmit, in accordance with successfully receiving the second subset of the set of PDUs, a fourth BA including information indicative the second subset of the set of PDUs.

Clause 17: The first wireless communication device of any of clauses 1-16, where the one or more processors are individually or collectively further configured to, when executing the code, cause the first wireless communication device to: receive, from the second wireless communication device, a first reservation frame associated with the TXOP; transmit, to a third wireless communication device and in accordance with receiving the first reservation frame, a second reservation frame associated with the TXOP; receive, from the third wireless communication device and in accordance with transmitting the second reservation frame, a first confirmation frame associated with the TXOP; and transmit, in accordance with receiving the first confirmation frame, a second confirmation frame associated with the TXOP.

Clause 18: The first wireless communication device of clause 17, where the first reservation frame is a first RTS frame, the second reservation frame is a second RTS frame, the first confirmation frame is a CTS frame, and the second confirmation frame is a CTS-to-self frame.

Clause 19: The first wireless communication device of any of clauses 17-18, where each of the first reservation frame, the second reservation frame, the first confirmation frame, and the second confirmation frame indicate an entire duration of the TXOP.

Clause 20: The first wireless communication device of any of clauses 17-19, where any one or more of the first reservation frame, the second reservation frame, the first confirmation frame, and the second confirmation frame indicate channel quality information, and where a rate adaptation at the first wireless communication device is associated with the channel quality information.

Clause 21: The first wireless communication device of any of clauses 1-20, where the one or more processors are individually or collectively further configured to, when executing the code, cause the first wireless communication device to: receive, via the relay path, the set of PDUs from an upstream AP, where each PDU of the set of PDUs includes a first address field indicative of the first wireless communication device, a second address field indicative of the upstream AP, and a field indicative of an AID of a client device, where the set of PDUs transmitted by the first wireless communication device via the relay path includes relayed versions of the set of PDUs received via the relay path and are transmitted to the client device, and where each PDU of the relayed versions of the set of PDUs includes a first address field indicative of the client device and a second address field indicative of the first wireless communication device.

Clause 22: The first wireless communication device of clause 21, where the one or more processors are individually or collectively further configured to, when executing the code, cause the first wireless communication device to: derive a MAC address of the client device in accordance with the AID of the client device, where the first address field indicates the MAC address of the client device.

Clause 23: The first wireless communication device of any of clauses 21-22, where the one or more processors are individually or collectively further configured to, when executing the code, cause the first wireless communication device to: receive the first BA from the client device, where the first BA includes a first address field indicative of the first wireless communication device and a second address field indicative of the client device; and transmit, via the relay path, the second BA to the upstream AP, where the second BA includes a first address field indicative of the upstream AP, a second address field indicative of the first wireless communication device, and a field indicative of the AID of the client device.

Clause 24: The first wireless communication device of any of clauses 1-23, where the one or more processors are individually or collectively further configured to, when executing the code, cause the first wireless communication device to: receive, via the relay path, the set of PDUs from a client device, where each PDU of the set of PDUs includes a first address field indicative of the first wireless communication device and a second address field indicative of the client device, where the set of PDUs transmitted by the first wireless communication device via the relay path includes relayed versions of the set of PDUs received via the relay path and are transmitted to an upstream AP, and where each PDU of the relayed versions of the set of PDUs includes a first address field indicative of the upstream AP, a second address field indicative of the first wireless communication device, and a field indicative of an AID of the client device.

Clause 25: The first wireless communication device of clause 24, where the one or more processors are individually or collectively further configured to, when executing the code, cause the first wireless communication device to: receive the first BA from the upstream AP, where the first BA includes a first address field indicative of the first wireless communication device, a second address field indicative of the upstream AP, and a field indicative of the AID of the client device; and transmit, in accordance with the AID of the client device, the second BA to the client device, where the second BA includes a first address field indicative of the client device and a second address field indicative of the first wireless communication device.

Clause 26: The first wireless communication device of any of clauses 1-25, where the one or more processors are individually or collectively further configured to, when executing the code, cause the first wireless communication device to: receive a management frame from a client device, where the management frame includes a first address field indicative of the first wireless communication device and a second address field indicative of the client device; and transmit, in accordance with the relay path, a relayed version of the management frame to an upstream AP, where the relayed version of the management frame includes a first address field indicative of the upstream AP, a second address field indicative of the first wireless communication device, and a field indicative of the client device.

Clause 27: The first wireless communication device of clause 26, where the field indicative of the client device is within an information element associated with satellite AP relaying and includes a MAC address of the client device.

Clause 28: The first wireless communication device of any of clauses 1-27, where the one or more processors are individually or collectively further configured to, when executing the code, cause the first wireless communication device to: receive a management frame from an upstream AP, where the management frame includes a first address field indicative of the first wireless communication device, a second address field indicative of the upstream AP, and a field indicative of a client device; and transmit, in accordance with the field indicative of the client device, a relayed version of the management frame to the client device, where the relayed version of the management frame includes a first address field indicative of the client device and a second address field indicative of the first wireless communication device.

Clause 29: The first wireless communication device of clause 28, where the field indicative of the client device is within an information element associated with satellite AP relaying and includes a MAC address of the client device.

Clause 30: The first wireless communication device of any of clauses 1-29, where the one or more processors are individually or collectively further configured to, when executing the code, cause the first wireless communication device to: transmit, to the root AP via the relay path, a frame including information indicative of a power management state of a client device; receive, from the root AP, a beacon payload associated with the client device in accordance with the power management state of the client device; and transmit, to the client device, a beacon frame in accordance with receiving the beacon payload, where the beacon frame includes the beacon payload.

Clause 31: The first wireless communication device of any of clauses 1-30, where the one or more processors are individually or collectively further configured to, when executing the code, cause the first wireless communication device to: receive, from the root AP via the relay path, a beacon payload associated with a client device; store the beacon payload in a buffer of the first wireless communication device in accordance with a power management state of the client device being associated with a power save mode; and transmit, to the client device, a beacon frame in accordance with the power management state of the client device switching to an active mode, where the beacon frame includes the beacon payload.

Clause 32: The first wireless communication device of any of clauses 1-31, where the one or more processors are individually or collectively further configured to, when executing the code, cause the first wireless communication device to: receive an encrypted unicast frame from the root AP via the relay path, where an encryption of the encrypted unicast frame is associated with a sequence number and a GTK, the GTK being specific to the first wireless communication device; unencrypt the encrypted unicast frame to obtain an unencrypted group addressed frame; and transmit the unencrypted group addressed frame via the relay path, where the set of PDUs includes the unencrypted group addressed frame.

Clause 33: The first wireless communication device of any of clauses 1-32, where the one or more processors are individually or collectively further configured to, when executing the code, cause the first wireless communication device to: receive an encrypted unicast frame and an indication of a sequence number from the root AP via the relay path; unencrypt the encrypted unicast frame to obtain an unencrypted group addressed frame; encrypt the unencrypted group addressed frame to obtain an encrypted group addressed frame, where an encryption of the encrypted group addressed frame is associated with the sequence number and a GTK, the GTK being specific to the first wireless communication device; and transmit the encrypted group addressed frame via the relay path, where the set of PDUs includes the encrypted group addressed frame.

Clause 34: The first wireless communication device of any of clauses 1-33, where the first wireless communication device is a satellite AP and the second wireless communication device is the root AP or a client device.

Clause 35: A first wireless communication device, including: one or more memories storing processor-executable code; and one or more processors coupled with the one or more memories and individually or collectively configured to, when executing the code, cause the first wireless communication device to: receive contextual information of one or more wireless communication devices, the one or more wireless communication devices associated with a relay path to the first wireless communication device via at least a second wireless communication device; communicating, via a relay path, a set of PDUs during a TXOP of the first wireless communication device or a third wireless communication device; and communicating, via the relay path, a BA associate with the set of PDUs during the TXOP, where the BA is associated with the relay path between the first wireless communication device and the third wireless communication device via at least the second wireless communication device.

Clause 36: The first wireless communication device of clause 35, where the one or more processors are individually or collectively further configured to, when executing the code, cause the first wireless communication device to: communicate the BA in accordance with an end-to-end encryption associated with the relay path.

Clause 37: The first wireless communication device of any of clauses 35-36, where the one or more processors are individually or collectively further configured to, when executing the code, cause the first wireless communication device to: scheduling communication with each of the one or more wireless communication devices associate with the relay path in accordance with the contextual information; and scheduling communication with each of one or more second wireless communication devices associate with a direct communication path to the first wireless communication in accordance with second contextual information of the one or more second wireless communication devices, where the first wireless communication device manages both the one or more wireless communication devices associated with the relay path and the one or more second wireless communication devices associated with the direct communication path.

Clause 38: The first wireless communication device of any of clauses 35-37, where the one or more processors are individually or collectively further configured to, when executing the code, cause the first wireless communication device to: retransmit, during the TXOP or a second TXOP, one or more PDUs of the set of PDUs in accordance with a comparison between a first set of sequence numbers associated with the set of PDUs and a second set of sequence numbers associated with successfully received PDUs of the set of PDUs, where the BA includes information indicative of the second set of sequence numbers associated with the successfully received PDUs of the set of PDUs.

Clause 39: The first wireless communication device of any of clauses 35-38, where each PDU of the set of PDUs includes a first address field indicative of the first wireless communication device, a second address field indicative of the second wireless communication device, and a field indicative of an AID of the third wireless communication device.

Clause 40: The first wireless communication device of clause 39, where, to communicate the set of PDUs, the one or more processors are individually or collectively further configured to, when executing the code, cause the first wireless communication device to: transmit the set of PDUs to the second wireless communication device, where the field indicative of the AID of the third wireless communication device indicates that the set of PDUs is to be relayed to the third wireless communication device.

Clause 41: The first wireless communication device of clause 40, where the one or more processors are individually or collectively further configured to, when executing the code, cause the first wireless communication device to: receive, from the second wireless communication device, a second BA including information indicative of the set of PDUs; and maintain a storage of information pertaining to the set of PDUs in accordance with the relay path and receiving the second BA from the second wireless communication device.

Clause 42: The first wireless communication device of any of clauses 40-41, where the one or more processors are individually or collectively further configured to, when executing the code, cause the first wireless communication device to: receive, from the second wireless communication device, a second BA including information indicative of successfully received PDUs of the set of PDUs; retransmit, during the TXOP, one or more PDUs of the set of PDUs in accordance with the second BA, the one or more PDUs including first unsuccessfully received PDUs; and receive, during the TXOP, a third BA associated with the one or more PDUs.

Clause 43: The first wireless communication device of any of clauses 39-42, where, to communicate the set of PDUs, the one or more processors are individually or collectively further configured to, when executing the code, cause the first wireless communication device to: receive the set of PDUs from the second wireless communication device, where the field indicative of the AID of the third wireless communication device indicates that the set of PDUs is relayed from the third wireless communication device.

Clause 44: The first wireless communication device of clause 43, where the one or more processors are individually or collectively further configured to, when executing the code, cause the first wireless communication device to: obtain the TXOP at the first wireless communication device; and transmit, to the second wireless communication device, a first frame associated with a sharing of the TXOP for uplink data from the third wireless communication device, where the frame initiates a transmission, by the second wireless communication device, of a second frame that triggers the uplink data from the third wireless communication device, and where receiving the set of PDUs is in accordance with transmitting the first frame associated with the sharing of the TXOP for the uplink data.

Clause 45: The first wireless communication device of any of clauses 43-44, where the one or more processors are individually or collectively further configured to, when executing the code, cause the first wireless communication device to: transmit, to the second wireless communication device, a second BA including information indicative of the set of PDUs.

Clause 46: The first wireless communication device of any of clauses 43-45, where the one or more processors are individually or collectively further configured to, when executing the code, cause the first wireless communication device to: transmit, in accordance with successfully receiving a first subset of the set of PDUs as part of a first transmission attempt, a second BA including information indicative the first subset of the set of PDUs; receive, as part of a second transmission attempt, a second subset of the set of PDUs in accordance with the second BA, where receiving the set of PDUs is associated with receiving the first subset as part of the first transmission attempt and receiving the second subset as part of the second transmission attempt; and transmit, in accordance with successfully receiving the second subset of the set of PDUs, a third BA including information indicative the second subset of the set of PDUs.

Clause 47: The first wireless communication device of any of clauses 35-46, where the BA includes a first address field indicative of the first wireless communication device, a second address field indicative of the second wireless communication device, and a field indicative of an AID of the third wireless communication device.

Clause 48: The first wireless communication device of clause 47, where, to communicate the BA, the one or more processors are individually or collectively further configured to, when executing the code, cause the first wireless communication device to: receive the BA from the second wireless communication device, where the field indicative of the AID of the third wireless communication device indicates that the BA is relayed from the third wireless communication device.

Clause 49: The first wireless communication device of clause 48, where the one or more processors are individually or collectively further configured to, when executing the code, cause the first wireless communication device to: receive the BA in accordance with a time duration until an expiration of the TXOP, where the first wireless communication device expects to receive the BA in accordance with the time duration until the expiration of the TXOP being less than or equal to a threshold time duration.

Clause 50: The first wireless communication device of any of clauses 47-49, where, to communicate the BA, the one or more processors are individually or collectively further configured to, when executing the code, cause the first wireless communication device to: transmit the BA to the second wireless communication device, where the field indicative of the AID of the third wireless communication device indicates that the BA is to be relayed to the third wireless communication device.

Clause 51: The first wireless communication device of any of clauses 35-50, where the one or more processors are individually or collectively further configured to, when executing the code, cause the first wireless communication device to: transmit information indicative of a termination of the TXOP, where transmission of the information indicative of the termination of the TXOP triggers a discarding of the set of PDUs at the second wireless communication device.

Clause 52: The first wireless communication device of clause 51, where the one or more processors are individually or collectively further configured to, when executing the code, cause the first wireless communication device to: transmit the information indicative of the termination of the TXOP via a CF-End frame, where an address field of the CF-End frame is indicative of the second wireless communication device.

Clause 53: The first wireless communication device of any of clauses 35-52, where the one or more processors are individually or collectively further configured to, when executing the code, cause the first wireless communication device to: perform a channel access scheme in accordance with communicating the BA with the second wireless communication device; and communicate a second set of PDUs with a fourth wireless communication during the TXOP in accordance with performing the channel access scheme.

Clause 54: The first wireless communication device of any of clauses 35-53, where the one or more processors are individually or collectively further configured to, when executing the code, cause the first wireless communication device to: communicating, with the second wireless communication device, a reservation frame associate with the TXOP, where the reservation frame is associated with a protection of the TXOP at the second wireless communication device; and communicating, with the second wireless communication device, a confirmation frame, where the confirmation frame be further associated with the protection of the TXOP at the second wireless communication device.

Clause 55: The first wireless communication device of clause 54, where the reservation frame is an RTS frame and the confirmation frame is a CTS frame.

Clause 56: The first wireless communication device of any of clauses 54-55, where each of the reservation frame and the confirmation frame indicate an entire duration of the TXOP.

Clause 57: The first wireless communication device of any of clauses 54-56, where any one or more of the reservation frame and the confirmation frame indicate channel quality information, and where a rate adaptation at the first wireless communication device, the second wireless communication device, or the third wireless communication device is associated with the channel quality information.

Clause 58: The first wireless communication device of any of clauses 35-57, where the one or more processors are individually or collectively further configured to, when executing the code, cause the first wireless communication device to: receive, in accordance with the relay path, a relayed version of a management frame, where the relayed version of the management frame includes a first address field indicative of the first wireless communication device, a second address field indicative of the second wireless communication device, and a field indicative of the third wireless communication device, where the field indicative of the third wireless communication device indicates that the management frame is relayed from the third wireless communication device.

Clause 59: The first wireless communication device of clause 58, where the field indicative of the third wireless communication device is within an information element associated with satellite AP relaying and includes a MAC address of the third wireless communication device.

Clause 60: The first wireless communication device of any of clauses 35-59, where the one or more processors are individually or collectively further configured to, when executing the code, cause the first wireless communication device to: transmit a management frame to the second wireless communication device, where the management frame includes a first address field indicative of the first wireless communication device, a second address field indicative of the second wireless communication device, and a field indicative of the third wireless communication device, and where the field indicative of the third wireless communication device indicates that the management frame is to be relayed to the third wireless communication device.

Clause 61: The first wireless communication device of clause 60, where the field indicative of the third wireless communication device is within an information element associated with satellite AP relaying and includes a MAC address of the third wireless communication device.

Clause 62: The first wireless communication device of any of clauses 35-61, where the one or more processors are individually or collectively further configured to, when executing the code, cause the first wireless communication device to: receive a frame including information indicative of a power management state of the third wireless communication device; and transmit, to the second wireless communication device, a beacon payload associated with the third wireless communication device in accordance with the power management state of the third wireless communication device, where transmission of the beacon payload triggers a transmission, by the second wireless communication device, of a beacon frame including the beacon payload.

Clause 63: The first wireless communication device of any of clauses 35-62, where the one or more processors are individually or collectively further configured to, when executing the code, cause the first wireless communication device to: transmit an encrypted unicast frame to the second wireless communication device, where an encryption of the encrypted unicast frame is associated with a sequence number and a GTK, the GTK being specific to the second wireless communication device, and where the encrypted unicast frame is associated with a group addressed frame, and where the set of PDUs includes the group addressed frame.

Clause 64: The first wireless communication device of any of clauses 35-63, where the one or more processors are individually or collectively further configured to, when executing the code, cause the first wireless communication device to: transmit an encrypted unicast frame and an indication of a sequence number to the second wireless communication device, where the encrypted unicast frame is associated with a group addressed frame, and where the set of PDUs includes the group addressed frame.

Clause 65: The first wireless communication device of any of clauses 35-64, where the first wireless communication device is a root AP, the second wireless communication device is a satellite AP, and the third wireless communication device is a client device.

Clause 66: A method for wireless communication at a first wireless communication device, including: transmitting contextual information of one or more wireless communication devices, the one or more wireless communication devices associated with a relay path to a root AP via at least the first wireless communication device; transmitting, via the relay path, a set of PDUs during a TXOP of a second wireless communication device; receiving, via the relay path, a first BA associated with the set of PDUs during the TXOP; and transmitting, via the relay path and in accordance with the first BA, a second BA associated with the set of PDUs during the TXOP.

Clause 67: The method of clause 66, further including: transmitting the second BA in accordance with an end-to-end encryption associated with the relay path.

Clause 68: The method of any of clauses 66-67, further including: transmitting the set of PDUs without reordering the set of PDUs, where the set of PDUs are a successfully received set of PDUs of a second set of PDUs.

Clause 69: The method of any of clauses 66-68, further including: refraining from retransmitting any PDUs of the set of PDUs that are unsuccessfully received.

Clause 70: The method of any of clauses 66-69, further including: adjusting a set of physical layer parameters associated with a communication link in accordance with a comparison between a first set of sequence numbers associated with the set of PDUs and a second set of sequence numbers associated with successfully received PDUs of the set of PDUs, where the first BA includes information indicative of the second set of sequence numbers associated with the successfully received PDUs of the set of PDUs.

Clause 71: The method of any of clauses 66-68 and 70, further including: receiving, via the first BA, information indicative of first successfully received PDUs of the set of PDUs; retransmitting, during the TXOP, one or more PDUs of the set of PDUs in accordance with the first BA, the one or more PDUs including first unsuccessfully received PDUs; and receiving, during the TXOP, a third BA associated with the one or more PDUs.

Clause 72: The method of clause 71, further including: receiving, via the third BA, information indicative of second successfully received PDUs associated with the one or more PDUs; and transmitting, via the second BA, information indicative of both the first successfully received PDUs and the second successfully received PDUs.

Clause 73: The method of any of clauses 66-72, further including: transmitting the second BA in accordance with a time duration until an expiration of the TXOP.

Clause 74: The method of clause 73, where the first wireless communication device transmits the second BA in accordance with the time duration until the expiration of the TXOP being less than or equal to a threshold time duration.

Clause 75: The method of any of clauses 66-74, further including: receiving information indicative of a termination of the TXOP; and discarding the set of PDUs in accordance with the termination of the TXOP.

Clause 76: The method of clause 75, further including: receiving the information indicative of the termination of the TXOP via a CF-End frame, where an address field of the CF-End frame is indicative of the first wireless communication device.

Clause 77: The method of any of clauses 66-76, further including: receiving a frame associated with an end-to-end reservation of the TXOP, where the end-to-end reservation of the TXOP is associated with end-to-end communication between a client device and the root AP via the relay path within the TXOP.

Clause 78: The method of any of clauses 66-77, further including: receiving, via the relay path, the set of PDUs during the TXOP, where the set of PDUs transmitted by the first wireless communication device via the relay path includes relayed versions of the set of PDUs received via the relay path.

Clause 79: The method of clause 78, further including: receiving a first frame associated with a sharing of the TXOP for uplink data; and transmitting a second frame that triggers the uplink data, where receiving the set of PDUs is in accordance with transmitting the second frame that triggers the uplink data.

Clause 80: The method of any of clauses 78-79, further including: transmitting, in accordance with successfully receiving the set of PDUs, a third BA including information indicative of the set of PDUs.

Clause 81: The method of any of clauses 78-80, further including: transmitting, in accordance with successfully receiving a first subset of the set of PDUs as part of a first transmission attempt, a third BA including information indicative the first subset of the set of PDUs; receiving, as part of a second transmission attempt, a second subset of the set of PDUs in accordance with the third BA, where receiving the set of PDUs is associated with receiving the first subset as part of the first transmission attempt and receiving the second subset as part of the second transmission attempt; and transmitting, in accordance with successfully receiving the second subset of the set of PDUs, a fourth BA including information indicative the second subset of the set of PDUs.

Clause 82: The method of any of clauses 66-81, further including: receiving, from the second wireless communication device, a first reservation frame associated with the TXOP; transmitting, to a third wireless communication device and in accordance with receiving the first reservation frame, a second reservation frame associated with the TXOP; receiving, from the third wireless communication device and in accordance with transmitting the second reservation frame, a first confirmation frame associated with the TXOP; and transmitting, in accordance with receiving the first confirmation frame, a second confirmation frame associated with the TXOP.

Clause 83: The method of clause 82, where the first reservation frame is a first RTS frame, the second reservation frame is a second RTS frame, the first confirmation frame is a CTS frame, and the second confirmation frame is a CTS-to-self frame.

Clause 84: The method of any of clauses 82-83, where each of the first reservation frame, the second reservation frame, the first confirmation frame, and the second confirmation frame indicate an entire duration of the TXOP.

Clause 85: The method of any of clauses 82-84, where any one or more of the first reservation frame, the second reservation frame, the first confirmation frame, and the second confirmation frame indicate channel quality information, and a rate adaptation at the first wireless communication device is associated with the channel quality information.

Clause 86: The method of any of clauses 66-85, further including: receiving, via the relay path, the set of PDUs from an upstream AP, where each PDU of the set of PDUs includes a first address field indicative of the first wireless communication device, a second address field indicative of the upstream AP, and a field indicative of an AID of a client device, where the set of PDUs transmitted by the first wireless communication device via the relay path includes relayed versions of the set of PDUs received via the relay path and are transmitted to the client device, and where each PDU of the relayed versions of the set of PDUs includes a first address field indicative of the client device and a second address field indicative of the first wireless communication device.

Clause 87: The method of clause 86, further including: deriving a MAC address of the client device in accordance with the AID of the client device, where the first address field indicates the MAC address of the client device.

Clause 88: The method of any of clauses 86-87, further including: receiving the first BA from the client device, where the first BA includes a first address field indicative of the first wireless communication device and a second address field indicative of the client device; and transmitting, via the relay path, the second BA to the upstream AP, where the second BA includes a first address field indicative of the upstream AP, a second address field indicative of the first wireless communication device, and a field indicative of the AID of the client device.

Clause 89: The method of any of clauses 66-88, further including: receiving, via the relay path, the set of PDUs from a client device, where each PDU of the set of PDUs includes a first address field indicative of the first wireless communication device and a second address field indicative of the client device, where the set of PDUs transmitted by the first wireless communication device via the relay path includes relayed versions of the set of PDUs received via the relay path and are transmitted to an upstream AP, and where each PDU of the relayed versions of the set of PDUs includes a first address field indicative of the upstream AP, a second address field indicative of the first wireless communication device, and a field indicative of an AID of the client device.

Clause 90: The method of clause 89, further including: receiving the first BA from the upstream AP, where the first BA includes a first address field indicative of the first wireless communication device, a second address field indicative of the upstream AP, and a field indicative of the AID of the client device; and transmitting, in accordance with the AID of the client device, the second BA to the client device, where the second BA includes a first address field indicative of the client device and a second address field indicative of the first wireless communication device.

Clause 91: The method of any of clauses 66-90, further including: receiving a management frame from a client device, where the management frame includes a first address field indicative of the first wireless communication device and a second address field indicative of the client device; and transmitting, in accordance with the relay path, a relayed version of the management frame to an upstream AP, where the relayed version of the management frame includes a first address field indicative of the upstream AP, a second address field indicative of the first wireless communication device, and a field indicative of the client device.

Clause 92: The method of clause 91, where the field indicative of the client device is within an information element associated with satellite AP relaying and includes a MAC address of the client device.

Clause 93: The method of any of clauses 66-92, further including: receiving a management frame from an upstream AP, where the management frame includes a first address field indicative of the first wireless communication device, a second address field indicative of the upstream AP, and a field indicative of a client device; and transmitting, in accordance with the field indicative of the client device, a relayed version of the management frame to the client device, where the relayed version of the management frame includes a first address field indicative of the client device and a second address field indicative of the first wireless communication device.

Clause 94: The method of clause 93, where the field indicative of the client device is within an information element associated with satellite AP relaying and includes a MAC address of the client device.

Clause 95: The method of any of clauses 66-94, further including: transmitting, to the root AP via the relay path, a frame including information indicative of a power management state of a client device; receiving, from the root AP, a beacon payload associated with the client device in accordance with the power management state of the client device; and transmitting, to the client device, a beacon frame in accordance with receiving the beacon payload, where the beacon frame includes the beacon payload.

Clause 96: The method of any of clauses 66-95, further including: receiving, from the root AP via the relay path, a beacon payload associated with a client device; storing the beacon payload in a buffer of the first wireless communication device in accordance with a power management state of the client device being associated with a power save mode; and transmitting, to the client device, a beacon frame in accordance with the power management state of the client device switching to an active mode, where the beacon frame includes the beacon payload.

Clause 97: The method of any of clauses 66-96, further including: receiving an encrypted unicast frame from the root AP via the relay path, where an encryption of the encrypted unicast frame is associated with a sequence number and a GTK, the GTK being specific to the first wireless communication device; unencrypting the encrypted unicast frame to obtain an unencrypted group addressed frame; and transmitting the unencrypted group addressed frame via the relay path, where the set of PDUs includes the unencrypted group addressed frame.

Clause 98: The method of any of clauses 66-97, further including: receiving an encrypted unicast frame and an indication of a sequence number from the root AP via the relay path; unencrypting the encrypted unicast frame to obtain an unencrypted group addressed frame; encrypting the unencrypted group addressed frame to obtain an encrypted group addressed frame, where an encryption of the encrypted group addressed frame is associated with the sequence number and a GTK, the GTK being specific to the first wireless communication device; and transmitting the encrypted group addressed frame via the relay path, where the set of PDUs includes the encrypted group addressed frame.

Clause 99: The method of any of clauses 66-98, where the first wireless communication device is a satellite AP and the second wireless communication device is the root AP or a client device.

Clause 100: A method for wireless communication at a first wireless communication device, including: receiving contextual information of one or more wireless communication devices, the one or more wireless communication devices associated with a relay path to the first wireless communication device via at least a second wireless communication device; communicating, via a relay path, a set of PDUs during a TXOP of the first wireless communication device or a third wireless communication device; and communicating, via the relay path, a BA associated with the set of PDUs during the TXOP, where the BA is associated with the relay path between the first wireless communication device and the third wireless communication device via at least the second wireless communication device.

Clause 101: The method of clause 100, further including: communicating the BA in accordance with an end-to-end encryption associated with the relay path.

Clause 102: The method of any of clauses 100-101, further including: scheduling communication with each of the one or more wireless communication devices associated with the relay path in accordance with the contextual information; and scheduling communication with each of one or more second wireless communication devices associated with a direct communication path to the first wireless communication in accordance with second contextual information of the one or more second wireless communication devices, where the first wireless communication device manages both the one or more wireless communication devices associated with the relay path and the one or more second wireless communication devices associated with the direct communication path.

Clause 103: The method of any of clauses 100-102, further including: retransmitting, during the TXOP or a second TXOP, one or more PDUs of the set of PDUs in accordance with a comparison between a first set of sequence numbers associated with the set of PDUs and a second set of sequence numbers associated with successfully received PDUs of the set of PDUs, where the BA includes information indicative of the second set of sequence numbers associated with the successfully received PDUs of the set of PDUs.

Clause 104: The method of any of clauses 100-103, where each PDU of the set of PDUs includes a first address field indicative of the first wireless communication device, a second address field indicative of the second wireless communication device, and a field indicative of an AID of the third wireless communication device.

Clause 105: The method of clause 104, where communicating the set of PDUs includes: transmitting the set of PDUs to the second wireless communication device, where the field indicative of the AID of the third wireless communication device indicates that the set of PDUs is to be relayed to the third wireless communication device.

Clause 106: The method of clause 105, further including: receiving, from the second wireless communication device, a second BA including information indicative of the set of PDUs; and maintaining a storage of information pertaining to the set of PDUs in accordance with the relay path and receiving the second BA from the second wireless communication device.

Clause 107: The method of any of clauses 105-106, further including: receiving, from the second wireless communication device, a second BA including information indicative of successfully received PDUs of the set of PDUs; retransmitting, during the TXOP, one or more PDUs of the set of PDUs in accordance with the second BA, the one or more PDUs including first unsuccessfully received PDUs; and receiving, during the TXOP, a third BA associated with the one or more PDUs.

Clause 108: The method of any of clauses 104-107, where communicating the set of PDUs includes: receiving the set of PDUs from the second wireless communication device, where the field indicative of the AID of the third wireless communication device indicates that the set of PDUs is relayed from the third wireless communication device.

Clause 109: The method of clause 108, further including: obtaining the TXOP at the first wireless communication device; and transmitting, to the second wireless communication device, a first frame associated with a sharing of the TXOP for uplink data from the third wireless communication device, where the frame initiates a transmission, by the second wireless communication device, of a second frame that triggers the uplink data from the third wireless communication device, and where receiving the set of PDUs is in accordance with transmitting the first frame associated with the sharing of the TXOP for the uplink data.

Clause 110: The method of any of clauses 108-109, further including: transmitting, to the second wireless communication device, a second BA including information indicative of the set of PDUs.

Clause 111: The method of any of clauses 108-110, further including: transmitting, in accordance with successfully receiving a first subset of the set of PDUs as part of a first transmission attempt, a second BA including information indicative the first subset of the set of PDUs; receiving, as part of a second transmission attempt, a second subset of the set of PDUs in accordance with the second BA, where receiving the set of PDUs is associated with receiving the first subset as part of the first transmission attempt and receiving the second subset as part of the second transmission attempt; and transmitting, in accordance with successfully receiving the second subset of the set of PDUs, a third BA including information indicative the second subset of the set of PDUs.

Clause 112: The method of any of clauses 100-111, where the BA includes a first address field indicative of the first wireless communication device, a second address field indicative of the second wireless communication device, and a field indicative of an AID of the third wireless communication device.

Clause 113: The method of clause 112, where communicating the BA includes: receiving the BA from the second wireless communication device, where the field indicative of the AID of the third wireless communication device indicates that the BA is relayed from the third wireless communication device.

Clause 114: The method of clause 113, further including: receiving the BA in accordance with a time duration until an expiration of the TXOP, where the first wireless communication device expects to receive the BA in accordance with the time duration until the expiration of the TXOP being less than or equal to a threshold time duration.

Clause 115: The method of any of clauses 112-114, where communicating the BA includes: transmitting the BA to the second wireless communication device, where the field indicative of the AID of the third wireless communication device indicates that the BA is to be relayed to the third wireless communication device.

Clause 116: The method of any of clauses 100-115, further including: transmitting information indicative of a termination of the TXOP, where transmission of the information indicative of the termination of the TXOP triggers a discarding of the set of PDUs at the second wireless communication device.

Clause 117: The method of clause 116, further including: transmitting the information indicative of the termination of the TXOP via a CF-End frame, where an address field of the CF-End frame is indicative of the second wireless communication device.

Clause 118: The method of any of clauses 100-117, further including: performing a channel access scheme in accordance with communicating the BA with the second wireless communication device; and communicating a second set of PDUs with a fourth wireless communication during the TXOP in accordance with performing the channel access scheme.

Clause 119: The method of any of clauses 100-118, further including: communicating, with the second wireless communication device, a reservation frame associated with the TXOP, where the reservation frame is associated with a protection of the TXOP at the second wireless communication device; and communicating, with the second wireless communication device, a confirmation frame, where the confirmation frame is further associated with the protection of the TXOP at the second wireless communication device.

Clause 120: The method of clause 119, where the reservation frame is an RTS frame and the confirmation frame is a CTS frame.

Clause 121: The method of any of clauses 119-120, where each of the reservation frame and the confirmation frame indicate an entire duration of the TXOP.

Clause 122: The method of any of clauses 119-121, where any one or more of the reservation frame and the confirmation frame indicate channel quality information, and a rate adaptation at the first wireless communication device, the second wireless communication device, or the third wireless communication device is associated with the channel quality information.

Clause 123: The method of any of clauses 100-122, further including: receiving, in accordance with the relay path, a relayed version of a management frame, where the relayed version of the management frame includes a first address field indicative of the first wireless communication device, a second address field indicative of the second wireless communication device, and a field indicative of the third wireless communication device, where the field indicative of the third wireless communication device indicates that the management frame is relayed from the third wireless communication device.

Clause 124: The method of clause 123, where the field indicative of the third wireless communication device is within an information element associated with satellite AP relaying and includes a MAC address of the third wireless communication device.

Clause 125: The method of any of clauses 100-124, further including: transmitting a management frame to the second wireless communication device, where the management frame includes a first address field indicative of the first wireless communication device, a second address field indicative of the second wireless communication device, and a field indicative of the third wireless communication device, and where the field indicative of the third wireless communication device indicates that the management frame is to be relayed to the third wireless communication device.

Clause 126: The method of clause 125, where the field indicative of the third wireless communication device is within an information element associated with satellite AP relaying and includes a MAC address of the third wireless communication device.

Clause 127: The method of any of clauses 100-126, further including: receiving a frame including information indicative of a power management state of the third wireless communication device; and transmitting, to the second wireless communication device, a beacon payload associated with the third wireless communication device in accordance with the power management state of the third wireless communication device, where transmission of the beacon payload triggers a transmission, by the second wireless communication device, of a beacon frame including the beacon payload.

Clause 128: The method of any of clauses 100-127, further including: transmitting an encrypted unicast frame to the second wireless communication device, where an encryption of the encrypted unicast frame is associated with a sequence number and a GTK, the GTK being specific to the second wireless communication device, and where the encrypted unicast frame is associated with a group addressed frame, and where the set of PDUs includes the group addressed frame.

Clause 129: The method of any of clauses 100-128, further including: transmitting an encrypted unicast frame and an indication of a sequence number to the second wireless communication device, where the encrypted unicast frame is associated with a group addressed frame, and where the set of PDUs includes the group addressed frame.

Clause 130: The method of any of clauses 100-129, where the first wireless communication device is a root AP, the second wireless communication device is a satellite AP, and the third wireless communication device is a client device.

Clause 131: A first wireless communication device, including at least one means for performing a method of any of clauses 66-99.

Clause 132: A non-transitory computer-readable medium storing code for wireless communication at a first wireless communication device, the code including instructions executable by one or more processors individually or collectively to perform a method of any of clauses 66-99.

Clause 133: A first wireless communication device, including at least one means for performing a method of any of clauses 100-130.

Clause 134: A non-transitory computer-readable medium storing code for wireless communication at a first wireless communication device, the code including instructions executable by one or more processors individually or collectively to perform a method of any of clauses 100-130.

Clause 135: A first wireless communication device, including: one or more memories storing processor-executable code; and one or more processors coupled with the one or more memories and individually or collectively configured to, when executing the code, cause the first wireless communication device to: receive, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device; and transmit, to the second wireless communication device in accordance with the multi-hop channel sounding, at least a second frame indicating: first channel information associated with a first wireless communication link between the first wireless communication device and the second wireless communication device; and second channel information associated with a second wireless communication link between the first wireless communication device and the third wireless communication device. Additionally, in some implementations, the first wireless communication device of clause 135 may further be capable of performing a method of any combination of clauses 66-130.

Clause 136: The first wireless communication device of clause 135, where the one or more processors are individually or collectively further configured to, when executing the code, cause the first wireless communication device to: receive, from the second wireless communication device, a third frame associated with a sharing of a transmission opportunity (TXOP) or a service period (SP) of the second wireless communication device with the first wireless communication device, where the multi-hop channel sounding is performed within the TXOP or the SP in accordance with the sharing of the TXOP or the SP.

Clause 137: The first wireless communication device of any of clauses 135-136, where the one or more processors are individually or collectively further configured to, when executing the code, cause the first wireless communication device to: transmit a third frame to obtain a transmission opportunity (TXOP) or a service period (SP) of the second wireless communication device in accordance with the first frame including the first identifying information and the second identifying information, where the multi-hop channel sounding is performed within the TXOP or the SP in accordance with obtainment of the TXOP or the SP.

Clause 138: The first wireless communication device of clause 137, where the one or more processors are individually or collectively further configured to, when executing the code, cause the first wireless communication device to: receive a second instance of the first frame in accordance with transmitting the third frame, where at least the second frame is transmitted in accordance with receiving the second instance of the first frame.

Clause 139: The first wireless communication device of any of clauses 135-138, where the one or more processors are individually or collectively further configured to, when executing the code, cause the first wireless communication device to: receive, in accordance with the multi-hop channel sounding, one or more sounding packets from the second wireless communication device, where the first channel information is associated with the one or more sounding packets.

Clause 140: The first wireless communication device of any of clauses 135-139, where the one or more processors are individually or collectively further configured to, when executing the code, cause the first wireless communication device to: measure the first frame in accordance with the multi-hop channel sounding, where the first channel information is associated with the first frame.

Clause 141: The first wireless communication device of any of clauses 135-140, where the one or more processors are individually or collectively further configured to, when executing the code, cause the first wireless communication device to: transmit, in accordance with the first frame including the second identifying information corresponding to the third wireless communication device, a third frame associated with the multi-hop channel sounding, the third frame including the second identifying information corresponding to the third wireless communication device; transmit, to the third wireless communication device, one or more sounding packets in accordance with the multi-hop channel sounding; and receive, from the third wireless communication device, a fourth frame indicating the second channel information, where the second channel information is associated with the one or more sounding packets.

Clause 142: The first wireless communication device of any of clauses 135-141, where, to transmit at least the second frame indicating the first channel information and the second channel information, the one or more processors are individually or collectively further configured to, when executing the code, cause the first wireless communication device to: transmit the second frame indicating the first channel information; and transmit a third frame indicting the second channel information, where the third frame is a relayed version of a frame received from the third wireless communication device.

Clause 143: The first wireless communication device of any of clauses 135-141, where, to transmit at least the second frame indicating the first channel information and the second channel information, the one or more processors are individually or collectively further configured to, when executing the code, cause the first wireless communication device to: transmit the second frame indicating both the first channel information and the second channel information.

Clause 144: The first wireless communication device of any of clauses 135-143, where the second channel information is associated with a previous channel sounding between the first wireless communication device and the third wireless communication device, and where the one or more processors are individually or collectively further configured to, when executing the code, cause the first wireless communication device to: receive, from the second wireless communication device, a third frame indicating whether the multi-hop channel sounding is terminated in accordance with the second channel information.

Clause 145: The first wireless communication device of clause 144, where, to receive the third frame, the one or more processors are individually or collectively further configured to, when executing the code, cause the first wireless communication device to: receive, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

Clause 146: The first wireless communication device of clause 144, where, to receive the third frame, the one or more processors are individually or collectively further configured to, when executing the code, cause the first wireless communication device to: receive, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

Clause 147: The first wireless communication device of clause 146, where the one or more processors are individually or collectively further configured to, when executing the code, cause the first wireless communication device to: transmit, to the third wireless communication device, a sounding announcement frame and one or more sounding packets in accordance with the continuation of the multi-hop channel sounding; receive, from the third wireless communication device, a fourth frame indicating third channel information associated with the second wireless communication link between the first wireless communication device and the third wireless communication device, where the third channel information is associated with one or more of the sounding announcement frame or the one or more sounding packets; and transmit, to the second wireless communication device, a fifth frame indicating the third channel information, where the fifth frame is a relayed version of the fourth frame.

Clause 148: The first wireless communication device of any of clauses 135-147, where the one or more processors are individually or collectively further configured to, when executing the code, cause the first wireless communication device to: receive one or more beacon frames transmitted by the second wireless communication device, where the first channel information is associated with the one or more beacon frames.

Clause 149: The first wireless communication device of any of clauses 135-148, where the one or more processors are individually or collectively further configured to, when executing the code, cause the first wireless communication device to: receive, from the second wireless communication device, a third frame in accordance with transmitting at least the second frame indicating the first channel information and the second channel information; and return a transmission opportunity (TXOP) or a service period (SP) of the second wireless communication device in accordance with receiving the third frame.

Clause 150: The first wireless communication device of any of clauses 135-149, where the one or more processors are individually or collectively further configured to, when executing the code, cause the first wireless communication device to: receive, from the second wireless communication device, information indicative of an amount of data to be relayed, during a transmission opportunity (TXOP) or a service period (SP), between the second wireless communication device and the third wireless communication device via at least the first wireless communication device; and transmit, to the second wireless communication device, an indication of an estimated amount of resources, where the estimated amount of resources is associated with the amount of data and at least one of the first channel information and the second channel information.

Clause 151: The first wireless communication device of any of clauses 135-150, where the one or more processors are individually or collectively further configured to, when executing the code, cause the first wireless communication device to: receive, from the second wireless communication device, a trigger frame associated with the multi-hop channel sounding, where transmitting at least the second frame indicating the first channel information is in accordance with the trigger frame.

Clause 152: The first wireless communication device of clause 151, where the trigger frame includes the first identifying information associated with the first wireless communication device and the second identifying information associated with the third wireless communication device.

Clause 153: The first wireless communication device of any of clauses 135-152, where the first channel information is associated with a first channel state resolution and the second channel information is associated with a second channel state resolution lower than the first channel state resolution.

Clause 154: The first wireless communication device of any of clauses 135-153, where the one or more processors are individually or collectively further configured to, when executing the code, cause the first wireless communication device to: transmit, via a relay path between the second wireless communication device and the third wireless communication device, one or more data frames in accordance with the multi-hop channel sounding.

Clause 155: The first wireless communication device of clause 154, where the one or more processors are individually or collectively further configured to, when executing the code, cause the first wireless communication device to: transmit the one or more data frames via the relay path during a transmission opportunity (TXOP) or a service period (SP) within which the multi-hop channel sounding is performed.

Clause 156: The first wireless communication device of any of clauses 135-155, where the first wireless communication device receives the first frame and transmits at least the second frame during a same transmission opportunity (TXOP) or a same service period (SP).

Clause 157: The first wireless communication device of any of clauses 135-156, where inclusion of the second identifying information corresponding to the third wireless communication device indicates, to the first wireless communication device, that the first frame is associated with an initiation of the multi-hop channel sounding.

Clause 158: The first wireless communication device of any of clauses 135-157, where the first frame is a sounding announcement frame or a request-to-send (RTS) frame, and the second frame is a compressed beamforming (CBF) frame or a clear-to-send (CTS) frame.

Clause 159: A first wireless communication device, including: one or more memories storing processor-executable code; and one or more processors coupled with the one or more memories and individually or collectively configured to, when executing the code, cause the first wireless communication device to: transmit a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device; and receive, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device. Additionally, in some implementations, the first wireless communication device of clause 159 may further be capable of performing a method of any combination of clauses 66-130.

Clause 160: The first wireless communication device of clause 159, where the one or more processors are individually or collectively further configured to, when executing the code, cause the first wireless communication device to: transmit, to the second wireless communication device, a third frame associated with a sharing of a transmission opportunity (TXOP) or a service period (SP) of the first wireless communication device with the second wireless communication device, where the multi-hop channel sounding is performed within the TXOP or the SP in accordance with the sharing of the TXOP or the SP.

Clause 161: The first wireless communication device of any of clauses 159-160, where the one or more processors are individually or collectively further configured to, when executing the code, cause the first wireless communication device to: receive a third frame associated with an obtainment of a transmission opportunity (TXOP) or a service period (SP) of the first wireless communication device by the second wireless communication device in accordance with the first frame including the first identifying information and the second identifying information, where the multi-hop channel sounding is performed within the TXOP or the SP in accordance with the obtainment of the TXOP or the SP by the second wireless communication device.

Clause 162: The first wireless communication device of clause 161, where the one or more processors are individually or collectively further configured to, when executing the code, cause the first wireless communication device to: transmit a second instance of the first frame in accordance with receiving the third frame, where at least the second frame is received in accordance with transmitting the second instance of the first frame.

Clause 163: The first wireless communication device of any of clauses 159-162, where the one or more processors are individually or collectively further configured to, when executing the code, cause the first wireless communication device to: transmit, in accordance with the multi-hop channel sounding, one or more sounding packets, where at least the first channel information is associated with the one or more sounding packets.

Clause 164: The first wireless communication device of any of clauses 159-163, where, to receive at least the second frame indicating the first channel information and the second channel information, the one or more processors are individually or collectively further configured to, when executing the code, cause the first wireless communication device to: receive, from the second wireless communication device, the second frame indicating the first channel information; and receive, from the second wireless communication device, a third frame indicating the second channel information.

Clause 165: The first wireless communication device of any of clauses 159-163, where, to receive at least the second frame indicating the first channel information and the second channel information, the one or more processors are individually or collectively further configured to, when executing the code, cause the first wireless communication device to: receive, from the second wireless communication device, the second frame indicating both the first channel information and the second channel information.

Clause 166: The first wireless communication device of any of clauses 159-165, where the second channel information is associated with a previous channel sounding between the second wireless communication device and the third wireless communication device, and where the one or more processors are individually or collectively further configured to, when executing the code, cause the first wireless communication device to: transmit, to the second wireless communication device, a third frame indicating whether the multi-hop channel sounding is terminated in accordance with the second channel information.

Clause 167: The first wireless communication device of clause 166, where, to transmit the third frame, the one or more processors are individually or collectively further configured to, when executing the code, cause the first wireless communication device to: transmit, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

Clause 168: The first wireless communication device of clause 166, where, to transmit the third frame, the one or more processors are individually or collectively further configured to, when executing the code, cause the first wireless communication device to: transmit, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

Clause 169: The first wireless communication device of clause 168, where the one or more processors are individually or collectively further configured to, when executing the code, cause the first wireless communication device to: receive, from the second wireless communication device, a fourth frame indicating third channel information associated with the second wireless communication link between the second wireless communication device and the third wireless communication device.

Clause 170: The first wireless communication device of any of clauses 159-169, where the one or more processors are individually or collectively further configured to, when executing the code, cause the first wireless communication device to: receive, from the third wireless communication device, a third frame indicating third channel information associated with a third wireless communication link between the first wireless communication device and the third wireless communication device.

Clause 171: The first wireless communication device of clause 170, where the one or more processors are individually or collectively further configured to, when executing the code, cause the first wireless communication device to: transmit, to the second wireless communication device, a fourth frame associated with a sharing of a transmission opportunity (TXOP) or a service period (SP) of the first wireless communication device with the second wireless communication device in accordance with the third channel information, where receiving the second channel information is in association with transmitting the fourth frame.

Clause 172: The first wireless communication device of any of clauses 170-171, where the one or more processors are individually or collectively further configured to, when executing the code, cause the first wireless communication device to: establish a data path between the first wireless communication device and the third wireless communication device in accordance with the first channel information, the second channel information, and the third channel information, where establishing the data path is in association with selecting a multi-hop relay data path associated with the first wireless communication link and the second wireless communication link or a direct data path associated with the third wireless communication link.

Clause 173: The first wireless communication device of any of clauses 159-172, where the one or more processors are individually or collectively further configured to, when executing the code, cause the first wireless communication device to: transmit a third frame in accordance with receiving at least the second frame indicating the first channel information and the second channel information, where the third frame is transmitted to re-obtain a transmission opportunity (TXOP) or a service period (SP) of the first wireless communication device.

Clause 174: The first wireless communication device of any of clauses 159-173, where the one or more processors are individually or collectively further configured to, when executing the code, cause the first wireless communication device to: transmit, to the second wireless communication device, information indicative of an amount of data to be relayed, during a transmission opportunity (TXOP) or a service period (SP), between the first wireless communication device and the third wireless communication device via at least the second wireless communication device; and receive, from the second wireless communication device, an indication of an estimated amount of resources, where the estimated amount of resources is associated with the amount of data and at least one of the first channel information and the second channel information.

Clause 175: The first wireless communication device of any of clauses 159-174, where the one or more processors are individually or collectively further configured to, when executing the code, cause the first wireless communication device to: transmit, to the second wireless communication device, a trigger frame associated with the multi-hop channel sounding, where receiving at least the second frame indicating the first channel information is in accordance with the trigger frame.

Clause 176: The first wireless communication device of clause 175, where the trigger frame includes the first identifying information associated with the first wireless communication device and the second identifying information associated with the third wireless communication device.

Clause 177: The first wireless communication device of any of clauses 159-176, where the first channel information is associated with a first channel state resolution and the second channel information is associated with a second channel state resolution lower than the first channel state resolution.

Clause 178: The first wireless communication device of any of clauses 159-177, where the first wireless communication device transmits the first frame and receives at least the second frame during a same transmission opportunity (TXOP) or a same service period (SP).

Clause 179: The first wireless communication device of any of clauses 159-178, where inclusion of the second identifying information corresponding to the third wireless communication device indicates, to the second wireless communication device, that the first frame is associated with an initiation of the multi-hop channel sounding.

Clause 180: The first wireless communication device of any of clauses 159-179, where the first frame is a sounding announcement frame or a request-to-send (RTS) frame, and the second frame is a compressed beamforming (CBF) frame or a clear-to-send (CTS) frame.

Clause 181: A method for wireless communication at a first wireless communication device, including: receiving, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device; and transmitting, to the second wireless communication device in accordance with the multi-hop channel sounding, at least a second frame indicating: first channel information associated with a first wireless communication link between the first wireless communication device and the second wireless communication device; and second channel information associated with a second wireless communication link between the first wireless communication device and the third wireless communication device. Additionally, in some implementations, the method of clause 181 may further perform a method of any combination of clauses 66-130.

Clause 182: The method of clause 181, further including: receiving, from the second wireless communication device, a third frame associated with a sharing of a transmission opportunity (TXOP) or a service period (SP) of the second wireless communication device with the first wireless communication device, where the multi-hop channel sounding is performed within the TXOP or the SP in accordance with the sharing of the TXOP or the SP.

Clause 183: The method of any of clauses 181-182, further including: transmitting a third frame to obtain a transmission opportunity (TXOP) or a service period (SP) of the second wireless communication device in accordance with the first frame including the first identifying information and the second identifying information, where the multi-hop channel sounding is performed within the TXOP or the SP in accordance with obtainment of the TXOP or the SP.

Clause 184: The method of clause 183, further including: receiving a second instance of the first frame in accordance with transmitting the third frame, where at least the second frame is transmitted in accordance with receiving the second instance of the first frame.

Clause 185: The method of any of clauses 181-184, further including: receiving, in accordance with the multi-hop channel sounding, one or more sounding packets from the second wireless communication device, where the first channel information is associated with the one or more sounding packets.

Clause 186: The method of any of clauses 181-185, further including: measuring the first frame in accordance with the multi-hop channel sounding, where the first channel information is associated with the first frame.

Clause 187: The method of any of clauses 181-186, further including: transmitting, in accordance with the first frame including the second identifying information corresponding to the third wireless communication device, a third frame associated with the multi-hop channel sounding, the third frame including the second identifying information corresponding to the third wireless communication device; transmitting, to the third wireless communication device, one or more sounding packets in accordance with the multi-hop channel sounding; and receiving, from the third wireless communication device, a fourth frame indicating the second channel information, where the second channel information is associated with the one or more sounding packets.

Clause 188: The method of any of clauses 181-187, where transmitting at least the second frame indicating the first channel information and the second channel information includes: transmitting the second frame indicating the first channel information; and transmitting a third frame indicting the second channel information, where the third frame is a relayed version of a frame received from the third wireless communication device.

Clause 189: The method of any of clauses 181-187, where transmitting at least the second frame indicating the first channel information and the second channel information includes: transmitting the second frame indicating both the first channel information and the second channel information.

Clause 190: The method of any of clauses 181-189, where the second channel information is associated with a previous channel sounding between the first wireless communication device and the third wireless communication device, the method further including: receiving, from the second wireless communication device, a third frame indicating whether the multi-hop channel sounding is terminated in accordance with the second channel information.

Clause 191: The method of clause 190, where receiving the third frame includes: receiving, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

Clause 192: The method of clause 190, where receiving the third frame includes: receiving, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

Clause 193: The method of clause 192, further including: transmitting, to the third wireless communication device, a sounding announcement frame and one or more sounding packets in accordance with the continuation of the multi-hop channel sounding; receiving, from the third wireless communication device, a fourth frame indicating third channel information associated with the second wireless communication link between the first wireless communication device and the third wireless communication device, where the third channel information is associated with one or more of the sounding announcement frame or the one or more sounding packets; and transmitting, to the second wireless communication device, a fifth frame indicating the third channel information, where the fifth frame is a relayed version of the fourth frame.

Clause 194: The method of any of clauses 181-193, further including: receiving one or more beacon frames transmitted by the second wireless communication device, where the first channel information is associated with the one or more beacon frames.

Clause 195: The method of any of clauses 181-194, further including: receiving, from the second wireless communication device, a third frame in accordance with transmitting at least the second frame indicating the first channel information and the second channel information; and returning a transmission opportunity (TXOP) or a service period (SP) of the second wireless communication device in accordance with receiving the third frame.

Clause 196: The method of any of clauses 181-195, further including: receiving, from the second wireless communication device, information indicative of an amount of data to be relayed, during a transmission opportunity (TXOP) or a service period (SP), between the second wireless communication device and the third wireless communication device via at least the first wireless communication device; and transmitting, to the second wireless communication device, an indication of an estimated amount of resources, where the estimated amount of resources is associated with the amount of data and at least one of the first channel information and the second channel information.

Clause 197: The method of any of clauses 181-196, further including: receiving, from the second wireless communication device, a trigger frame associated with the multi-hop channel sounding, where transmitting at least the second frame indicating the first channel information is in accordance with the trigger frame.

Clause 198: The method of clause 197, where the trigger frame includes the first identifying information associated with the first wireless communication device and the second identifying information associated with the third wireless communication device.

Clause 199: The method of any of clauses 181-198, where the first channel information is associated with a first channel state resolution and the second channel information is associated with a second channel state resolution lower than the first channel state resolution.

Clause 200: The method of any of clauses 181-199, further including: transmitting, via a relay path between the second wireless communication device and the third wireless communication device, one or more data frames in accordance with the multi-hop channel sounding.

Clause 201: The method of clause 200, further including: transmitting the one or more data frames via the relay path during a transmission opportunity (TXOP) or a service period (SP) within which the multi-hop channel sounding is performed.

Clause 202: The method of any of clauses 181-201, where the first wireless communication device receives the first frame and transmits at least the second frame during a same transmission opportunity (TXOP) or a same service period (SP).

Clause 203: The method of any of clauses 181-202, where inclusion of the second identifying information corresponding to the third wireless communication device indicates, to the first wireless communication device, that the first frame is associated with an initiation of the multi-hop channel sounding.

Clause 204: The method of any of clauses 181-203, where the first frame is a sounding announcement frame or a request-to-send (RTS) frame, and the second frame is a compressed beamforming (CBF) frame or a clear-to-send (CTS) frame.

Clause 205: A method for wireless communication at a first wireless communication device, including: transmitting a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device; and receiving, in accordance with the multi-hop channel sounding, at least a second frame indicating: first channel information associated with a first wireless communication link between the first wireless communication device and the second wireless communication device; and second channel information associated with a second wireless communication link between the second wireless communication device and the third wireless communication device. Additionally, in some implementations, the method of clause 205 may further perform a method of any combination of clauses 66-130.

Clause 206: The method of clause 205, further including: transmitting, to the second wireless communication device, a third frame associated with a sharing of a transmission opportunity (TXOP) or a service period (SP) of the first wireless communication device with the second wireless communication device, where the multi-hop channel sounding is performed within the TXOP or the SP in accordance with the sharing of the TXOP or the SP.

Clause 207: The method of any of clauses 205-206, further including: receiving a third frame associated with an obtainment of a transmission opportunity (TXOP) or a service period (SP) of the first wireless communication device by the second wireless communication device in accordance with the first frame including the first identifying information and the second identifying information, where the multi-hop channel sounding is performed within the TXOP or the SP in accordance with the obtainment of the TXOP or the SP by the second wireless communication device.

Clause 208: The method of clause 207, further including: transmitting a second instance of the first frame in accordance with receiving the third frame, where at least the second frame is received in accordance with transmitting the second instance of the first frame.

Clause 209: The method of any of clauses 205-208, further including: transmitting, in accordance with the multi-hop channel sounding, one or more sounding packets, where at least the first channel information is associated with the one or more sounding packets.

Clause 210: The method of any of clauses 205-209, where receiving at least the second frame indicating the first channel information and the second channel information includes: receiving, from the second wireless communication device, the second frame indicating the first channel information; and receiving, from the second wireless communication device, a third frame indicating the second channel information.

Clause 211: The method of any of clauses 205-209, where receiving at least the second frame indicating the first channel information and the second channel information includes: receiving, from the second wireless communication device, the second frame indicating both the first channel information and the second channel information.

Clause 212: The method of any of clauses 205-211, where the second channel information is associated with a previous channel sounding between the second wireless communication device and the third wireless communication device, the method further including: transmitting, to the second wireless communication device, a third frame indicating whether the multi-hop channel sounding is terminated in accordance with the second channel information.

Clause 213: The method of clause 212, where transmitting the third frame includes: transmitting, via the third frame, an indication that the multi-hop channel sounding is terminated in accordance with the second channel information passing one or more conditions, where the one or more conditions are associated with a channel quality, an amount of time since measurement of the channel quality, a power management state of the third wireless communication device, a set of operating parameters associated with the third wireless communication device, or any combination thereof.

Clause 214: The method of clause 212, where transmitting the third frame includes: transmitting, via the third frame, an indication of a continuation of the multi-hop channel sounding in accordance with the second channel information failing one or more conditions, where the one or more conditions are associated with a channel quality, an amount of time since measurement of the channel quality, a power management state of the third wireless communication device, a set of operating parameters associated with the third wireless communication device, or any combination thereof.

Clause 215: The method of clause 214, further including: receiving, from the second wireless communication device, a fourth frame indicating third channel information associated with the second wireless communication link between the second wireless communication device and the third wireless communication device.

Clause 216: The method of any of clauses 205-215, further including: receiving, from the third wireless communication device, a third frame indicating third channel information associated with a third wireless communication link between the first wireless communication device and the third wireless communication device.

Clause 217: The method of clause 216, further including: transmitting, to the second wireless communication device, a fourth frame associated with a sharing of a transmission opportunity (TXOP) or a service period (SP) of the first wireless communication device with the second wireless communication device in accordance with the third channel information, where receiving the second channel information is in association with transmitting the fourth frame.

Clause 218: The method of any of clauses 216-217, further including: establishing a data path between the first wireless communication device and the third wireless communication device in accordance with the first channel information, the second channel information, and the third channel information, where establishing the data path is in association with selecting a multi-hop relay data path associated with the first wireless communication link and the second wireless communication link or a direct data path associated with the third wireless communication link.

Clause 219: The method of any of clauses 205-218, further including: transmitting a third frame in accordance with receiving at least the second frame indicating the first channel information and the second channel information, where the third frame is transmitted to re-obtain a transmission opportunity (TXOP) or a service period (SP) of the first wireless communication device.

Clause 220: The method of any of clauses 205-219, further including: transmitting, to the second wireless communication device, information indicative of an amount of data to be relayed, during a transmission opportunity (TXOP) or a service period (SP), between the first wireless communication device and the third wireless communication device via at least the second wireless communication device; and receiving, from the second wireless communication device, an indication of an estimated amount of resources, where the estimated amount of resources is associated with the amount of data and at least one of the first channel information and the second channel information.

Clause 221: The method of any of clauses 205-220, further including: transmitting, to the second wireless communication device, a trigger frame associated with the multi-hop channel sounding, where receiving at least the second frame indicating the first channel information is in accordance with the trigger frame.

Clause 222: The method of clause 221, where the trigger frame includes the first identifying information associated with the first wireless communication device and the second identifying information associated with the third wireless communication device.

Clause 223: The method of any of clauses 205-222, where the first channel information is associated with a first channel state resolution and the second channel information is associated with a second channel state resolution lower than the first channel state resolution.

Clause 224: The method of any of clauses 205-223, where the first wireless communication device transmits the first frame and receives at least the second frame during a same transmission opportunity (TXOP) or a same service period (SP).

Clause 225: The method of any of clauses 205-224, where inclusion of the second identifying information corresponding to the third wireless communication device indicates, to the second wireless communication device, that the first frame is associated with an initiation of the multi-hop channel sounding.

Clause 226: The method of any of clauses 205-225, where the first frame is a sounding announcement frame or a request-to-send (RTS) frame, and the second frame is a compressed beamforming (CBF) frame or a clear-to-send (CTS) frame.

Clause 227: A first wireless communication device, including at least one means for performing a method of any combination of clauses 66-130 and 181-204.

Clause 228: A non-transitory computer-readable medium storing code for wireless communication at a first wireless communication device, the code including instructions executable by one or more processors individually or collectively to perform a method of any combination of clauses 66-130 and 181-204.

Clause 229: A first wireless communication device, including at least one means for performing a method of any combination of clauses 66-130 and 205-226.

Clause 230: A non-transitory computer-readable medium storing code for wireless communication at a first wireless communication device, the code including instructions executable by one or more processors individually or collectively to perform a method of any combination of clauses 66-130 and 205-226.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Also, as used herein, the phrase “a set” may be understood as including the possibility of a set with one member. That is, the phrase “a set” may be understood in the same manner as “one or more” or “at least one of.”

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless communication device, comprising:
one or more memories storing processor-executable code; and
one or more processors coupled with the one or more memories and individually or collectively configured to, when executing the code, cause the first wireless communication device to:
receive, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device; and
transmit, to the second wireless communication device in accordance with the multi-hop channel sounding, at least a second frame indicating:
first channel information associated with a first wireless communication link between the first wireless communication device and the second wireless communication device; and
second channel information associated with a second wireless communication link between the first wireless communication device and the third wireless communication device.

2. The first wireless communication device of claim 1, wherein the one or more processors are individually or collectively further configured to, when executing the code, cause the first wireless communication device to:
receive, from the second wireless communication device, a third frame associated with a sharing of a transmission opportunity (TXOP) or a service period (SP) of the second wireless communication device with the first wireless communication device, wherein the multi-hop channel sounding is performed within the TXOP or the SP in accordance with the sharing of the TXOP or the SP.

3. The first wireless communication device of claim 1, wherein the one or more processors are individually or collectively further configured to, when executing the code, cause the first wireless communication device to:
transmit a third frame to obtain a transmission opportunity (TXOP) or a service period (SP) of the second wireless communication device in accordance with the first frame including the first identifying information and the second identifying information, wherein the multi-hop channel sounding is performed within the TXOP or the SP in accordance with obtainment of the TXOP or the SP.

4. (canceled)

5. The first wireless communication device of claim 1, wherein the one or more processors are individually or collectively further configured to, when executing the code, cause the first wireless communication device to:
receive, in accordance with the multi-hop channel sounding, one or more sounding packets from the second wireless communication device, wherein the first channel information is associated with the one or more sounding packets.

6. The first wireless communication device of claim 1, wherein the one or more processors are individually or collectively further configured to, when executing the code, cause the first wireless communication device to:
measure the first frame in accordance with the multi-hop channel sounding, wherein the first channel information is associated with the first frame.

7. The first wireless communication device of claim 1, wherein the one or more processors are individually or collectively further configured to, when executing the code, cause the first wireless communication device to:
transmit, in accordance with the first frame including the second identifying information corresponding to the third wireless communication device, a third frame associated with the multi-hop channel sounding, the third frame including the second identifying information corresponding to the third wireless communication device;
transmit, to the third wireless communication device, one or more sounding packets in accordance with the multi-hop channel sounding; and
receive, from the third wireless communication device, a fourth frame indicating the second channel information, wherein the second channel information is associated with the one or more sounding packets.

8. The first wireless communication device of claim 1, wherein, to transmit at least the second frame indicating the first channel information and the second channel information, the one or more processors are individually or collectively further configured to, when executing the code, cause the first wireless communication device to:
transmit the second frame indicating the first channel information; and
transmit a third frame indicting the second channel information, wherein the third frame is a relayed version of a frame received from the third wireless communication device.

9. The first wireless communication device of claim 1, wherein, to transmit at least the second frame indicating the first channel information and the second channel information, the one or more processors are individually or collectively further configured to, when executing the code, cause the first wireless communication device to:
transmit the second frame indicating both the first channel information and the second channel information.

10. The first wireless communication device of claim 1, wherein the second channel information is associated with a previous channel sounding between the first wireless communication device and the third wireless communication device, and wherein the one or more processors are individually or collectively further configured to, when executing the code, cause the first wireless communication device to:
receive, from the second wireless communication device, a third frame indicating whether the multi-hop channel sounding is terminated in accordance with the second channel information.

11. The first wireless communication device of claim 10, wherein, to receive the third frame, the one or more processors are individually or collectively further configured to, when executing the code, cause the first wireless communication device to:
receive, via the third frame, an indication that the multi-hop channel sounding is terminated in accordance with the second channel information passing one or more conditions, wherein the one or more conditions are associated with a channel quality, an amount of time since measurement of the channel quality, a power management state of the third wireless communication device, a set of operating parameters associated with the third wireless communication device, or any combination thereof.

12. The first wireless communication device of claim 10, wherein, to receive the third frame, the one or more processors are individually or collectively further configured to, when executing the code, cause the first wireless communication device to:
receive, via the third frame, an indication of a continuation of the multi-hop channel sounding in accordance with the second channel information failing one or more conditions, wherein the one or more conditions are associated with a channel quality, an amount of time since measurement of the channel quality, a power management state of the third wireless communication device, a set of operating parameters associated with the third wireless communication device, or any combination thereof.

13. The first wireless communication device of claim 12, wherein the one or more processors are individually or collectively further configured to, when executing the code, cause the first wireless communication device to:
transmit, to the third wireless communication device, a sounding announcement frame and one or more sounding packets in accordance with the continuation of the multi-hop channel sounding;
receive, from the third wireless communication device, a fourth frame indicating third channel information associated with the second wireless communication link between the first wireless communication device and the third wireless communication device, wherein the third channel information is associated with one or more of the sounding announcement frame or the one or more sounding packets; and
transmit, to the second wireless communication device, a fifth frame indicating the third channel information, wherein the fifth frame is a relayed version of the fourth frame.

14-19. (canceled)

20. The first wireless communication device of claim 1, wherein the one or more processors are individually or collectively further configured to, when executing the code, cause the first wireless communication device to:
transmit, via a relay path between the second wireless communication device and the third wireless communication device, one or more data frames in accordance with the multi-hop channel sounding.

21. The first wireless communication device of claim 20, wherein the one or more processors are individually or collectively further configured to, when executing the code, cause the first wireless communication device to:
transmit the one or more data frames via the relay path during a transmission opportunity (TXOP) or a service period (SP) within which the multi-hop channel sounding is performed.

22-24. (canceled)

25. A first wireless communication device, comprising:
one or more memories storing processor-executable code; and
one or more processors coupled with the one or more memories and individually or collectively configured to, when executing the code, cause the first wireless communication device to:
transmit a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device; and
receive, in accordance with the multi-hop channel sounding, at least a second frame indicating first channel information associated with a first wireless communication link between the first wireless communication device and the second wireless communication device and second channel information associated with a second wireless communication link between the second wireless communication device and the third wireless communication device.

26-35. (canceled)

36. The first wireless communication device of claim 25, wherein the one or more processors are individually or collectively further configured to, when executing the code, cause the first wireless communication device to:
receive, from the third wireless communication device, a third frame indicating third channel information associated with a third wireless communication link between the first wireless communication device and the third wireless communication device.

37. The first wireless communication device of claim 36, wherein the one or more processors are individually or collectively further configured to, when executing the code, cause the first wireless communication device to:
transmit, to the second wireless communication device, a fourth frame associated with a sharing of a transmission opportunity (TXOP) or a service period (SP) of the first wireless communication device with the second wireless communication device in accordance with the third channel information, wherein receiving the second channel information is in association with transmitting the fourth frame.

38. The first wireless communication device of claim 36, wherein the one or more processors are individually or collectively further configured to, when executing the code, cause the first wireless communication device to:
establish a data path between the first wireless communication device and the third wireless communication device in accordance with the first channel information, the second channel information, and the third channel information, wherein establishing the data path is in association with selecting a multi-hop relay data path associated with the first wireless communication link and the second wireless communication link or a direct data path associated with the third wireless communication link.

39. The first wireless communication device of claim 25, wherein the one or more processors are individually or collectively further configured to, when executing the code, cause the first wireless communication device to:
transmit a third frame in accordance with receiving at least the second frame indicating the first channel information and the second channel information, wherein the third frame is transmitted to re-obtain a transmission opportunity (TXOP) or a service period (SP) of the first wireless communication device.

40. The first wireless communication device of claim 25, wherein the one or more processors are individually or collectively further configured to, when executing the code, cause the first wireless communication device to:
transmit, to the second wireless communication device, information indicative of an amount of data to be relayed, during a transmission opportunity (TXOP) or a service period (SP), between the first wireless communication device and the third wireless communication device via at least the second wireless communication device; and
receive, from the second wireless communication device, an indication of an estimated amount of resources, wherein the estimated amount of resources is associated with the amount of data and at least one of the first channel information and the second channel information.

41. The first wireless communication device of claim 25, wherein the one or more processors are individually or collectively further configured to, when executing the code, cause the first wireless communication device to:
transmit, to the second wireless communication device, a trigger frame associated with the multi-hop channel sounding, wherein receiving at least the second frame indicating the first channel information is in accordance with the trigger frame.

42. (canceled)

43. (canceled)

44. The first wireless communication device of claim 25, wherein the first wireless communication device transmits the first frame and receives at least the second frame during a same transmission opportunity (TXOP) or a same service period (SP).

45. The first wireless communication device of claim 25, wherein inclusion of the second identifying information corresponding to the third wireless communication device indicates, to the second wireless communication device, that the first frame is associated with an initiation of the multi-hop channel sounding.

46. (canceled)

47. A method for wireless communication at a first wireless communication device, comprising:
receiving, from a second wireless communication device, a first frame associated with a multi-hop channel sounding between the second wireless communication device and a third wireless communication device via at least the first wireless communication device, the first frame including first identifying information corresponding to the first wireless communication device and second identifying information corresponding to the third wireless communication device; and
transmitting, to the second wireless communication device in accordance with the multi-hop channel sounding, at least a second frame indicating:
first channel information associated with a first wireless communication link between the first wireless communication device and the second wireless communication device; and
second channel information associated with a second wireless communication link between the first wireless communication device and the third wireless communication device.

48-60. (canceled)

61. The method of claim 47, further comprising:
receiving, from the second wireless communication device, a third frame in accordance with transmitting at least the second frame indicating the first channel information and the second channel information; and
returning a transmission opportunity (TXOP) or a service period (SP) of the second wireless communication device in accordance with receiving the third frame.

62. The method of claim 47, further comprising:
receiving, from the second wireless communication device, information indicative of an amount of data to be relayed, during a transmission opportunity (TXOP) or a service period (SP), between the second wireless communication device and the third wireless communication device via at least the first wireless communication device; and
transmitting, to the second wireless communication device, an indication of an estimated amount of resources, wherein the estimated amount of resources is associated with the amount of data and at least one of the first channel information and the second channel information.

63. The method of claim 47, further comprising:
receiving, from the second wireless communication device, a trigger frame associated with the multi-hop channel sounding, wherein transmitting at least the second frame indicating the first channel information is in accordance with the trigger frame.

64-70. (canceled)

71. A method for wireless communication at a first wireless communication device, comprising:
transmitting a first frame associated with a multi-hop channel sounding involving the first wireless communication device, a second wireless communication device, and a third wireless communication device, the first frame including first identifying information corresponding to the second wireless communication device and second identifying information corresponding to the third wireless communication device; and
receiving, in accordance with the multi-hop channel sounding, at least a second frame indicating:
first channel information associated with a first wireless communication link between the first wireless communication device and the second wireless communication device; and
second channel information associated with a second wireless communication link between the second wireless communication device and the third wireless communication device.

72. The method of claim 71, further comprising:
transmitting, to the second wireless communication device, a third frame associated with a sharing of a transmission opportunity (TXOP) or a service period (SP) of the first wireless communication device with the second wireless communication device, wherein the multi-hop channel sounding is performed within the TXOP or the SP in accordance with the sharing of the TXOP or the SP.

73. The method of claim 71, further comprising:
receiving a third frame associated with an obtainment of a transmission opportunity (TXOP) or a service period (SP) of the first wireless communication device by the second wireless communication device in accordance with the first frame including the first identifying information and the second identifying information, wherein the multi-hop channel sounding is performed within the TXOP or the SP in accordance with the obtainment of the TXOP or the SP by the second wireless communication device.

74-92. (canceled)
